(19) United States
(12) Patent Application Publication
(10) Pub. No.: US 2012/0173444 A1
(43) Pub. Date: Jul. 5, 2012

(54) METHOD AND SYSTEM FOR ENERGY EFFICIENCY AND SUSTAINABILITY MANAGEMENT

(76) Inventor: Ory ZIK, Brookline, MA (US)

(21) Appl. No.: 13/343,382

(22) Filed: Jan. 4, 2012

Related U.S. Application Data
(60) Provisional application No. 61/429,572, filed on Jan. 4, 2011.

(51) Int. Cl. G06Q 99/00

(52) U.S. Cl. 705/317

(57) ABSTRACT

A system and method for sustainability management of energy consumption of a selected resource, including a memory and a processor to calculate a global sustainability quantification value. The global sustainability quantification value may be a resultant quantity of the selected resource which may be produced by exploitation of a predetermined quantity of a predetermined second resource.

### REFERENCE TO PRIOR APPLICATION

The present application claims benefit of U. S. provisional application No. 61/429,572 filed on Jan. 4, 2011 titled “Computer Implemented Systems and Methods for Measuring, Analyzing, Presenting and Controlling Energy Consumption” which is incorporated herein by reference in its entirety.

### FIELD OF THE INVENTION

Embodiments of the present invention relate to systems and methods for resource consumption measurement, energy efficiency and sustainability management.

### BACKGROUND OF THE INVENTION

Energy and resource consumption affects many industries, economic factors and environments around the world. Adverse effects of human activities on the environment including economic costs, toxic waste and possibly global warming, are related to energy and resource consumption. Methods for managing and monitoring energy consumption and improving sustainability have been developed. Sustainability, particularly environmental sustainability, may be defined as the quality of being unharmful, relatively unharmful, or less harmful to the environment than other energy sources or resources, for supporting long-term ecological balance.

### SUMMARY OF THE INVENTION

There is provided in accordance with an embodiment of the invention a system for sustainability management of energy consumption of a selected resource, including a memory and a processor to calculate a global sustainability quantification value. The global sustainability quantification value may be a resultant quantity of the selected resource which may be produced by exploitation of a predetermined quantity of a predetermined second resource.

In accordance with an embodiment of the invention the predetermined second resource may be a fossil fuel. Additionally, the predetermined second resource may be gasoline. Furthermore, the predetermined quantity of the predetermined second resource may be a gallon of gasoline. Moreover, the predetermined second resource may be a fossil fuel in its primary energy state.

In accordance with an embodiment of the invention the processor may calculate a sustainability quantification value by executing an algorithm based on the global sustainability quantification value, and a sustainability efficiency value being an indication of an energy efficiency degree of the selected resource. Accordingly, the sustainability efficiency value may be calculated according to the geographical location wherein the resource is consumed.

In accordance with an embodiment of the invention the processor may calculate a sustainability expenditure value by executing an algorithm based on a quantity associated with the selected resource, and the sustainability efficiency value. Additionally, the quantity associated with the selected resource may be a consumed quantity of the selected resource.

In accordance with an embodiment of the invention the processor may calculate the sustainability expenditure value for a first selected resource and the sustainability expenditure value for a second selected resource, wherein the sustainability expenditure value for the first selected resource and the sustainability expenditure value for the second selected resource are measured in a common unit, wherein the first resource is measured in a first conventional unit and the second resource is measured in a second conventional unit, said first conventional unit may be different than the second conventional unit.

There is provided in accordance with an embodiment of the invention a method for sustainability management of energy consumption of a selected resource, including calculating a global sustainability quantification value, where the value may be a resultant quantity of the selected resource, which may be produced by exploitation of a predetermined quantity of a predetermined resource, the calculating may be performed by a processor and the global sustainability quantification value may be stored in a memory.

There is provided in accordance with an embodiment of the invention a system for sustainability management of energy consumption of a selected resource, including a memory and a processor. The processor may calculate a sustainability efficiency value based on the geographical location of the selected resource. The sustainability efficiency value may be an indication of an energy efficiency degree of the selected resource. The sustainability efficiency value is based on a time period in which the selected resource is consumed.

There is provided in accordance with an embodiment of the invention a method for sustainability management of energy consumption of a selected resource, comprising calculating a sustainability efficiency value based on the geographical location of the selected resource. The sustainability efficiency value may be an indication of an energy efficiency degree of the selected resource and the calculating may be performed by a processor and the sustainability efficiency value may be stored in a memory.

### BRIEF DESCRIPTION OF THE DRAWINGS

The principals and operation of the system, apparatus and methods according to embodiments of the present invention may be better understood with reference to the drawings, and the following description, it being understood that these drawings are given for illustrative purposes only and are not meant to be limiting.

FIG. 1 is a simplified schematic illustration of a system for energy efficiency and sustainability management according to an embodiment of the invention;

FIG. 2 is a simplified schematic illustration of a system for energy efficiency and sustainability management according to an embodiment of the invention;

FIG. 3 is a simplified schematic illustration of a system for energy efficiency and sustainability management according to an embodiment of the invention;

FIG. 4 is a simplified schematic illustration of a system for energy efficiency and sustainability management according to an embodiment of the invention;

FIG. 5 is a simplified schematic illustration of hardware components within a server of a system of FIGS. 1-4, according to an embodiment of the invention;

FIG. 6 is a simplified flowchart of a method for energy efficiency and sustainability management of the system of FIGS. 1-4, according to an embodiment of the invention;

FIG. 7 is a simplified illustration of a user interface and display according to the flowchart in FIG. 6, according to an embodiment of the invention;

FIG. 8 is a simplified illustration of a user interface and display according to the flowchart in FIG. 6, according to an embodiment of the invention;

FIG. 9 is a simplified illustration of a user interface and display according to the flowchart in FIG. 6, according to an embodiment of the invention;

FIG. 10 is a simplified illustration of a user interface and display according to the flowchart in FIG. 6, according to an embodiment of the invention;

FIG. 11 is a simplified flowchart of a method for energy efficiency and sustainability management of the system of FIGS. 1-4, according to an embodiment of the invention;

FIG. 12 is a simplified illustration of a user interface and display according to the flowchart in FIG. 11, according to an embodiment of the invention;

FIG. 13 is a simplified illustration of a user interface and display according to the flowchart in FIG. 11, according to an embodiment of the invention;

FIG. 14 is a simplified illustration of a user interface and display according to the flowchart in FIG. 11, according to an embodiment of the invention;

FIG. 15 is a simplified illustration of a display according to the flowchart in FIG. 11, according to an embodiment of the invention;

FIG. 16 is a simplified illustration of a display according to the flowchart in FIG. 11, according to an embodiment of the invention;

FIG. 17 is a simplified flowchart of a method for energy efficiency and sustainability management of the system of FIGS. 1-4, according to an embodiment of the invention;

FIG. 18 is a simplified schematic illustration of a system for energy efficiency and sustainability management according to an embodiment of the invention;

FIG. 19 is a simplified illustration of a user interface and display according to the system of FIG. 18, according to an embodiment of the invention;

FIG. 20 is a simplified illustration of a user interface and display according to the system of FIG. 18, according to an embodiment of the invention;

FIG. 21 is a simplified flowchart of a method for energy efficiency and sustainability management of the system of FIGS. 18-21, according to an embodiment of the invention; and

FIG. 22 is a simplified flowchart of a method for energy efficiency and sustainability management according to an embodiment of the invention;

FIG. 23 is a simplified flowchart of a method for energy efficiency and sustainability management according to an embodiment of the invention;

FIG. 24 is a simplified flowchart of a method for energy efficiency and sustainability management according to an embodiment of the invention;

FIG. 25 is a simplified flowchart of a method for energy efficiency and sustainability management according to an embodiment of the invention;

FIG. 26 is a simplified flowchart of a method for energy efficiency and sustainability management according to an embodiment of the invention;

FIG. 27 is a simplified flowchart of a method for energy efficiency and sustainability management according to an embodiment of the invention;

FIG. 28 is a simplified flowchart of a method for energy efficiency and sustainability management according to an embodiment of the invention;

FIG. 29 is a simplified schematic illustration of a device for energy efficiency and sustainability management, according to an embodiment of the invention;

FIG. 30 is a simplified illustration of a display according to a method for energy efficiency and sustainability management, according to an embodiment of the invention;

FIG. 31 is a simplified illustration of a display according to a method for energy efficiency and sustainability management, according to an embodiment of the invention;

FIG. 32 is a simplified illustration of a display according to a method for energy efficiency and sustainability management, according to an embodiment of the invention;

FIG. 33 is a simplified illustration of a display according to a method for energy efficiency and sustainability management, according to an embodiment of the invention;

FIG. 34 is a simplified illustration of a display according to a method for energy efficiency and sustainability management, according to an embodiment of the invention;

FIG. 35 is a simplified illustration of a display according to a method for energy efficiency and sustainability management, according to an embodiment of the invention;

FIG. 36 is a simplified illustration of a display according to a method for energy efficiency and sustainability management, according to an embodiment of the invention;

FIG. 37 is a simplified illustration of a display according to a method for energy efficiency and sustainability management, according to an embodiment of the invention;

FIG. 38 is a simplified illustration of a display according to a method for energy efficiency and sustainability management, according to an embodiment of the invention;

FIG. 39 is a simplified illustration of a display according to a method for energy efficiency and sustainability management, according to an embodiment of the invention;

FIG. 40 is a simplified illustration of a display according to a method for energy efficiency and sustainability management, according to an embodiment of the invention;

FIG. 41 is a simplified illustration of a display according to a method for energy efficiency and sustainability management, according to an embodiment of the invention; and

FIG. 42 is a simplified illustration of a display according to a method for energy efficiency and sustainability management, according to an embodiment of the invention.

For simplicity and clarity of illustration, elements shown in the drawings have not necessarily been drawn to scale. For example, the dimensions of some of the elements may be exaggerated relative to other elements among the drawings to indicate corresponding or analogous elements throughout the serial views.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

In accordance with embodiments of the invention there is provided systems and methods for energy efficiency and sustainability management for consumers of resources. The consumers may be any energy consumers, such as individuals, companies, government agencies, executives, and products, for example. Resources when used herein may include energy or other physical resources, the use of which may affect the environment (e.g., the environment of the planet, environment of a facility, environment of a city, county, state, country or any other relevant environment), such as oil, gasoline, electricity, water, materials such as plastic, wood, paper, manufactured goods such as automobiles, etc. Energy when discussed herein may include energy or power, or the physical manifestation of energy or stored energy such as oil, or processes such as heating, cooling or transportation which require energy. Resources when discussed herein may include resources such as water, paper or other commodities, mined or extracted raw materials, which may require energy or other resources to produce and transport. The energy consumers may be from various sectors, such as the residential sector, commercial sector, military sector or governmental sector. The energy consumption may include consumption, for example: resources such as sunlight, air, wind, water, electricity, natural gas, gasoline, land, materials, food, agricultural waste, fossil fuels and derivatives thereof, such as heat, transportation, including land and air transportation, for example. Throughout the specification the term “resource” refers to the resources and derivatives thereof.

Energy or resource consumers, wishing to monitor their sustainability and improve their energy efficiency, may benefit from a quantifiable, intuitive value evaluating the effect their resource consumption has on the environment.

Throughout the description an energy consumer is referred to as a user of the sustainability management system. It is appreciated that the energy consumer and the user of the sustainability management system may be separate entities or the same entity.

Generally, a sustainability management system or method may provide a value or rating according to embodiments of the invention, which reflects an effect that consumption of a resource has on the environment. For example, currently, a consumer, reviewing in his utility bill a consumed 100 kilowatt-hour (kWh) this month or 10 million BTU of heating gas, may not have accurate knowledge of the effect his consumption of electricity or heating gas has on the environment. (Typically the consumption of electricity when discussed herein is the electricity consumed by a consumer at his home, but other measures of electricity usage may be used.) It is known that using electricity generated in a coal power plant has a greater adverse environmental effect (e.g., by emitting carbon dioxide into the planet's atmosphere) than electricity generated in a solar power plant. Thus there is a need for a value or rating which expresses and reflects the environment effect due to resource consumption.

Additionally, the sustainability management system may provide a common, standard or uniform unit for measuring or quantifying different types of resources. Currently, different resources are measured in disparate units. For example, electricity may be measured in kWh and water in liters or gallons. There is a need in the art for expressing and measuring disparate resources using a common unit. For example, measuring electricity consumption and water consumption by a uniform, common unit (common to both resources), may allow for adding or comparing the electricity consumption with the water consumption. A common unit as provided in embodiments of the present invention may incorporate or take into account adverse environmental effects, the effects of production, or other factors.

A sustainability management system according to embodiments may provide values reflecting the environmental effect, which are measured in a uniform unit for disparate resources. Additionally, an embodiment may provide values reflecting an environmental effect due to resource consumption; and a uniform unit or dimensionless value for measuring disparate resources. These values may be referred to throughout the specification as “sustainability values”.

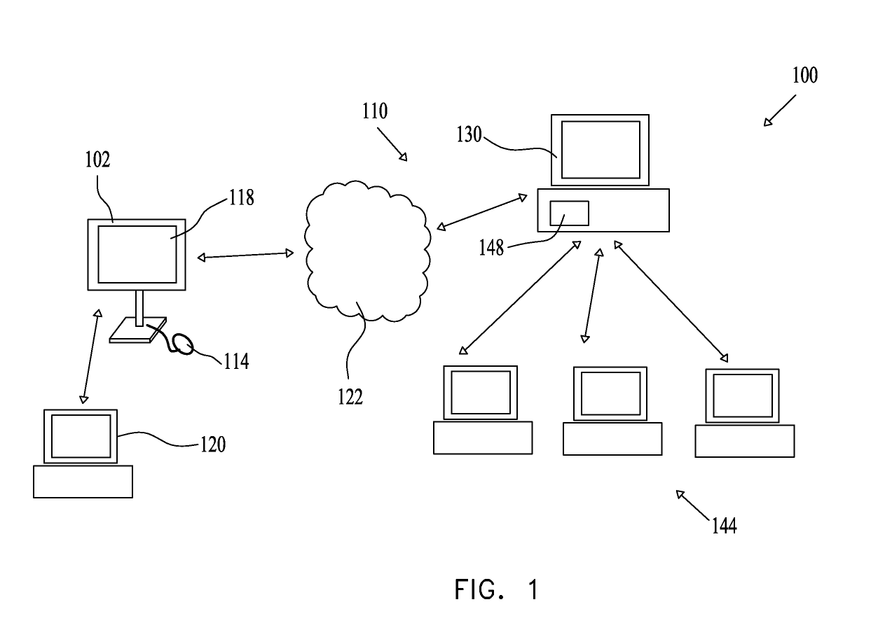

An example of a sustainability value may be a sustainability quantification value comprising a spatiotemporal sustainability quantification value. The spatiotemporal sustainability quantification value may be a numerical value which comprises an evaluation of the effect a resource has on the environment. The effect the use of a resource has on the environment may be evaluated by a sustainability efficiency value. Use of a resource may include consumption of a resource and environmental costs involved in providing the resource, such as the transportation of water or manufactured goods; the energy or other resources required to manufacture or transport to a user a good, such as a vehicle. The resource may be measured relative to any suitable value or unit, as will be further described. For example the resource may be measures relative to a global sustainability quantification value. The spatiotemporal sustainability quantification value may be calculated by employing or executing an algorithm comprising the sustainability efficiency value and the global sustainability quantification value, as will be further described. For example, the algorithm may be executed by a processor, such as a processor of a server 120, server 130, server 144 or user machine 102 described in reference to FIGS. 1-4.

The sustainability efficiency value may comprise in various embodiments any environmental effect caused anytime due to the resource. This may include anytime from harvesting the resource until consumption of the resource and thereafter, including post consumption environmental effects due to disposal of the resource and disposal of the waste caused by the resource. The sustainability efficiency value may comprise an indication of an energy efficiency degree of a resource.

The sustainability efficiency value may include harmful, adverse effects on the environment. The adverse effects may be categorized into a multiplicity of categories.

For example, one category of an adverse effect may comprise direct effects on the environment. Direct effects on the environment may include emissions and pollutants, such as the emission of the greenhouse gases, carbon dioxide, methane, nitrous oxide and ozone, nitric oxide emissions, nitrogen dioxide emissions, sulfur dioxide emissions, air pollutants, water pollutants, waste, hazardous waste and municipal waste, for example. Additionally, the resources that are required for removing waste and undesired emissions may be included.

Another category of an adverse effect may comprise use of resources or materials to produce a resource. For example, use of cooling water in generating electricity in a power plant; use of land for harvesting gasoline; use of any material for harvesting, transporting, providing, consuming or removing a resource.

Moreover, another category of an adverse effect may comprise indirect adverse effects on the environment. The indirect adverse effects may comprise any losses arising anytime from harvesting until consuming the resource and thereafter. The losses may be losses well known in the art such as, conversion losses, which may be due to conversion of the energy from its primary state to a usable form of energy, such as refining crude oil for producing gasoline, or turbine losses in generating electricity in a power plan. Additionally, there may be transmission and distribution losses, such as electric power transmission losses in transferring electrical power from a power plant to a user or distribution of gasoline to a user. Another example may be losses due to system inefficiencies in producing and delivering a resource, such as leaks in gasoline or water pipes. Additional losses may be time of delivery losses due to storage of the resource, such as the energy losses accrued in storing electricity or heat. Other losses may be thermal losses, for example.

These losses may have an adverse environmental effect for various reasons, for example since these losses require expending more of the resource to compensate for these losses.

The sustainability efficiency value may vary according to the geographical location of the resource or the user consuming the resource. For example, the adverse environmental effect of electricity produced in a fossil fuel power plant, is typically greater than electricity produced in a solar power plant. Therefore, the adverse environmental effect in a geographical location where the electricity is produced in or delivered from a fossil fuel power plant, is greater than the adverse environmental effect in a geographical location where the electricity is produced in or delivered from a solar power plant. Hence, the sustainability efficiency value may be dependent on the geographical location of the resource or the source of the resource. The geographical location may be any location associated with the resource. In accordance with an embodiment of the present invention, the geographical location is the location in which the resource is consumed.

It is noted that the sustainability efficiency value may also vary according to the time period when the resource is consumed. For example, electricity is generated in a power plant which generates electricity using solar power, when there is sufficient sunlight. At times the sunlight is insufficient the power plant may supplement the electricity generation by generating electricity using coal. Accordingly, during the summertime a relatively larger amount of electricity will be generated by solar power then in the wintertime. Thus, the adverse environmental effect of electricity consumed from the power plant during summertime is less than the adverse environmental effect of electricity consumed during wintertime.

As described hereinabove, the sustainability efficiency value may be a numerical value or a rating comprising a single or a plurality of numerical values, each reflecting an effect or effects the resource has on the environment. The plurality of numerical values may be compiled together to a consolidated numerical value constituting the sustainability efficiency value, in any suitable method. In a non-limiting example, the sustainability efficiency value may be a sum of the plurality of numerical values. A combination of multiplication, addition or any other calculation method may be used for compiling the sustainability efficiency value.

A non-limiting example for evaluating a sustainability efficiency value may be for example: where the consumed resource is electricity generated by a coal power plant it is known in the art that the accrued losses may be: 68% due to conversion of coal to electricity; 1.4% due to transmission and distribution; 2.1% due to system inefficiencies; and 2.6% due to time of delivery losses. The adverse environmental effect due to carbon dioxide emitted during generation of electricity by the coal power plant may be evaluated as 9.4%. Thus, the sum of the above environmental effects is 83.5%. The sustainability efficiency value is the remainder following subtraction of the environmental effects from 100%. Thus, the sustainability efficiency value is 16.5%.

Adverse environmental effect due to carbon dioxide emission may be evaluated for example by quantifying an amount of energy (in its primary state) invested in removing the carbon dioxide. For example, the carbon dioxide may be removed by electric scrubbing, as known in the art. Electric scrubbing may comprise applying a voltage across a carbonate solution to release the carbon dioxide. The amount of electricity invested in performing the electric scrubbing reflects the adverse environmental effect due to carbon dioxide emission. In the example above the electricity invested in scrubbing the carbon dioxide emitted during generation of electricity in a coal power plant is 9.4% of the amount of energy used by the coal power plant to generate electricity.

It is generally noted that in accordance with an embodiment of the invention the adverse environmental effects described herein may be evaluated by quantifying an amount of energy invested in removing the adverse environmental effect.

In another non-limiting example, the sustainability efficiency value of electricity generated within a natural gas combined cycle power plant is 63.9%. As with other specific examples of efficiencies, conversions of energy, conversions to Energy Points (a standard unit which may quantify or measure the resource expenditure of the user and the effect his consumption has on the environment) or other standard units, etc., other efficiency values may be used.

It is appreciated that other values may be used.

The global sustainability quantification value may measure or evaluate disparate resources relative to any suitable common value. In accordance with an embodiment, a resource may be measured relative to a standard unit such as a gallon of gasoline. In other words, the global sustainability quantification value may be the quantity of a resource energy produced by converting a gallon of gasoline into the resource energy. For example, the global sustainability quantification value of electricity may be the quantity of electrical energy produced by converting a gallon of gasoline into electrical energy. Other standard units may be used.

In accordance with one embodiment the amount of energy that may be generated from a gallon of gasoline is converted from its primary energy state of crude, unrefined oil, such as oil harvested from an oil shale or well to electrical energy.

Thus, in a non-limiting example, the resultant quantity of electrical energy produced by converting a gallon of gasoline, in its primary energy state, into electrical energy, may be approximately 42.2 kWh per gallon of gasoline, as known in the art. In accordance with an embodiment, the unit per “gallon of gasoline” may be defined as an “Energy Point” (EP). Thus the global sustainability quantification value of electricity is according to one embodiment is 42.2 [kWh/EP]. It is noted that units other than Energy Points may be used.

In a non-limiting example, the resultant quantity of electrical energy produced by converting a gallon of gasoline, in a processed energy state, into electrical energy, may be approximately 35 kWh per gallon of gasoline, as known in the art, and may be presented relative to Energy Point units as 35 [kWh/EP].

The Energy Point may quantify or measure the resource expenditure of the user and the effect his consumption has on the environment.

For many people, mileage or kilometers gained per gallon or liter of gasoline is an intuitive quantity. Therefore, expressing a quantity of a resource produced by converting, for example, a gallon or liter of gasoline to the resource, may be relatively intuitive, since it is analogous to the mileage gained per gallon or liter of gasoline. It is noted that other standard quantities may be used.

It is appreciated that the global sustainability quantification value may be any suitable value reflecting, for example an amount of energy, or another resource input affecting the environment such as an area (e.g., acre) of land, solar energy or biofuels. In accordance with an embodiment, the global sustainability quantification value may comprise a resultant quantity of a selected resource which is produced by exploitation of a predetermined quantity of a predetermined resource.

In accordance with an embodiment, the global sustainability quantification value may comprise a resultant quantity of a selected resource energy which is produced by exploitation of a predetermined quantity of a predetermined resource. In accordance with another embodiment, the global sustainability quantification value may comprise a resultant quantity of a selected resource energy which is produced by exploitation of a predetermined quantity of a predetermined resource energy. Accordingly, the global sustainability quantification value may comprise a resultant quantity of a selected resource which is produced by converting a predetermined quantity of fossil fuel to produce the selected resource. In another example, the global sustainability quantification value may comprise a resultant quantity of a selected resource which is produced by converting a predetermined quantity of water to produce the selected resource. In yet another example, the global sustainability quantification value may comprise a resultant quantity of a selected resource which is produced by using a predetermined area of land to produce the selected resource. In yet another example the global sustainability quantification value may be any suitable value, such as the quantity of a gaseous emission caused due to exploitation of the selected resource or the predetermined resource, for example.

In a further example the global sustainability quantification value may be the quantity of a greenhouse gas emission, such as carbon dioxide emission, caused due to exploitation of the resource.

In yet a further example the global sustainability quantification value may be the quantity of a resource energy produced by converting a gallon of gasoline into the resource energy and measured in reference to a greenhouse gas emission. For example, an amount of approximately 10 kilogram of carbon dioxide may be emitted during combustion of a gallon of gasoline. In accordance with an embodiment, the carbon dioxide emission per “gallon of gasoline” is in one example approximately 10 Energy Points. The global sustainability quantification value may be provided by the sustainability management system in reference to the carbon emission of a gallon of gasoline. In a non-limiting example, the global sustainability quantification value of electricity may be provided by the sustainability management system in reference to the carbon emission of a gallon of gasoline by dividing the global sustainability quantification value (e.g. 42.2) by the carbon dioxide emission per Energy Point, which is 42.2/10=4.22 [kWh/carbon dioxide emission per EP].

Thus it is shown that the sustainability management system may provide the sustainability values in reference to the carbon emission of a gallon of gasoline.

As described herein in reference to gasoline, the predetermined resource may be a resource in its primary energy state. The primary energy state may be defined as an energy form found in nature that has not been subjected to a conversion or transformation process.

Calculating the global sustainability quantification value may allow a user to express different resources relative to a uniform value. For example, a resource, such as electricity, may be expressed by calculating the resultant quantity of electrical energy produced by converting a gallon of gasoline into electrical energy. Additionally, a resource, such as water, may be expressed by calculating the resultant quantity of water produced by converting a gallon of gasoline into energy used to produce the water.

As described herein, the spatiotemporal sustainability quantification value may be calculated by executing or employing a method or algorithm comprising the sustainability efficiency value and the global sustainability quantification value. In accordance with an embodiment, the spatiotemporal sustainability quantification value may be a product of the sustainability efficiency value multiplied by the global sustainability quantification value.

Thus, the spatiotemporal sustainability quantification value may be calculated, for example:

Spatiotemporal sustainability quantification value==Global sustainability quantification value×Sustainability efficiency value

It is noted that other formulas or inputs may be used.

In a non-limiting example, the spatiotemporal sustainability quantification value of electricity generated in a coal power plant is equal to the sustainability efficiency value of electricity generated in a coal power plant (=16.5%) multiplied by the global sustainability quantification value for electricity (=42.2 [kWh/EP])=6.9 [kWh/EP], approximately. Similarly, the spatiotemporal sustainability quantification value of electricity generated in a natural gas combined cycle power plant is equal to the sustainability efficiency value of electricity generated in a natural gas combined cycle power plant (=63.9%) multiplied by the global sustainability quantification value for electricity (=42.2 [kWh/EP])=27 [kWh/EP], approximately.

From the above example it can be appreciated that a consumed resource may be produced by diverse technologies, each with a different sustainability efficiency value.

For example, electricity may be generated by diverse technologies, such as by a coal power plant, a wind power plant and a natural gas power plant. Thus there are different spatiotemporal sustainability quantification values for the different technologies for producing the electricity. The diverse technologies may comprise many further divisions, for example electricity may be generated by a coal power plant performing carbon sequestration or by a coal power plant, which does not sequester the carbon. The spatiotemporal sustainability quantification value for electricity generated by the coal power plant performing carbon sequestration may be different than the spatiotemporal sustainability quantification value for electricity generated by the coal power plant which does not sequester the carbon.

Thus in accordance with an embodiment of the invention each resource may be generated by diverse technologies and the sustainability management system may provide the spatiotemporal sustainability quantification value for each type of resource technology and each type of technology for processing a resource.

The total spatiotemporal sustainability quantification value of the resource produced by diverse technologies may be calculated by any suitable algorithm. For example, the algorithm may be executed by a processor, such as a processor of a server 120, server 130, server 144 or user machine 102 described in reference to FIGS. 1-4.

In accordance with an embodiment the total spatiotemporal sustainability quantification value of the resource produced by diverse technologies may be calculated by an algorithm utilizing the formula for adding parallel resistors, as known in the art.

The formula may be calculated for any number of N resources, for example:

$$Total spatiotemporal sustainability quantification value = \frac{1}{{\sum }_{i}^{N} \frac{\begin{matrix}Percentage of {technology}_{i} from \\ total resource composition\end{matrix}}{\begin{matrix}Spatiotemporal sustainability \\ quantification value of {technology}_{i}\end{matrix}}}$$

where i is an index defining each technology used to produce the resource.

It is noted that other formulas or inputs may be used.

Thus, in a non limiting example, the total spatiotemporal sustainability quantification value of electricity, where 40% is generated in a coal power plant and 60% is generated in a natural gas combined cycle power plant, is calculated as:

$$Total spatiotemporal sustainability quantification value = \frac{1}{\frac{0.4}{6.9} + \frac{0.6}{27}} = 12.5 [ kWh / EP ]$$

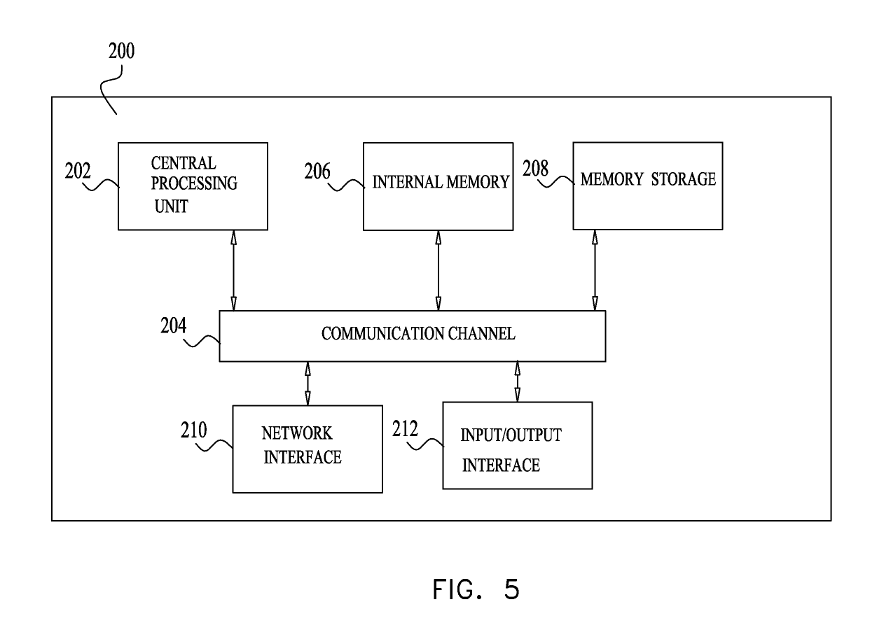

A user, being provided with the spatiotemporal sustainability quantification value of a resource, may utilize this value for managing and monitoring his consumption, as will be described in reference to FIGS. 5-10.

In an additional example the resource may be water. The sustainability management system may retrieve the electrical energy expended for producing the water in a selected geographical location. The total spatiotemporal sustainability quantification value of electricity is calculated as just described. The spatiotemporal sustainability quantification value of water may be calculated by multiplying the retrieved amount of water produced per amount of electricity by the total spatiotemporal sustainability quantification values of electricity.

In a non-limiting example, in a selected geographical location the amount of electrical energy invested for water production is 5 [kWh/kilogallons]. The total spatiotemporal sustainability quantification value of electricity is 12.5 [kWh/EP], as described herein. Therefore, the spatiotemporal sustainability quantification value of water may be 12.5/5=2.5 [kilogallons/EP]. Thus a user investing the energy equivalent to a gallon of gasoline will yield approximately 2,500 gallons of fresh water.

In an additional example the resource may be a resource waste. The sustainability management system may retrieve the electrical energy expended for removing the resource waste in a selected geographical location. The total spatiotemporal sustainability quantification value of electricity is calculated as described.

Additionally, the sustainability management system may retrieve the amount or value of energy expended for transportation of the resource waste in a selected geographical location. The total spatiotemporal sustainability quantification value of transportation is calculated as described in accordance with an embodiment of the invention.

A sustainability management system and method according to one embodiment may provide Energy Points or a sustainability expenditure value. The sustainability expenditure value may be a numerical evaluation or quantification of the resource expenditure of the user and the effect his consumption has on the environment. Additionally, the sustainability expenditure value may indicate the energy efficiency of a user's resource consumption or energy consumption.

As described herein, the environmental effect a resource has on the environment may be evaluated by the spatiotemporal sustainability quantification value. Therefore, the sustainability expenditure value may be calculated as the quantity of consumed resource relative to the spatiotemporal sustainability quantification value of the consumed resource.

The sustainability expenditure value may be calculated by employing or executing an algorithm comprising the spatiotemporal sustainability quantification value and the quantity of consumed resource, as will be further described. For example, the algorithm may be executed by a processor, such as a processor of a server 120, server 130, server 144 or user machine 102 described in reference to FIGS. 1-4.

In accordance with an embodiment, the sustainability expenditure value may be a quotient of the quantity of a consumed resource divided by the spatiotemporal sustainability quantification value.

Thus, the sustainability expenditure value may be calculated, for example:

$$Sustainability expenditure value = \frac{\begin{matrix}Quantity of consumed \\ resource\end{matrix} }{\begin{matrix}Spatiotemporal sustainability \\ quantification value\end{matrix}}$$

It is noted that other formulas or inputs may be used.

This quantity of a consumed resource may be for example, an amount of kWh of consumed electricity or an amount of gallons of consumed water or gasoline or other quantities.

In a non limiting example, the sustainability expenditure value of a user, which has consumed 100 [kWh] of electricity using the electricity generated as described in the example provided in reference to the spatiotemporal sustainability quantification value, is calculated as: 100 [kWh]/12.5 [kWh/EP]=8 [EP]

In accordance with an embodiment, a user of the sustainability management system may provide a quantity associated with the consumed resource, such as the cost of a resource in monetary units appearing in a utility bill. Additionally, the quantity associated with the consumed resource may be air miles (e.g., distance travelled using commercial airlines) or car miles, for example. The sustainability management system may convert the quantity associated with the consumed resource into the quantity of the consumed resource.

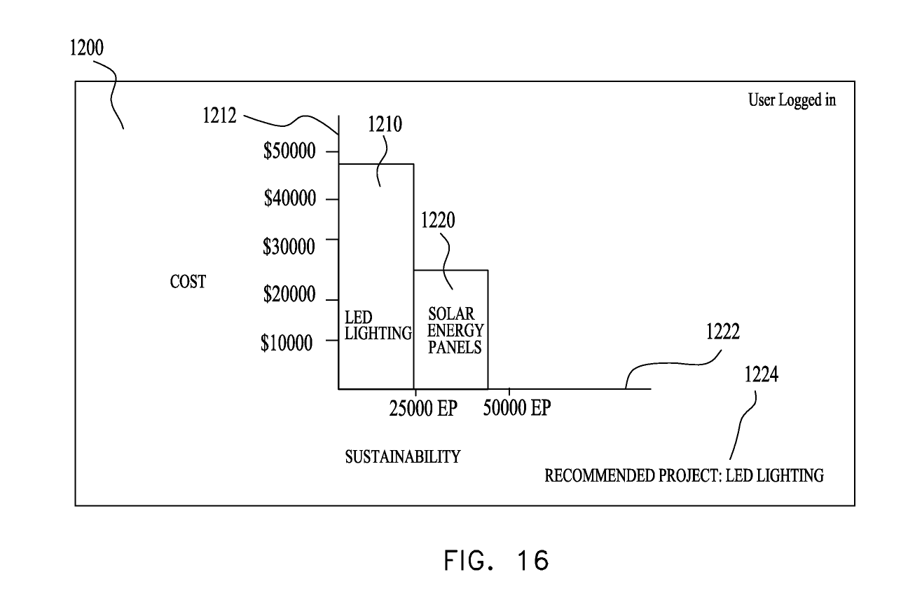

The sustainability expenditure value may be evaluated for each type of consumed resource. For example, a user may provide the amount of water a user has consumed (e.g., during a specific period) and the amount of electricity the user has consumed (e.g., during a specific period). The system may return to the user the sustainability expenditure value for water and the sustainability expenditure value for electricity. Additionally, the sustainability expenditure value may be evaluated for projected activities for example a user wishing to purchase a product may compare the energy efficiency of different products so as to select the most energy efficient product. An example of such a selection is described in reference to FIG. 16, for example. Additionally, a user wishing to undertake an activity such as a trip or travel may compare the energy efficiency of different future activities such as trips so as to select the most energy efficient activity, or the activity having the lowest environmental impact.

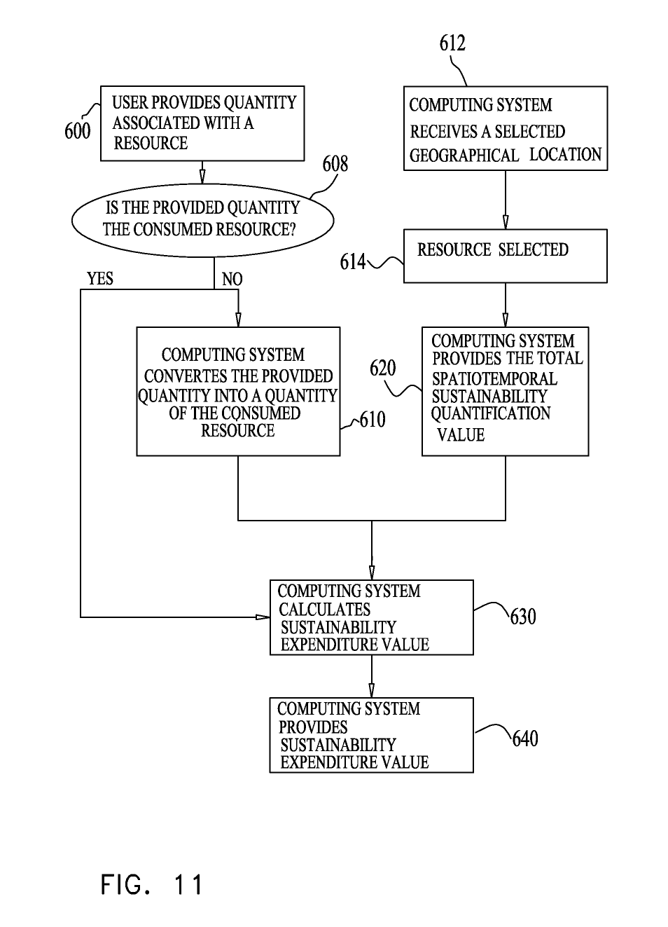

It is a feature of the invention that the sustainability expenditure value may be measured in a uniform unit for all types of resources. This feature provides a unique energy scale or energy metric for all resources. The sustainability expenditure values of different types of resources may be added for evaluating a total sustainability expenditure value of a user. The total sustainability expenditure value provides the user with a numerical value expressing the total quantity of resources the user has consumed (e.g., during a specific period or in a certain location) and the effect his consumption has on the environment. Thereby, providing an essential tool for the user to manage and monitor his resource consumption, as will be further described in reference to FIGS. 11-42.

The total sustainability expenditure value may be calculated by employing or executing an algorithm comprising the sustainability expenditure value of each resource, as will be further described. For example, the algorithm may be executed by a processor, such as a processor of a server 120, server 130, server 144 or user machine 102 described in reference to FIGS. 1-4.

The total sustainability expenditure value may be calculated for any number of N resources, for example:

$$Totalsustainability expenditure value = {\sum }_{i}^{N} Sustainabilityexpenditure {value}_{i}$$

where i is an index defining the sustainability expenditure value of each resource.

It is noted that other formulas or inputs may be used.

In a non limiting example, where the sustainability expenditure value of electricity of a user during a selected period of time is 8 [EP] and the sustainability expenditure value of car transportation (e.g., a cumulative number of car trips during the period) during the selected period of time is 10 [EP], the total sustainability expenditure value of the user (assuming he did not consume any other resources) is 18 [EP].

Thus it is seen that a user may provide a first resource measured in a first conventional unit, i.e. the electricity measured in kWh, and a second resource measured in a second different conventional unit, i.e. the car transportation measured in miles. The sustainability management system may provide the first and second resource in a common unit, such as both the electricity and car transportation being measured by Energy Points.

In accordance with an embodiment the sustainability expenditure value may be a value representing the Energy Point.

As described herein the sustainability management system may provide the sustainability values in reference to the carbon emission of a gallon of gasoline. In a non-limiting example, the sustainability expenditure value may be provided in reference to the carbon emission of a gallon of gasoline. For example, wherein the total sustainability expenditure value of the user is 18 [EP], the sustainability management system may provide the sustainability expenditure value in reference to the carbon emission of a gallon of gasoline and the sustainability expenditure value is thus 1.8 [carbon dioxide emission per EP].

Thus it is shown that the sustainability management system may provide the sustainability values in reference to the carbon emission of a gallon of gasoline. Furthermore it is shown that the sustainability management system may be utilized as a carbon dioxide calculator by measuring the sustainability expenditure value in reference to quantities of carbon dioxide emission.

The sustainability expenditure values of the different types of resources may be compared thereto for managing and monitoring the user's resource consumption.

In accordance with another embodiment, the sustainability management system may provide a general sustainability expenditure value comprising the quantity of a consumed resource and the global sustainability quantification value. In accordance with an embodiment, the general sustainability expenditure value may be a quotient of the quantity of a consumed resource divided by the global sustainability quantification value.

The general sustainability expenditure value may be calculated by employing or executing an algorithm comprising the global sustainability quantification value and the quantity of consumed resource, as will be further described. For example, the algorithm may be executed by a processor, such as a processor of a server 120, server 130, server 144 or user machine 102 described in reference to FIGS. 1-4.

The general sustainability expenditure value may be calculated, for example:

$$General sustainability expenditure value = \frac{\begin{matrix}Quanity of \\ consumed resource\end{matrix}}{\begin{matrix}Global sustainably \\ quantification value\end{matrix}}$$

It is noted that other formulas or inputs may be used.

The general sustainability expenditure value may be evaluated for each type of consumed resource. For example, a user may provide the amount of water a user has consumed and the amount of electricity the user had consumed. The system may return to the user the sustainability expenditure value for water and the sustainability expenditure value for electricity.

It is a feature of the invention that the general sustainability expenditure value may be a uniform unit or standardized unit for all types of resources. This feature may allow adding the general sustainability expenditure values of different types of resources for evaluating a total general sustainability expenditure of a user. The total sustainability expenditure provides the user with a numerical value expressing the total quantity of resources the user has consumed. Thereby, providing an essential tool for the user to manage and monitor his resource consumption.

Additionally, this feature may allow comparing of the general sustainability expenditure values of the different types of resources. Comparison of general sustainability expenditure values of the different types of resources may be utilized for managing and monitoring the user's consumption.

In accordance with another embodiment, a sustainability metrology system may be provided for converting different conventional units of resources into a uniform, common unit. In accordance with an embodiment of the sustainability metrology system, a first resource may be provided in a conventional resource unit, such as kWh for electricity. The first resource may be converted into a global sustainability quantification value. Any quantity of the first resource may be provided in the conventional resource unit. The uniform, common unit value may be a quotient calculated by dividing the quantity of the first resource with the global sustainability quantification value

The uniform unit resource value may be calculated, for example:

$$Uniform unit resource value = \frac{\begin{matrix}Quantity of the \\ first resource\end{matrix}}{\begin{matrix}Global sustainably \\ quantification value\end{matrix}}$$

It is noted that other formulas or inputs may be used.

The quantity of the first resource may be any suitable quantity. For example, it may be an average consumed quantity of an average consumer within a selected geographical location during a selected time period, for example.

The data of the average consumed quantity may be obtained from any suitable database, as will be further described herein in reference to FIG. 11.

The uniform unit resource value may be calculated for a second resource or a specific quantity of a second resource, such as water, for example. Converting quantities of resources into a value with a uniform unit, may allow for addition of different types of resources and comparison between the different types of resources.

For example, the total uniform unit resource values of different types of values may be calculated for any number of N resources, for example:

$$Total uniform unit resource value = {\sum }_{i}^{N} Uniform unit resource {value}_{i}$$

where i is an index defining each uniform unit resource value.

It is noted that other formulas or inputs may be used.

In accordance with another embodiment, a sustainability metrology system may be provided for converting different conventional units of resources into a dimensionless value. The dimensionless value may be provided similarly to the method for calculating the uniform unit resource value. For example, a quantity of a resource is divided by a global sustainability quantification value, where the unit of the global sustainability quantification value is identical to the provided quantity unit.

Unless specifically stated otherwise, as is apparent throughout the specification, discussions utilizing terms such as “processing”, “computing”, “calculating”, determining” or the like, refer to the action and/or processes of a computer or computing system, or a similar electronic computing device, that manipulates and/or transforms data represented as physical, such as electronics, quantities within the computing system's registers and/or memories into other data similarly represented as physical quantities within the computing system's memories, registers or other such information storage, transmission or display devices.

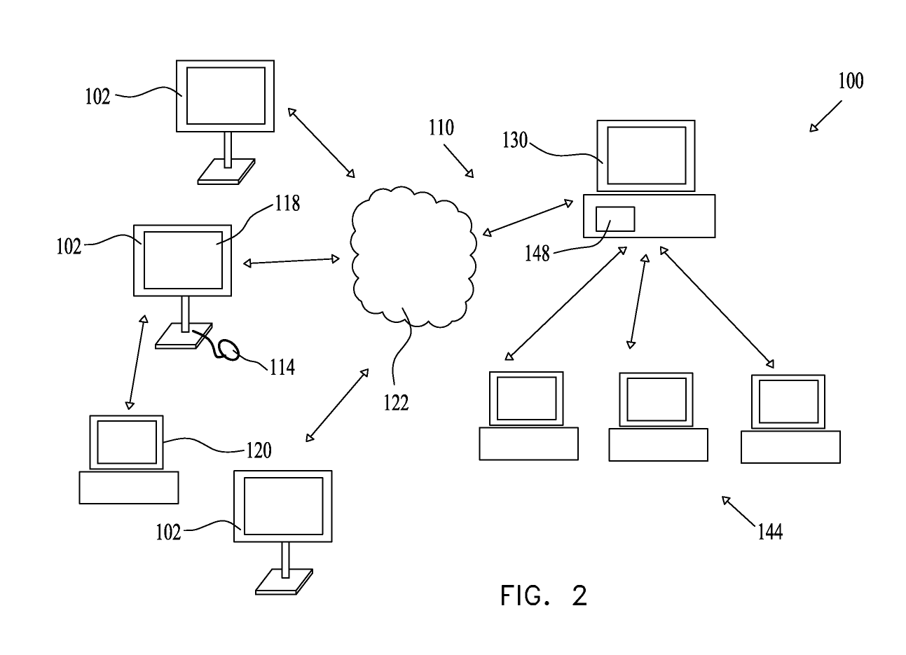

Reference is made to FIGS. 1 and 2, which are each a simplified schematic illustration of one of many computer-implemented embodiments of the sustainability management system. As seen in FIG. 1, a sustainability management system 100 may comprise a user machine 102. The user machine 102 may comprise any suitable means for communicating with a computing system 110. The user machine 102 may comprise a computer, a server, an electronic device, a workstation, a desktop, a laptop, a notebook computer, a personal digital assistant (PDA), a smart phone and a mobile phone, for example. The user machine 102 may comprise a plurality of machines.

The user machine 102 may comprise any suitable user input device 114 for allowing transmission of sustainability data to the computing system 110. The input device 114 may comprise a click wheel or mouse, keyboard, scanner, pointing device, touch screen, recorder or microphone, for example. The user machine 102 may comprise any suitable user output device 118 for providing information to a user, typically a monitor, screen or display.

The sustainability data may comprise any information relevant to calculation and evaluation of the sustainability values provided by the sustainability management system 100. For example sustainability data may comprise the sustainability efficiency value; sustainability quantification value; spatiotemporal sustainability quantification value; global sustainability quantification value; sustainability expenditure value; total sustainability expenditure value; general sustainability expenditure value; and a uniform, common unit resource value. Additionally, the sustainability data may be any information used by the sustainability management system 100 including data pertaining to consumption of the selected quantity or amount (e.g., gallons, liters, miles driven, amount of cooling by air conditioning of the selected resource (e.g. gasoline, water, automobile driving, air-conditioning use)), such as other user relevant data, typically, geographical information and financial information, for example.

The sustainability data may be stored within the user machine 102. Additionally, at least a portion of the sustainability data may be stored within a user database, such as within one or more server(s) 120, in communication with the user machine 102.

Data may be transmitted from the user machine 102 and/or server 120 to the computing system 110 in any suitable manner, such as via a network 122. The network 122 may comprise any type of network, such as a local area network (LAN), a wide area network (WAN), or a global network, for example. The network 122 may be part of, or comprise any suitable networking system, such as the Internet, for example, or Intranets. Generally, the term “Internet” may refer to the worldwide collection of networks, gateways, routers, and computers that use Transmission Control Protocol/Internet Protocol (“TCP/IP”) and other packet based protocols to communicate therebetween.

Transmission of the data from the user machine 102 and or server 120 to the computing system 110 via the network 122, may be performed by employing any communication media known in the art operative to transmit data. The communication media may comprise wired media such as twisted pair, coaxial cable, fiber optics, wave guides or any other wired media, and wireless media such as acoustic, RF, infrared or any other wireless media.

The computing system 110 may receive sustainability data in any suitable manner. The sustainability data may be physically entered by a user. Alternatively, the sustainability data may be retrieved by the computing system 110 from the user machine 102 or server 120, such as at predetermined time periods, or may be prompted anytime new data is introduced. Additionally, the computing system 110 may receive sustainability data via network 122, such as online reports, bills, receipts, credit car receipts, air miles or points, indices, bank statements and input from energy consuming devices, for example. The computing system 110 may receive sustainability data by data mining methods, user inserted data and physical measurements, for example.

The computing system 110 may comprise one or more server(s) 130. Server 130 may include components for receiving, processing, storing and transmitting the received sustainability data, as will be further described in reference to FIG. 5.

In the description the sustainability data will described as being stored within a single or plurality of databases, though it is appreciated that the sustainability data may be stored and provided in any suitable manner known in the art.

The server 130 may communicate with further databases for receiving further sustainability data and, in turn, may receive data from these databases. The databases may be stored in additional servers 144. It is noted that the further databases may be stored in any suitable location.

Additionally, a database or a plurality of databases may be stored within the server 130, such as within a hard drive 148 thereof.

A plurality of users may be in communication with the computing system 110, as seen in FIG. 2, for managing and monitoring their sustainability.

It is noted that some databases utilized in the sustainability management system 100 may be developed for the sustainability management system. Other databases may be public databases or private databases accessed in any suitable manner.

The sustainability management system 100 may be configured in a client-server model. The user machine 102 may be a local terminal operated by a user. The user machine 102 may include a processor, memory and user output device 118.

The sustainability values, such as the global sustainability quantification value, and the sustainability efficiency value, may be stored in a memory, such as the memory of server 130, or any other suitable memory, such as the memory of server 120, 144 or user machine 102.

The computing system 110 may comprise a remote server, such as server 130, which may comprise a processor and memory. An example of a hardware component assembly including the processor, memory and Input/Output (I/O) interface is shown in FIG. 5. Each of user machine 102, computing system 110, and other computers and computing systems (e.g., personal computers, portable computing devices, cellular telephones, etc.) may include one or more computing devices such as shown in FIG. 5. The computing device shown in FIG. 5 may vary as suitable, for example including multiple processors or memories, and other components.

Following computation within the computing system 110, processed sustainability data may be provided to the user machine 102 via the network 122 or in any suitable manner, employing any suitable communication media. The processed sustainability data may be provided to the user by displaying the processed data on the user output device 118. Additionally, the processed data may be provided to the user in any suitable manner, such as by a paper report, or via an e-mail message, or Short Message Service (SMS) for example. Moreover, the processed sustainability data may be stored in any suitable location for future use thereof, such as in server 120, for example.

The computation performed by computing system 110 may be performed by processors, such as processors of the servers 120, 130, 144 or user machine 102.

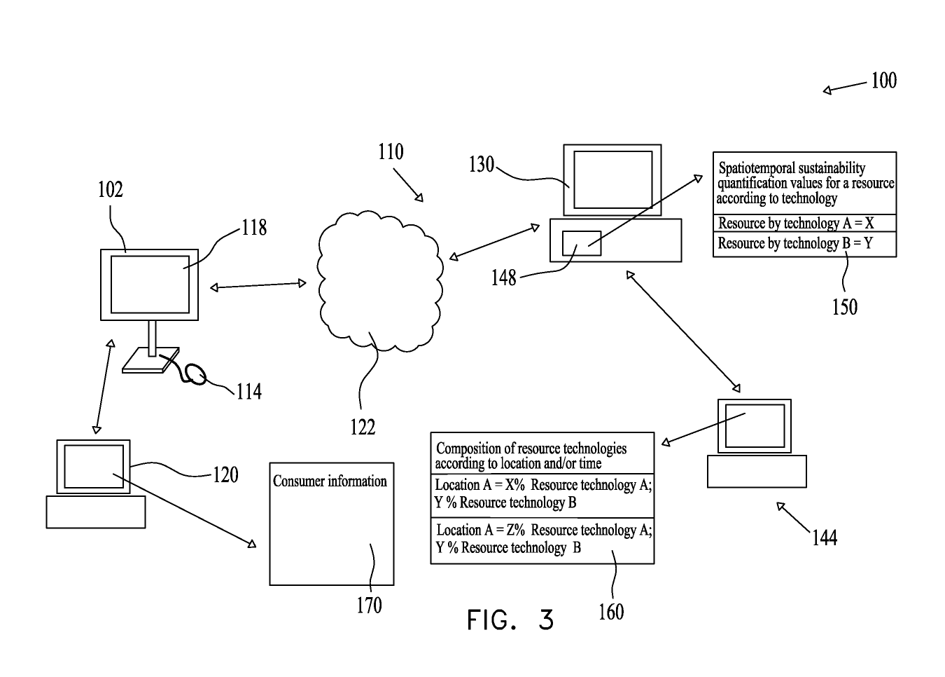

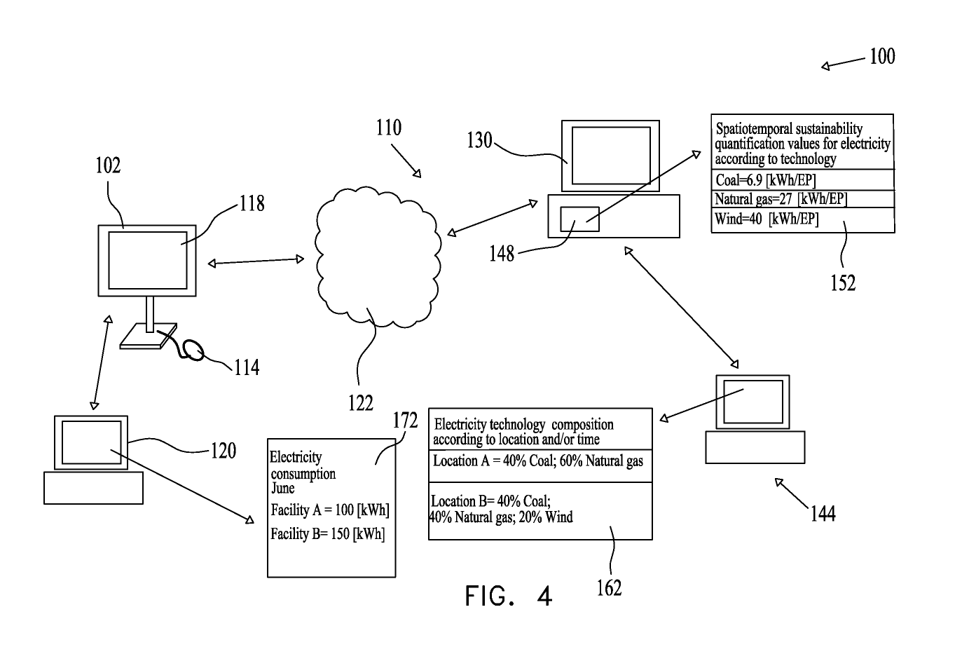

Reference is made to FIGS. 3 and 4, which are each a simplified schematic illustration of one of many computer-implemented embodiments of the sustainability management system. As seen in FIG. 3, the server 130 of the computing system 110 may comprise a database 150 including the spatiotemporal sustainability quantification values of a resource according to the resource technology. For example, the resource may be electricity. The spatiotemporal sustainability quantification values of electricity, generated by different technologies, are shown, as seen in database 152 in FIG. 4. In the example in FIG. 4 the spatiotemporal sustainability quantification values of electricity generated by a coal power plant, a natural gas power plant and a wind power plant, are shown. The server 130 may be in communication with one of the plurality of servers 144. Server 144 may comprise a database 160 including the composition of resource technologies for a plurality of locations. For example, as seen in a database 162 of FIG. 4, the composition of the electricity technologies in different locations is shown, where the composition in Location A is as follows: 40% of the electricity is generated by a coal power plant and 60% of the electricity is generated by a natural gas power plant. The composition in Location B is as follows: 40% of the electricity is generated by a coal power plant and 40% of the electricity is generated by a natural gas power plant and 20% of the electricity is generated by a wind power plant. The composition of resource production technologies for a plurality of locations may be retrieved from any suitable database. For example, where the resource is electricity, as in FIG. 4, the composition of resource production technologies for a plurality of locations may be retrieved from databases stored within servers of the electricity utility company. Similarly, where the resource is water, the composition of resource technologies for a plurality of locations may be retrieved from databases stored within servers of the water utility company. It is noted that the term “resource technology” and “resource production technology” may be used interchangeably herein.

The server 120 may comprise database 170 including user information. The user information may be any suitable information, such as a quantity of a consumed resource, consumed during a period of time. For example, the user information may be the electricity consumption of a user during the month of June in facility A and facility B, as seen in database 172 in FIG. 4.

The user information may be used to calculate the sustainability expenditure value. For example, where the user information comprises the amount of consumed electricity during the month of June, as seen in database 172, the sustainability expenditure value of Facility A or B may be calculated by dividing the amount of consumed electricity by the total spatiotemporal sustainability quantification values of electricity.

Reference is made to FIG. 5, which is a simplified schematic illustration of hardware components within a server of a system for energy efficiency and sustainability management of FIGS. 1-4. As seen in FIG. 5, a user machine, such as the user machine 102 or servers 120, 130 or 144 of FIGS. 1-4, may comprise a hardware component assembly 200 operative to perform functions of an operating system of the sustainability management system 100. A central processing unit (CPU) 202 may be provided for processing the operations of the operating system and running the algorithms and calculations of the sustainability management system 100, as described herein. The CPU 202 may be connected via a local communication channel 204 to an internal memory module 206 that supports the calculations and operation of the CPU 202. Sustainability data or any other user relevant data may be stored within an internal memory storage device 208. The internal memory storage device 208 may further contain operating system files and executable code for executing the operating system and the sustainability management system 100.

The communication channel 204 may be in communication with a network interface 210 operative to retrieve and access external data, such as from other databases. For example, the network interface 210 of the user machine 102 may be in communication with server 120 or server 130 or 144 or any other device, via network 122 and the network interface 210 of server 130 may be in communication with user machine 102 or servers 120 or 144 or any other device, via network 122.

The external data may be processed by the CPU 202 and stored within the internal memory storage device 206. An I/O interface 212 may be provided to receive input information. For example, I/O interface 212 may receive input information from the user input device 114 of user machine 102 and provide output information to the user output device 118.

The CPU 202, internal memory module 206, internal memory storage device 208, network interface 210 and I/O interface 212 may be connected therebetween via the internal memory module 204.

It is appreciated that additional hardware components may be provided to perform functions of an operating system of the sustainability management system 100. The hardware components of hardware component assembly 200 may be formed of conventional components known in the art.

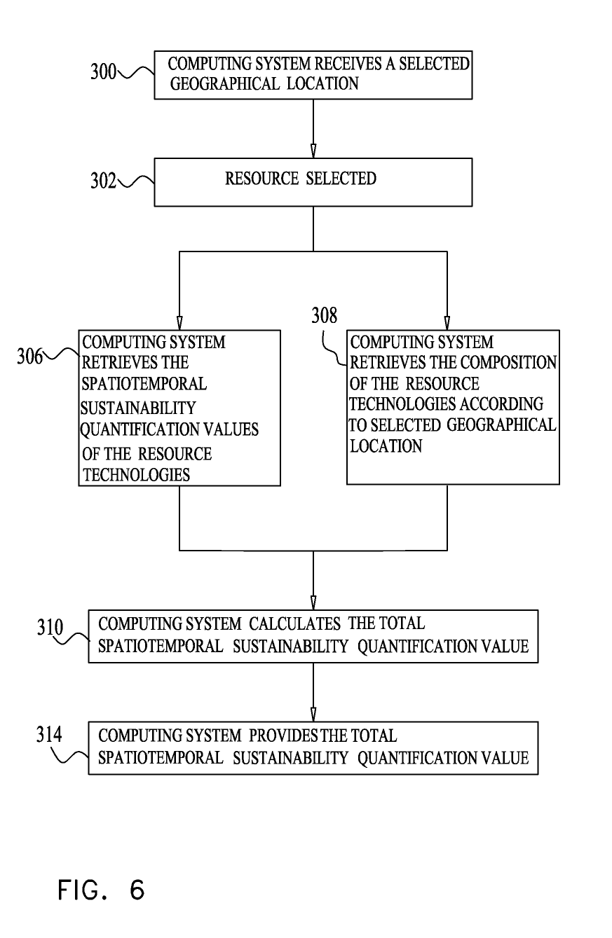

Reference is made to FIG. 6, which is a simplified flowchart of a method for energy efficiency and sustainability management of the system of FIGS. 1-4. As seen in step 300, the computing system 110 receives a selected geographical location. The selected geographical location may be transmitted from the user machine 102 to the server 130 of the computing system 110 via the network 122, as described in reference to FIGS. 1 and 2. Alternatively, the selected geographical location may be provided by a user in any other suitable manner. The selected geographical location may be stored within the server 120 or within the computing system 110, such as within server 130.

The selected geographical location may be any location of interest, such as an address, city, county, state or country, for example. The location may be the location of a user, such as the address of a company or individual, for example. In another example the location may be a relatively large geographical area comprising a plurality of locations, such as a country comprising a plurality of states.

It is noted that in some embodiments a time or time span of interest may be provided by the user in place of the selected geographical location or in addition thereto.

Turning to step 302, a resource may be selected. The user may select the resource via the input device 114. The selected resource may be transmitted from the user machine 102 to the server 130 of the computing system 110, via the network 122. Alternatively, the computing system 110 may be programmed to select a resource.

In step 306 the computing system 110 may retrieve the spatiotemporal sustainability quantification values of a resource according to the resource technology, such as from databases 150 and 152 in respective FIGS. 3 and 4. In step 308 the computing system 110 may retrieve the composition of the consumed resource technologies according to the selected geographical location, such as from databases 160 and 162 in respective FIGS. 3 and 4. For example, where the resource is electricity, the composition of the consumed resource technologies may be retrieved from databases stored in servers of an electric company.

The computing system 110 may calculate the total spatiotemporal sustainability quantification value for the selected resource in step 310. The calculation may be performed by an algorithm processed within server 130 or any other suitable server. As described herein, the algorithm may comprise the algorithm utilizing the formula for adding parallel resistors.

The total spatiotemporal sustainability quantification value may be provided to the user, as seen in step 314, in any suitable manner, such as via the user output device 118 or by providing a paper report, for example. Alternatively, the total spatiotemporal sustainability quantification value may be stored within the computing system 110, such as within the server 130 or 144 or user machine 102 or server 120, for future use.

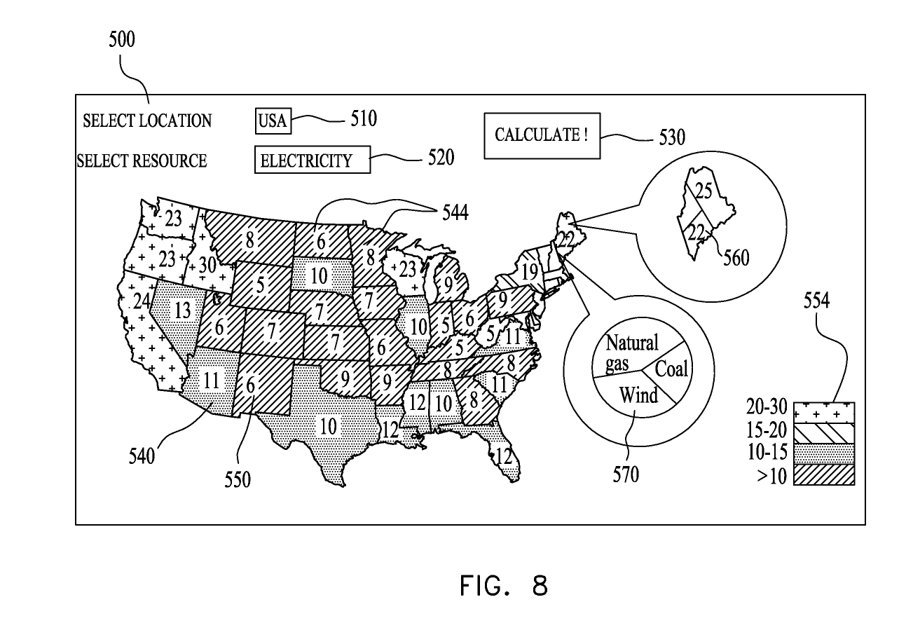

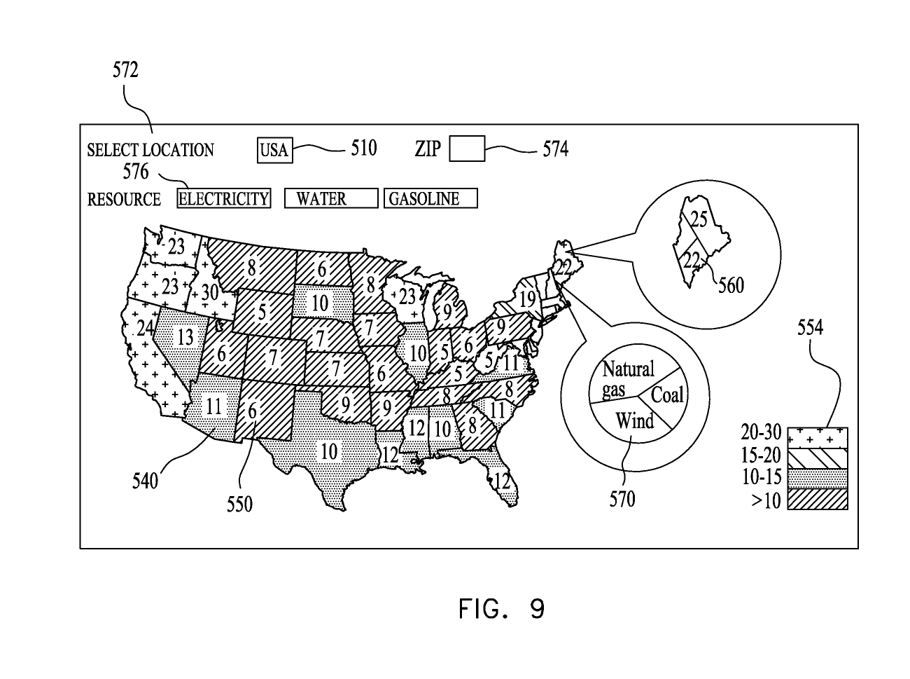

The computing system 110 may be programmed to continue calculating a plurality of spatiotemporal sustainability quantification values for a plurality of respective geographical locations. Alternatively, where the selected geographical location comprises sub-locations, a plurality of spatiotemporal sustainability quantification values may be calculated for each sub-location. An example of a display of a plurality of spatiotemporal sustainability quantification values is shown in FIGS. 8 and 9.

The sustainability management system may further provide aids for energy efficiency and sustainability management. For example the computing system 110 may calculate the spatiotemporal sustainability quantification of different products or projects. The computing system 110 may utilize algorithms known in the art for selecting the product with the optimal, greatest energy efficiency. This selection may be provided to the user on the user display 118 of the user machine 102 or in any other suitable manner.

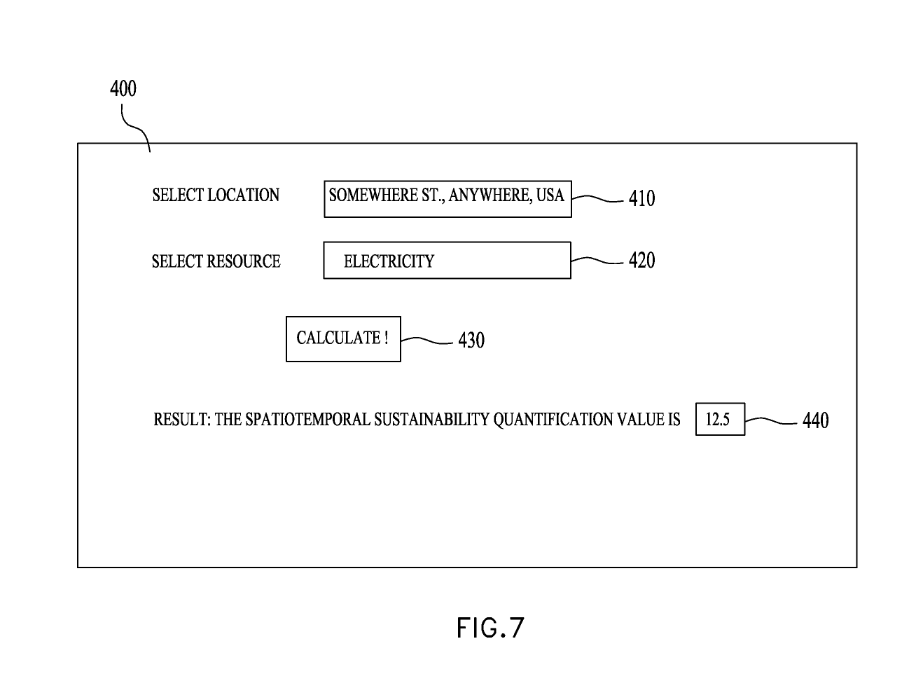

The spatiotemporal sustainability quantification value may be presented to the user in any suitable manner. Non-limiting examples of a user interface and display are illustrated in FIGS. 7-10.

In accordance with an embodiment, step 306 and 308 (and other operations discussed herein) may be performed by the computing system 110 which retrieves data from geospatial databases calculating the spatiotemporal sustainability quantification value as described in step 310. Other systems may perform the operations described herein. The geospatial database may comprise two types of tables: (a) a first flat indexed table comprising the spatiotemporal sustainability quantification value for each of the plurality of resource technologies, such as for the technologies for generating electricity, technologies for producing water, technologies for producing natural gas, transportation technologies and technologies for disposing waste, and (b) a second geospatial index that maps each geographical region to its corresponding record entry in the flat table. Other numbers and types of databases may be used, and other ways of organizing data may be used.

In one embodiment, a geospatial index may be constructed from polygons of geographic coordinates (e.g., longitude, latitude, global positioning system coordinates, etc.), wherein each polygon represents a geographical region, such as a state, county, zip or postal code, as well as customized regions and specific points. The data content of the flat tables may also be indexed by date and time, such that there is an option to maintain and query different data values for different times. Generally, this structure may enables high flexibility in providing different data based on a geographic location and/or time, as well as enabling progressive improvements. As more data is collected or refined, the database may accommodate these updates and make them available to be used by the computing system 110.

The computing system 110 may calculate the spatiotemporal sustainability quantification value utilizing or executing an iterative algorithm for any selected geographical location and resource. For example: (i) the computing system may identify the coordinates of that selected geographical location by using reverse geo-coding and execute a query to the geospatial index. The query result may return all defined regions that contain sustainability data for that geographical location. (ii) the computing system 110 may select the geographical location to be used for calculation of the spatiotemporal sustainability quantification value based on the highest resolution available for the selected geographical location. This may be implemented by upfront labeling of the polygons to different layers and choosing the deepest layer. Alternatively, this may be performed during runtime, choosing the data that is indexed by the smallest polygon—smallest by region or by perimeter. Thus, for example the computing system 110 may utilize the zip or postal-code region if such is available rather than the state or province level region. Such an approach provides a fallback mechanism that may automatically adjust when more data for refined regions are collected. Other methods of defining geographical areas may be used.

The calculation of the spatiotemporal sustainability quantification value of different resources may be executed in parallel, using a multithreaded approach. This may provide a better response time and better utilization of computational resources, such as multiple CPUs.

Reference is made to FIG. 7, which is a simplified illustration of a user interface and display according to the flowchart in FIG. 6. As seen in FIG. 7, a user interface 400 may be displayed on the user output device 118, such as on a monitor of the user machine 102 or in any other suitable manner, such as on a paper report. The user interface 400 may include control modules or input fields to allow the user to input data, typically via the user input device 114, by indicating on a button or other portion of the user interface 400.

A user may enter a geographical location within a location field 410. The geographical location may be entered by typing the location, by selecting an option from a drop-down menu or in any other suitable manner. A resource field 420 may be provided for allowing the user to select a resource. The resource may be entered by typing the resource, or by selecting an option from a drop-down menu or in any other suitable manner. As described in reference to FIG. 6, in other embodiments the resource may be selected by the computing system 110.

It is noted that the resource selected in field 420 and throughout the description may include electricity, water, land transportation, air transportation, sea transportation, waste disposal, commodities, merchandise, goods, land, materials, use of utilities, for example.

A prompter, such as a prompter button 430, when pressed or operated by a user, may prompt the computing system 110 to calculate the spatiotemporal sustainability quantification value according to the selected data within the location field 410 and resource field 420. Alternatively, the prompter may not be used and the computing system 110 may perform the calculations upon occurrence of a data entry event. The resultant spatiotemporal sustainability quantification value may be displayed in a result field 440. The spatiotemporal sustainability quantification value may be displayed in any suitable manner, such as a one dimensional value, two dimensional value, profile, graph or chart.

In a non-limiting example, a user enters an address at the location field 410. The user selects “electricity” as the resource within the resource field 420. Thereafter the user presses the prompter button 430.

The computing system 110 may calculate the spatiotemporal sustainability quantification value as described in reference to FIG. 6. The resultant spatiotemporal sustainability quantification value may be, as shown in the abovementioned examples, 12.5 [kWh/EP].

Thus it is shown that the sustainability management system 100 may provide a user with information which may be utilized for monitoring his energy efficiency and sustainability management. As described, a user may utilize the resultant spatiotemporal sustainability quantification value to monitor the efficiency of his consumption of the resource. In a non-limiting example, the sustainability management system may provide a first and second spatiotemporal sustainability quantification value, each of a different location. Accordingly, the user may select the preferable location, wherein the spatiotemporal sustainability quantification value, and hence the resource efficiency, is greater.

Reference is made to FIG. 8, which is an additional simplified illustration of a user interface and display according to the flowchart in FIG. 6. As seen in FIG. 8, a user interface 500 may be displayed on the user output device 118, such as on a monitor of the user machine 102 or in any other suitable manner, such as on a paper report. The user interface 500 may include control modules or input fields to allow the user to input data, typically via the user input device 114, by indicating on a button or other portion of the user interface 500.

A user may enter a geographical location within a location field 510. The geographical location may be entered by typing the location, or by selecting an option from a drop-down menu or by selecting a location on a map or in any other suitable manner. A resource field 520 may be provided for allowing the user to select a resource. The resource may be entered by typing the resource, or by selecting an option from a drop-down menu or in any other suitable manner. As described in reference to FIG. 6, in other embodiments the resource may be selected by the computing system 110.

A prompter, such as a prompter button 530, may prompt the computing system 110 to calculate the spatiotemporal sustainability quantification value according to the selected data within the location field 510 and resource field 520. Alternatively, the prompter button may not be used and the computing system 110 may perform the calculations upon occurrence of a data entry event. As seen in FIG. 8, the resultant spatiotemporal sustainability quantification value may be displayed in a geographical map 540. The map 540 may be divided into a plurality of sub-locations 544. The spatiotemporal sustainability quantification value may be provided for at least one sub-location and shown in any suitable configuration. As seen in FIG. 8, a numerical value 550 may be depicted on the sub-location or at any other suitable portion of the user interface 500. Additionally, a color coded scale 554 or any other scale may illustrate the spatiotemporal sustainability quantification value of at least some sub-locations 544.

Additional sustainability data may be provided and/or displayed. For example, an enlarged map of the sub-location, showing the spatiotemporal sustainability quantification values of a plurality of areas 560 within the sub-location, may be shown. Additionally, a composition of the resource technologies within a sub-location 544 may be displayed, as seen in chart 570. Moreover, any additional information pertaining to the map 540, such as geographical information, typically mountains, roads and state borders, may be provided and/or displayed.

The additional sustainability data and information may be selected by the user in any suitable manner such as by pointing, zooming-in, zooming-out or dragging, any location within the map 540 or by entering an address of a desired location in the location field 510.

In a non-limiting example, a user enters a country at the location field 510. The user selects “electricity” as the resource within the resource field 520. Thereafter the user presses the prompter button 530. The server 130, upon being prompted by the user machine 102, accesses the databases on servers 144 for receiving the spatiotemporal sustainability quantification value of each sub-location 544 and area 560, as described herein.

Additional prompts may be utilized for accessing the databases on servers 144 for receiving additional data, such as sustainability data or information relating to map 540. These prompts may include, clicking, dragging, zooming, pointing and entering an address, for example.

Thus it is shown that the sustainability management system 100 may provide a user with information which may be utilized for monitoring his energy efficiency and sustainability management. As described, a user may utilize the resultant spatiotemporal sustainability quantification value to monitor the efficiency of his consumption of the resource, such as by comparing the resultant spatiotemporal sustainability quantification value of the locations on the map 540, for example.

Reference is made to FIG. 9, which is an additional simplified illustration of a user interface and display according to the flowchart in FIG. 6. A user interface and display 572 illustrates additional features displayed in user interface 500 FIG. 8. As seen in FIG. 9, a user may select a specific geographical location by selecting a zip or postal code in the selection field 574. The user may select a resource from the plurality of resources in field 576, such as electricity, water or gasoline. The user may select the desired resource by clicking thereon or in any other suitable manner.

Thus it is shown that the sustainability management system 100 may provide a user with information which may be utilized for monitoring his energy efficiency and sustainability management. As described, a user may utilize the resultant spatiotemporal sustainability quantification value to monitor the efficiency of his consumption of the resource, such as by comparing the resultant spatiotemporal sustainability quantification value of the locations on the map 540, for example and further comparing the spatiotemporal sustainability quantification values of different resources, such as water and electricity, for example.

Additionally, a user may utilize the resultant spatiotemporal sustainability quantification value to compare the energy efficiency of different scenarios, such as living in a first geographical location verses living in a second geographical location, for examples.

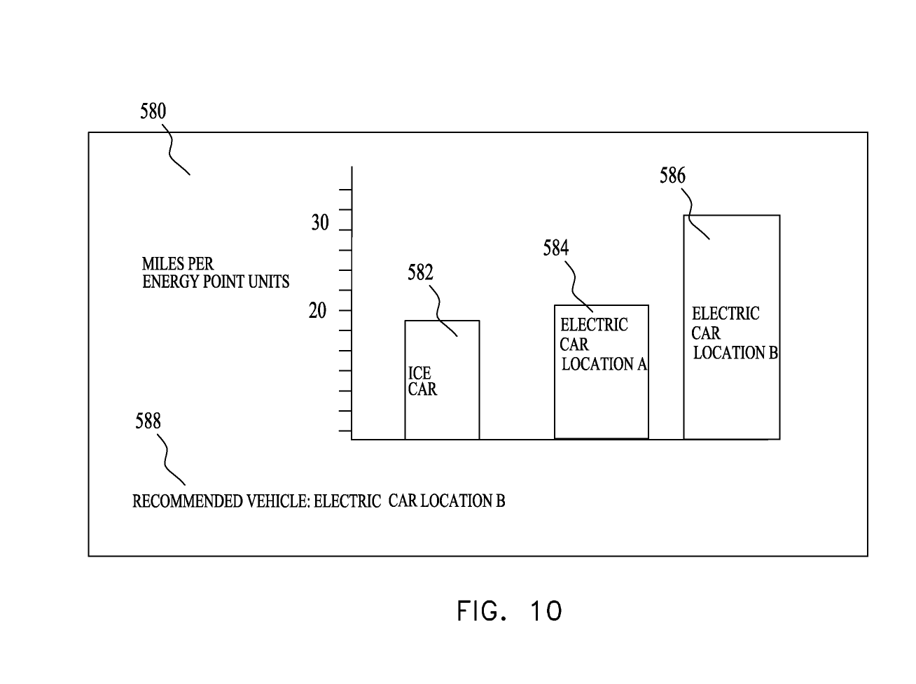

Reference is made to FIG. 10, which is a simplified illustration of a display according to the flowchart in FIG. 6. As seen in FIG. 10, a display 580 may be shown on the user output device 118, such as on a monitor of the user machine 102 or in any other suitable manner, such as on a paper report.

A user may utilize the system 100 to select a product by comparing the spatiotemporal sustainability quantification values of different models of the product. As seen for example in FIG. 10, three cars are compared to each other. The car mileage per Energy Point units is calculated for each car to determine the car with the highest mileage per Energy Point units.

A user may select a specific car model comprising an internal combustion engine (ICE). The user may further select an electric car model in any suitable manner, such as by selection fields (not shown). Other types of cars may be chosen (hybrid, large, small, etc.). The global sustainability quantification value of gasoline, is by definition, one gallon per Energy Point unit.

The sustainability efficiency value may be calculated as 0.88 due to use of resources and materials to manufacture the car. Additionally, the adverse environmental effect due to manufacturing and disposal of the car battery may be included in the sustainability efficiency value. Therefore the spatiotemporal sustainability quantification value is =1*0.88 [gallons/EP].

The computing system 110 may retrieve the miles per gallon (MPG) for the selected car model. For example, the car model MPG may be retrieved from the car manufacturer's database on server 144, or from another database. For an Internal Combustion Engine (ICE) car the MPG may be for example 20 MPG.

The spatiotemporal sustainability quantification value is multiplied by the MPG to calculate the miles per Energy Points of the ICE car: 0.88*20=17.6 [miles/EP], as seen in bar chart 582.

The spatiotemporal sustainability quantification value of the electric cars in location A and location B may be calculated. In this example, in location A the electricity is generated in a coal power plant and thus the electricity spatiotemporal sustainability quantification value in location A is 6.9 [kWh/EP], as described herein. In location B 40% of the electricity is generated in a coal power plant and 60% of the electricity is generated in a natural gas combined cycle power plant. Therefore the spatiotemporal sustainability quantification value of electricity in location B is 12.5 [kWh/EP], as described herein. The mileage per kWh for the electric car model may be retrieved by the computing system 110 from the electric car manufacture's database. In this example the mileage per kWh is 3.

Accordingly, the miles per Energy Points in location A is 6.9*3=20.7 [miles/EP] as seen in bar chart 584. The miles per Energy Points in location B is 12.5*3=37.5 [miles/EP] as seen in bar chart 586.

It is noted that the spatiotemporal sustainability quantification value of the electric cars may vary according to the time the car battery is recharged.

The sustainability efficiency value of electricity used at off-peak hours, such as at nighttime, may be greater than during the day, which is during peak hours, wherein the use of electricity is greatest. Therefore, the spatiotemporal sustainability quantification value of an electric car recharged at nighttime is greater than the spatiotemporal sustainability quantification value of an electric car recharged during the day. In a non-limiting exampling, off-peak charging improves the spatiotemporal sustainability quantification value by 10% thereof.

The computing system 110 may retrieve the time period wherein the car was charged in any suitable manner. For example, the computing system 110 may retrieve the charging time period from databases stored in a server of an electric company or from a utility bill listing the time period of electricity consumption.

The sustainability efficiency value of the ICE car and the electric cars described herein may include additional adverse environmental effects accrued during the lifetime of the car. For example, use of materials for manufacturing the car, use of land and sea transportation for transporting the car, resources invested for disposing the car after use, or any other adverse environmental effect due to resources invested in the car.

From comparing the bar charts 582, 584 and 586 it can be seen that selecting the electric car in location B is the optimal selection for sustainability management and energy efficiency. A recommendation for the selected car may appear on the display, as seen at suggestion field 588.

Thus it is shown that the sustainability management system 100 may provide a user with information which may be utilized for monitoring his energy efficiency and sustainability management. As described, a user may utilize the resultant spatiotemporal sustainability quantification value to monitor the efficiency of his consumption of the resource, such as by comparing the resultant spatiotemporal sustainability quantification value of different products. Additionally, a user may utilize the resultant spatiotemporal sustainability quantification value to compare the energy efficiency of different scenarios, such as living in a first geographical location verses living in a second geographical location. Moreover, a user may utilize the resultant spatiotemporal sustainability quantification value to project the energy efficiency of future activities, for example.

Reference is now made to FIG. 11, which is a simplified flowchart of a method for energy efficiency and sustainability management of the system of FIGS. 1-4.

As seen in step 600 the computing system 110 may receive a quantity associated with a resource. This quantity may be the amount of a resource the user has consumed, such as an amount of kWh of consumed electricity or an amount of gallons of consumed water or gasoline.

The quantity associated with a resource may be a quantity of consumed resource. The consumption may be at a specific time in the past, for example, a quantity of electricity consumed by a company in the past year. Additionally, the consumption may be during an ongoing period, wherein the sustainability management system provides ongoing reports regarding use of the resources. Moreover, the consumption may have not actually occurred, but rather be a projected future consumption, such as a hypothetical quantity of gasoline used in a first model of an ICE car verses a second model of an ICE car, for example.

The quantity may be transmitted from the user machine 102 to the server 130 of the computing system 110 via the network 122, as described in reference to FIGS. 1 and 2. Alternatively, the quantity may be provided by a user in any other suitable manner. The quantity may be stored within the server 120 or within the computing system 110, such as within server 130.

It is noted that the computing system 110 may be programmed to perform step 600, without the user performing the steps. For example, the computing system 110 may be programmed to access online reports via network 122 or a user database, such as a database stored in user machine 102 or server 120 or servers 130 and 144, at predetermined time intervals for retrieving bills, receipts, credit car receipts, air miles or points, indices, bank statements and input from energy consuming devices, for example.

When the provided quantity is not the consumed quantity, as seen in step 608, the computing system 110 may convert the provided quantity to an amount of the consumed resource, as seen in step 610. The conversion may be performed by the computing system 110 receiving conversion data from an additional server 144 for performing the conversion. For example, wherein the fee of a utility bill is provided, the computing system 110 may convert the fee to be paid to the utility company to the consumed amount of resource by dividing the fee by the cost per resource unit in the selected geographical location, and possibly factoring in taxes, fees, etc. The cost per resource unit in the selected geographical location may be available from any suitable database. For example, wherein the resource is electricity, the cost per resource unit may be retrieved from databases stored in servers of the electric company. The computing system 110 may retrieve any applicable data for performing the conversion, such as provided discounts, rates and deducted taxes, for example.

It is noted that wherein a user does not provide a quantity associated with the resource, the computing system 110 may utilize other applicable data. For example, wherein a user does not provide the quantity of electricity he consumed, the computing system may retrieve the average consumption in the geographic location of the user and utilize the average consumption for calculating the sustainability expenditure value. For example, wherein the resource is electricity, the average consumption may be retrieved from databases stored in servers of the electric company.

As seen in step 612, the computing system 110 may receive a selected geographical location. The selected geographical location may be transmitted from the user machine 102 to the server 130 of the computing system 110 via the network 122, as described in reference to FIGS. 1 and 2. Alternatively, the selected geographical location may be provided by a user in any other suitable manner. The selected geographical location may be stored within the server 120 or within the computing system 110, such as within server 130.

The selected geographical location may be any location of interest, such an address, city, county, state or country, for example. The location may be the location of a user, such as the address of a company or individual, for example. In another example the location may be a relatively large geographical area comprising a plurality of locations, such as a country comprising a plurality of states.

It is noted that in some embodiments a time or time span of interest may be provided by the user in place of the selected geographical location or in addition thereto. The time span may be in the past, present or future.

Turning to step 614, a resource may be selected. The user may select the resource via the input device 114 and may transmit his selection from the user machine 102 to the server 130 of the computing system 110, via the network 122.

It is noted that step 614 for selecting the resource may not be used and the computing system 110 may recognize the selected resource from step 600 according to the provided quantity of consumed resource.

In step 620 the computing system 110 may provide the total spatiotemporal sustainability quantification value, as calculated according to the steps described in reference to FIG. 6.

In one embodiment, the computing system 110 may retrieve the spatiotemporal sustainability quantification values from data in a spatiotemporal sustainability quantification value map, such as map 540 of FIG. 8.

In step 630 the sustainability expenditure value may be calculated. For example an algorithm may be executed or employed comprising the quantity of consumed resource and the total spatiotemporal sustainability quantification value. In one embodiment, the sustainability expenditure value may be a quotient of the quantity of consumed resource divided by the spatiotemporal sustainability quantification value. The servers 130 or 144 or 120 or user machine 102 may execute the algorithm for calculating the sustainability expenditure value.

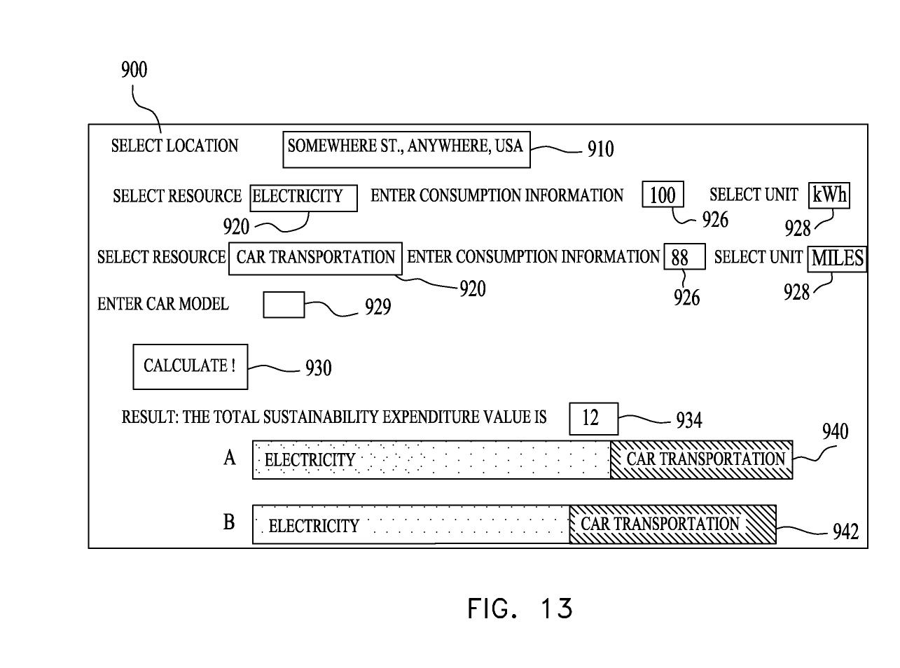

Additionally, the sustainability expenditure value may be further modified according to additional user information, as will be described in reference to FIG. 13.

The sustainability expenditure value may be provided to the user, as seen in step 640, in any suitable manner, such as via the user output device 118 or by providing a paper report, for example. Alternatively, the sustainability expenditure value may be stored within the computing system 110, such as within the server 130 or 144 or 120 or user machine 102 for future use.

The steps described herein for calculating the sustainability expenditure value may be performed for a plurality of resources. For example, the sustainability expenditure value of electricity may be calculated and thereafter the sustainability expenditure value for water may be calculated.

A sustainability management system and method according to one embodiment may further provide aids for energy efficiency and sustainability management. For example the computing system 110 may calculate the sustainability expenditure value of different products or the uses of different products. The computing system 110 may utilize algorithms known in the art for selecting, based on energy efficiency, sustainability, equivalency, or other calculations or results produced by embodiments of the present invention, the product with the optimal, highest energy efficiency. This selection may be provided to the user on the user display 118 of the user machine 102 or in any other suitable manner. Additionally, the computing system 110 may be programmed to provide suggestions for optimizing the energy consumption, such as a suggestion for minimizing the sustainability expenditure value of a resource. An example for a suggestion is a recommendation to consume a smaller quantity of the resource.

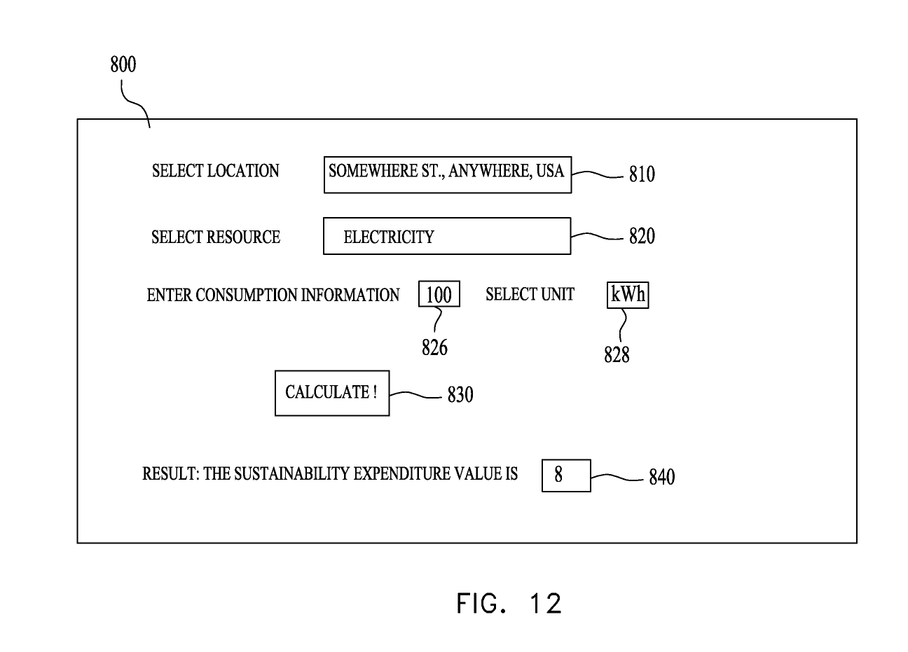

The sustainability expenditure value may be presented to the user in any suitable manner. Non-limiting examples of a user interface and display of the sustainability expenditure values are illustrated in FIGS. 12-21.

In another embodiment, steps 600 and 610 may be replaced by selection of any suitable quantity of a resource. The selection may be performed by the user or by a predetermined selection by the computing system 110. The quantity may be, for example, the average consumption of the resource. In step 630 a general sustainability expenditure value may be calculated by employing an algorithm comprising the quantity of the resource and the spatiotemporal sustainability quantification value. In one embodiment, the general sustainability expenditure value may be a quotient of the quantity of the resource divided by the spatiotemporal sustainability quantification value. The general sustainability expenditure value may be a dimensionless value or may be measured in a uniform unit, such as an Energy Point unit.

Thus, a plurality of resources that conventionally are measured in different units, may be expresses by a uniform, common unit. This may allow comparing the different resources to each other. Additionally, a plurality of resources, all expressed in a uniform, common unit, may be calculated to be expressed as a consolidated numerical value.

Reference is made to FIG. 12, which is a simplified illustration of a user interface and display according to the flowchart in FIG. 11. As seen in FIG. 12, a user interface 800 may be displayed on the user output device 118, such as on a monitor of the user machine 102 or in any other suitable manner, such as on a paper report. The user interface 800 may include control modules or input fields to allow the user to input data, typically via the user input device 114, by indicating on a button or other portion of the user interface 800.

A user may enter a geographical location within a location field 810. The geographical location may be entered by typing the location, or by selecting an option from a drop-down menu or in any other suitable manner. A resource field 820 may be provided for allowing the user to select a resource. A consumption field 826 may be provided for allowing the user to enter a quantity of the consumed resource. Additionally, a unit field 828 may be provided for allowing the user to enter the appropriate resource unit. The user may fill in or enter information into fields 810, 820, 826 and 828 by typing, or by selecting an option from a drop-down menu or in any other suitable manner.

As described in reference to FIG. 11 in some embodiments the resource field 820 may not be used and the resource may be recognized by the computing system 110 from the quantity entered in the consumption field 826 or the unit entered in the unit field 828.

A prompter, such as a prompter button 830, may (when activated or operated by a user) prompt the computing system 110 to calculate the sustainability expenditure value according to the selected data within the location field 810, resource field 820, consumption field 826 or unit field 828. Alternatively, the prompter button may not be used and the computing system 110 may perform the calculations upon occurrence of a data entry event. The resultant sustainability expenditure value may be displayed in a result field 840. The sustainability expenditure value may be displayed in any suitable manner, such as a one dimensional value, two dimensional value, profile, graph or chart.

In a non-limiting example, a user enters an address at the location field 810. The user selects “electricity” as the resource within the resource field 820. The user enters the quantity of “100” in the consumption field 826 and “kWh” in the unit field 828. Thereafter the user presses the prompter button 830. The server 130, upon being prompted by the user machine 102, accesses the databases on servers 144 for calculating the spatiotemporal sustainability quantification value, as described herein in reference to FIG. 7, wherein the resultant spatiotemporal sustainability quantification value is 12.5 [kWh/EP], approximately.

The resource quantity may be divided by the spatiotemporal sustainability quantification value, resulting in the sustainability expenditure value of 100/12.5=8 [EP], and may be displayed in the result field 840.

Thus it is shown that the sustainability management system 100 may provide a user with information which may be utilized for monitoring his energy efficiency and sustainability management. As described, a user may utilize the resultant sustainability expenditure value to monitor the efficiency of his consumption of the resource, such as by comparing the resultant sustainability expenditure value of resources during a period of time. Additionally, a user may utilize the resultant sustainability expenditure value to compare the energy efficiency of different scenarios, such as living in a first geographical location verses living in a second geographical location. Moreover, a user may utilize the sustainability expenditure value to project the energy efficiency of future activities or use of products, for example.

Reference is made to FIG. 13, which is a simplified illustration of a user interface and display according to the flowchart in FIG. 11. As seen in FIG. 13, a user interface 900 may be displayed on the user output device 118, such as on a monitor of the user machine 102 or in any other suitable manner, such as on a paper report. The user interface 900 may include control modules or input fields to allow the user to input data, typically via the user input device 114, by indicating on a button or other portion of the user interface 900.

A user may enter a geographical location within a location field 910. A plurality of resource fields 920 may be provided for allowing the user to select a plurality of resources. A plurality of consumption fields 926 may be provided for allowing the user to enter a quantity of the consumed resources. Additionally, a plurality of unit fields 928 may be provided for the user to enter the appropriate resource units. Additional fields 929 may be included for the user to provide further information pertaining to the consumed resource. The user may fill in or enter information into fields 910, 920, 926, 928 and 929 by typing, or by selecting an option from a drop-down menu or in any other suitable manner. Other or different information may be entered.

As described in reference to FIG. 11, in some embodiments, the resource fields 920 may not be used and the resource may be recognized by the computing system 110 from the quantity entered in the consumption field 926 or the unit entered in the unit field 928.

A prompter, such as a prompter button 930, may prompt the computing system 110 to calculate the sustainability expenditure value according to the selected data within the location field 910, resource field 920, consumption field 926 or unit field 928. Alternatively, the prompter button may not be used and the computing system 110 may perform the calculations upon occurrence of a data entry event. The resultant sustainability expenditure value may be displayed in a result field 934. The sustainability expenditure value may be displayed in any suitable manner, such as a one dimensional value, two dimensional value, profile, graph or chart. As seen on FIG. 12, a plurality of consumed resources may be provided. The total sustainability expenditure value of the user may be displayed as described in the following example.

In a non-limiting example, a user enters an address at the location field 910. The user selects “electricity” as the first resource within the resource field 920. The user enters the quantity of “100” in the first consumption field 926 and “kWh” in the first unit field 928. The user selects “car transportation” as the second resource within the resource field 920. The user enters the quantity of “88” in the second consumption field 926 and “Miles” in the second unit field 928. Upon selecting car transportation the user may be requested to enter the car model or provide other information in field 929.

Thereafter the user presses the prompter button 930. The server 130, upon being prompted by the user machine 102, accesses the databases on servers 144 for calculating the spatiotemporal sustainability quantification value for electricity, as described herein in reference to FIG. 12 wherein the resultant sustainability expenditure value for electricity is 100/11.39=8 [EP].

The server 130 may accesses the databases on servers 144 for calculating the spatiotemporal sustainability quantification value for car transportation. The global sustainability quantification value of gasoline is in one embodiment by definition 1 [gallon/EP] (other values for global sustainability quantification values, and other standardized units, may be used). The sustainability efficiency value of an internal combustion engine car may be 0.88 as described in reference to FIG. 10. As with other efficiency values discussed herein, other values may be used.

Therefore the spatiotemporal sustainability quantification value for car transportation is 0.88

The server 130 retrieves the MPG for the selected car model. For example, the car model MPG may be retrieved from the car manufacturer's database via server 144. For an Internal Combustion Engine (ICE) car the MPG may be for example 25 MPG.

The spatiotemporal sustainability quantification value is multiplied by the MPG to calculate the miles per Energy Points of the car: 0.88*25=22 [miles/EP]

The resource quantity may be divided by spatiotemporal sustainability quantification value, resulting in the sustainability expenditure value for car transportation of 88/22=4 [EP].

The total sustainability expenditure value may be calculated by adding the sustainability expenditure value for electricity with the sustainability expenditure value for car transportation, resulting in the total sustainability expenditure value of 8+4=12 as seen in the result field 934.

The total sustainability expenditure value may be displayed in a bar chart 940 with segments representing each of the sustainability expenditure values.

It is noted that the use of air transportation may be calculated similar to the way the use of car transportation is calculated. The server 130 may access the databases on servers 144 for calculating the spatiotemporal sustainability quantification value for air transportation. The global sustainability quantification value of gasoline may be 1 [gallon/EP]. The server 130 may retrieves the MPG for the airplane to calculate the spatiotemporal sustainability quantification value of miles per Energy Point. For example, the user may provide his flight information and accordingly the server may retrieve the aircraft model from the airline company databases stored in servers 144. The aircraft MPG may be retrieved from the aircraft manufacturer's database on server 144. The sustainability expenditure value may be modified according to additional user information. For example, the sustainability expenditure value for air transportation may also include the occupancy of the aircraft so as to adapt the sustainability expenditure value for a single passenger. For example, for a model 747 airplane the MPG for a single passenger may be considered to be 60 MPG. The air mileage may be provided by the user. Alternatively, the air mileage may be calculated by the server 130 following retrieval of air travel points or other flight information. The air travel points or other flight information may be retrieved by server 130 from the user machine 102 or server 120 or any other server 144. The air mileage is divided by spatiotemporal sustainability quantification value, resulting in the sustainability expenditure value for air transportation.

Additional features may be provided on the user interface 900 for monitoring the sustainability expenditure value of a user. For example, a bar chart 942 showing the total sustainability expenditure value in comparison with the total sustainability expenditure value of bar chart 940 may be displayed.

The bar charts 940 and 942 may each display the total sustainability expenditure value of different consumers, such as company A in comparison with company B, thus comparing the resource consumption of different companies. Alternatively, bar charts 940 and 942 may each display the total sustainability expenditure value for different time periods, such as a first yearly quarter compared to a second yearly quarter, thereby allowing a user to monitor his resource consumption over a desired time period. Moreover, bar charts 940 and 942 may each display the total sustainability expenditure value for different individuals, such as a user and his peer. Moreover, bar charts 940 and 942 may each display the total sustainability expenditure value for different individuals in a social network.

Additionally, bar chart 940 may be the sustainability expenditure value of a user comparing his sustainability expenditure value with an average sustainability expenditure value of another entity, shown in bar chart 942, such as the average sustainability expenditure value of consumers in his state, for example.

The total sustainability expenditure value shown in bar chart 942 may be data which has been stored in any one of the servers, such as server 120,130 or 144 or user machine 102 for example.

Thus it is shown that the sustainability management system 100 may provide a user with information which may be utilized for monitoring his energy efficiency and sustainability management. As described, a user may utilize the resultant sustainability expenditure value to monitor the efficiency of his consumption of the resource, such as by comparing the resultant sustainability expenditure value of resources during a period of time. Additionally, a user may utilize the resultant sustainability expenditure value to compare the energy efficiency of different scenarios, such as living in a first geographical location verses living in a second geographical location. Moreover, a user may utilize the sustainability expenditure value to project the energy efficiency of future activities or use of products. Furthermore the user may compare his sustainability expenditure value to an average sustainability expenditure value or a benchmark sustainability expenditure value.

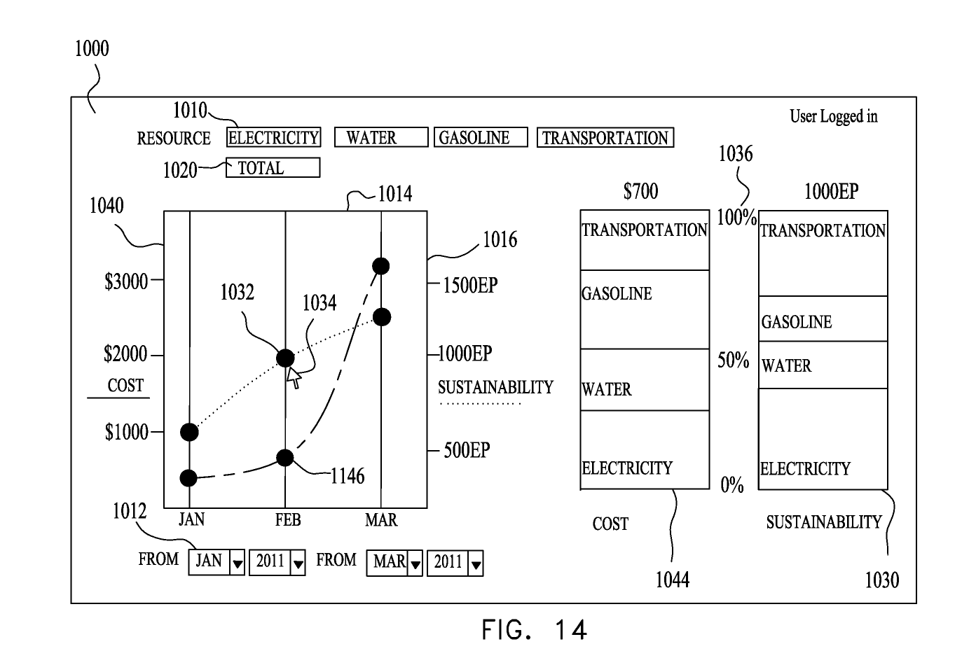

Reference is made to FIG. 14, which is a simplified illustration of a user interface and display according to the flowchart in FIG. 11. As seen in FIG. 14, a user interface 1000 may be displayed on the user output device 118, such as on a monitor of the user machine 102 or in any other suitable manner, such as on a paper report. The user interface 1000 may include control modules or input fields to allow the user to input data, typically via the user input device 114, by indicating on a button or other portion of the user interface 1000.

A user may log in to a user's account to activate the system 100. The computing system 110 may retrieve the user's information, such as his geographical location or locations, the quantity of consumed resources during past periods of time and costs, as stored within any one of the servers 120, 130 or 144 or user machine 102, of the system 100.

The user interface 1000 may comprise a resource field 1010 comprising different resources the user has consumed, such as electricity, water, gasoline and transportation, for example. Additionally, a duration field 1012 may be provided to allow the user to select a desired time span. Upon the user's selection of a resource in resource field 1010 and duration field 1012 a graph 1014 displaying the sustainability expenditure value may appear on the left side of the user interface 1000. The sustainability expenditure value may be titled “sustainability” and may be measured by Energy Point units, as seen in the right-sided scale 1016. The graph 1014 illustrates the trend of the sustainability expenditure of a user during the selected duration. A total sustainability expenditure value may be selected in field 1020 for displaying the total sustainability expenditure of all resources. A bar chart 1030 may be displayed at the right-side of the user interface 1000. The bar chart 1030 illustrates a breakdown of the sustainability expenditure value of each resource during a selected time period, illustrated by point 1132 and selected by cursor 1034. The portion of each sustainability expenditure value resource may be ascertained from a percentage scale 1036 appearing alongside the bar chart 1030.

Additionally, the financial expenditure of the user during the selected duration may be displayed by graph 1014. The financial expenditure may be titled “cost” and may be measured in any suitable currency, as seen in the left-sided scale 1040. The graph 1014 illustrates the trend of the financial expenditure of a user during the selected duration. A bar chart 1044 may be displayed alongside the sustainability bar chart 1030. The bar chart 1044 illustrates a breakdown of the cost of each resource at a time period 1146 corresponding to the selected time period 1132. The portion of the cost of each resource may be ascertained from the percentage scale 1036 appearing alongside the bar chart 1044.

Thus it is shown that the system 100 may provide the user with a visual display in graph 1014 showing the trend of the sustainability expenditure value of each resource and of the total sustainability expenditure value during a selected duration. The user may utilize this information to monitor his sustainability expenditure. The user may further visualize the portion of each consumed resource of the total sustainability expenditure, as seen in bar chart 1030. Moreover, the user may easily compare the sustainability expenditure with the financial expenditure using the visual display in graphs 1014 and bar charts 1030 and 1044.

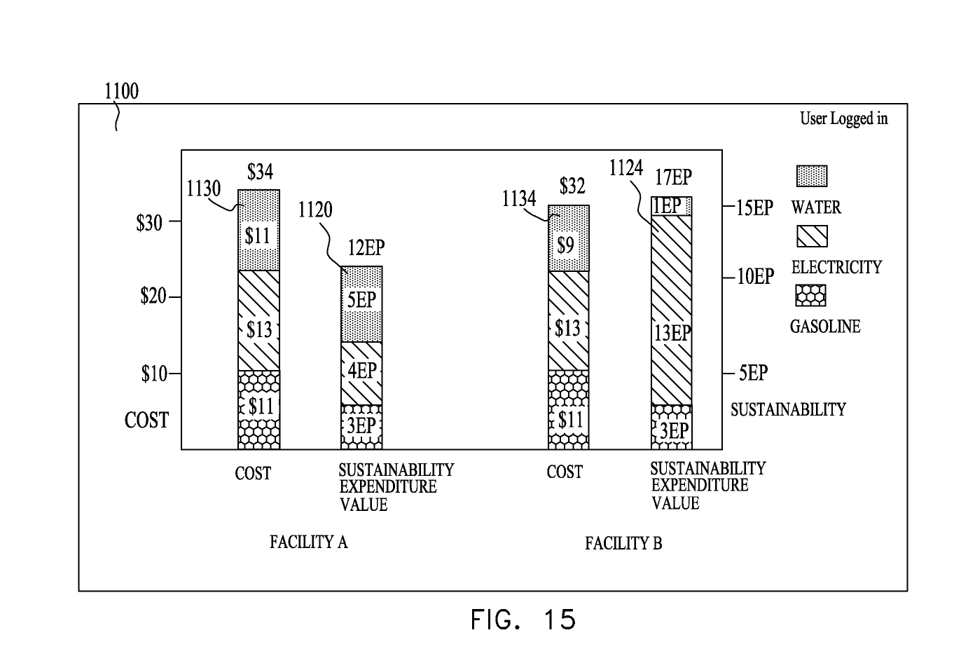

It is noted that additional features may be provided. For example, the sustainability and financial expenditure values of additional consumers or additional facilities may be displayed in graph 1014 for comparison thereof. An example of a display comparing the sustainability and financial expenditure values of two facilities is shown in FIG. 15.

Additionally, the computing system 110 may be programmed to provide suggestions for optimizing the energy consumption (not shown). For example, the computing system 110 may provide the sustainability expenditure value of each product consuming a resource and identify the product with the highest sustainability expenditure value. Accordingly, the computing system 110 may generate a suggestion to reduce the consumption of that product or select an alternative product with a higher spatiotemporal sustainability quantification value. For example, the computing system 110 may calculate the electricity sustainability expenditure value of an air conditioning device. The computing system 100 may retrieve the average sustainability expenditure value for air conditioners in the geographical location of the user. Upon identifying that the air conditioning device has a higher sustainability expenditure value than the average, the computing system 110 may generate a suggestion to reduce use of the air conditioning device, or alternatively to select a model with a higher spatiotemporal sustainability quantification value.

Thus it is shown that the sustainability management system 100 may provide a user with information which may be utilized for monitoring his energy efficiency and sustainability management. As described, a user may utilize the resultant sustainability expenditure value to monitor the efficiency of his consumption of the resource, such as by comparing the resultant sustainability expenditure value of resources during a period of time. Additionally, a user may utilize the resultant sustainability expenditure value to compare the energy efficiency of different scenarios. Moreover, a user may utilize the sustainability expenditure value to project the energy efficiency of future activities or use of products.

Furthermore, the display showing the breakdown of the consumed resources may allow a user to select methods to optimize the resource consumption, such as by minimizing the electricity consumption, for example. Additionally, the display showing the energy expenditure along with the financial expenditure may allow a user to optimize his energy efficiency and sustainability management while considering budgetary constrains. For example, a company wishing to optimize their energy efficiency within a given budget can compare the effectiveness of reducing water consumption and its effect on cost reduction.

Reference is made to FIG. 15, which is a simplified illustration of a display according to the flowchart in FIG. 11. As seen in FIG. 15, a display 1100 may be shown on the user output device 118, such as on a monitor of the user machine 102 or in any other suitable manner, such as on a paper report.

A user may log in to a user's account to activate the system 100. The computing system 110 may retrieve the user's information, such as his geographical location or locations, the quantity of consumed resources during past periods of time, and costs, as stored within any one of the servers 120, 130 or 144 or user machine 102, of the system 100. The computing system 110 may retrieve the spatiotemporal sustainability quantification value of the resources of Facility A and Facility B in accordance with the geographical location thereof. In the example shown in FIG. 15, the electricity in the geographical location of Facility A is generated by a natural gas power plant and in Facility B the electricity is generated by a coal power plant.

The resource costs and consumed resource quantities in one example are as set forth:

| | Consumed | | |
|---|---|---|---|
| | resource | | |
| | quantities | | |
| | in | | |
| | Facilities | Cost in | Cost in |
| Resource | A and B | Facility A | Facility B |
| Gasoline | 3 gallons | $10.5 | $10.5 |
| Electricity | 100 kWh | $13.2 | $13.2 |
| Water | 3 kgal | $8.93 | $7.25 |

A bar chart 1120 may be displayed at the left-side of the display 1100. The bar chart 1120 illustrates the total sustainability expenditure value of Facility A, along with a breakdown of the sustainability expenditure value of each resource, such as water, electricity and gasoline. Similarly, a bar chart 1124 may be displayed at the right-side of the display 1100. Bar chart 1124 shows the total sustainability expenditure value of Facility B and resource breakdown thereof. The bar charts 1120 and 1124 may be titled “sustainability” and may be measured by Energy Point units.

Additionally, the financial expenditure of Facility A may be displayed by bar chart 1130. The financial expenditure may be titled “cost” and may be measured in any suitable currency, as seen at the left-side of display 1100. The bar chart 1130 illustrates the total cost of the resources and a breakdown thereof. Similarly, a bar chart 1134 may be displayed at the right-side of the display 1100. Bar chart 1134 shows the total sustainability expenditure value of Facility B and resource breakdown thereof.

From comparing the sustainability bar charts 1120 and 1124 with the cost bar charts 1130 and 1134 it can be seen that though the total financial expenditure of Facility A is generally similar to Facility B, the sustainability expenditure of Facility A is significantly less than Facility B. This is mostly due to the electricity sustainability expenditure value of Facility A, which is significantly less than the electricity sustainability expenditure value of Facility B. Thus it is seen that the sustainability expenditure value of a resource depends on the geographical location thereof.

In FIG. 15 it is seen that the system 100 may provide the user with a visual display in charts 1120 and 1124 showing the portion of each consumed resource within the total sustainability expenditure of different geographical locations, Facility A and Facility B. The user may utilize this information to monitor the sustainability expenditure of the facilities. Moreover, the user may easily compare the sustainability expenditure shown in bar charts 1120 and 1124 with the financial expenditure shown in bar charts 1130 and 1134.

Thus it is shown that the sustainability management system 100 may provide a user with information which may be utilized for monitoring his energy efficiency and sustainability management. As described, a user may utilize the resultant sustainability expenditure value to monitor the efficiency of his consumption of the resource, such as by comparing the resultant sustainability expenditure value of resources during a period of time. Additionally, a user may utilize the resultant sustainability expenditure value to compare the energy efficiency of different scenarios. Moreover, a user may utilize the sustainability expenditure value to project the energy efficiency of future activities or use of products.

Furthermore the display showing the breakdown of the consumed resources allows a user to select methods to optimize the resource consumption, such as by minimizing the electricity consumption, for example. Additionally, the display showing the energy expenditure along with the financial expenditure allows a user to optimize his energy efficiency and sustainability management while considering budgetary constrains. For example, a company wishing to optimize their energy efficiency within a given budget can compare the effectiveness of reducing water consumption and its effect on cost reduction.

Reference is made to FIG. 16, which is a simplified illustration of a display according to the flowchart in FIG. 11. As seen in FIG. 16, a display 1200 may be shown on the user output device 118, such as on a monitor of the user machine 102 or in any other suitable manner, such as on a paper report.

A user may log in to a user's account to activate the system 100. The computing system 110 may retrieve the user's information, such as his geographical location or locations, the quantity of consumed resources during past periods of time and costs, as stored within any one of the servers 120, 130 or 144 or user machine 102, of the system 100. Additionally, information pertaining to the structure of the facilities of the user may be retrieved.

FIG. 16 illustrates a simplified example wherein a user may utilize system 100 to provide information and visual aids for determining the most sustainable and cost efficient project or product for efficient resource management. For example, when the user is required to select between replacing existing conventional incandescent light bulbs with light-emitting diode (LED) lighting or installing solar panels for electricity generation, in a selected facility, the user may compare the sustainability expenditure value of each project besides the cost.

The cost and sustainability expenditure value of the products may be calculated by computing system 110. For example the cost of the LED lighting and solar panels it retrieved from remote servers 144, such as from the manufacturer's server. The sustainability expenditure value may be calculated according to the data stored within the servers 130, 144, 120 or user machine 102. For example, the size and structure of the facility may be retrieved for calculation of the cost and sustainability expenditure value of the products.

The product costs and Sustainability Expenditure Value thereof in one example are as set forth:

| | | Sustainability |
|---|---|---|
| | | Expenditure |
| Product | Cost | Value [EP] |
| LED | $20000 | 24621 |
| Lighting | | |
| Solar | $55238 | 21307 |
| Panels | | |

A bar chart 1210 may be displayed in display 1200. The bar chart 1210 illustrates the cost of LED lighting vs. the sustainability expenditure value thereof. The cost scale may be measured in any suitable currency and is illustrated by the vertical axis 1212. Similarly, a bar chart 1220 illustrates the cost of solar panel installation vs. the sustainability expenditure value thereof. The sustainability expenditure value scale is titled “sustainability” and measured in Energy Point units, as illustrated by the horizontal axis 1222.

From comparing the sustainability bar charts 1210 with 1220 it can be seen that selecting the LED lighting product is, in this example, the most sustainable and cost efficient method for efficient resource management. A recommendation for the selected product may appear on the display, as seen at suggestion field 1224.

In FIG. 16 it is seen that the system 100 may provide the user with a visual display in charts 1210 and 1220 comparing the financial expenditure and the sustainability expenditure of various projects, previously incomparable without utilizing a system providing a common resource unit, such as the Energy Points of system 100.

Additionally in FIG. 16 it is seen that the system 100 may provide the user with projected sustainability expenditure values for assisting the user in selecting the preferred product.

Thus it is shown that the sustainability management system 100 may provide a user with information which may be utilized for monitoring his energy efficiency and sustainability management. As described, a user may utilize the resultant sustainability expenditure value to monitor the efficiency of his consumption of the resource, such as by comparing the resultant sustainability expenditure value of resources during a period of time. Additionally, a user may utilize the resultant sustainability expenditure value to compare the energy efficiency of different scenarios. Moreover, a user may utilize the sustainability expenditure value to project the energy efficiency of future activities or use of products.

Furthermore the display showing the breakdown of the consumed resources may allow a user to select methods to optimize the resource consumption, such as by selecting a more efficient method for energy consumption. An example for a more efficient method for energy consumption may be installing solar panels for generating electricity. Additionally, the display showing the energy expenditure along with the financial expenditure allows a user to optimize his energy efficiency and sustainability management while considering budgetary constrains. For example, a company wishing to optimize their energy efficiency within a given budget can compare the effectiveness of inserting solar panels, for the cost of the given budget, with changing existing lights to LED lighting, for the cost the given budget.

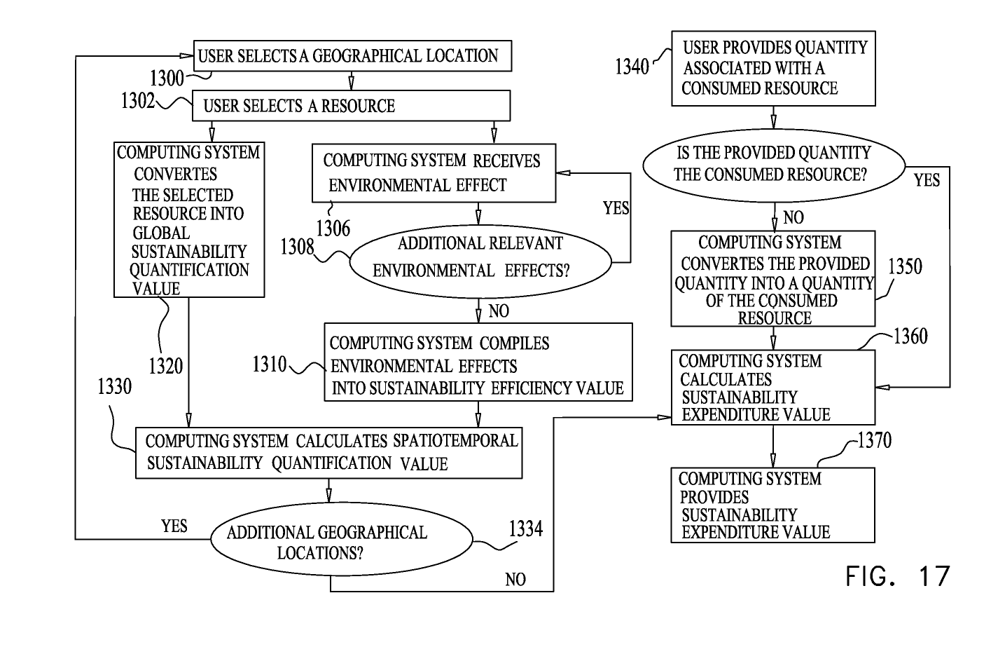

Reference is made to FIG. 17, which is simplified flowchart of a method for energy efficiency and sustainability management. An embodiment of the method may be used with the system of FIGS. 1-4, but other systems may be used. As seen in step 1300, a user may provide to the computing system 110 a selected geographical location, via the input device 114. For example, the selected geographical location may be transmitted from the user machine 102 to the server 130 of the computing system 110 via the network 122, as described in reference to FIGS. 1-4.

It is noted that in some embodiments a time or time span of interest may be provided by the user in place of the selected geographical location or in addition thereto. Other or additional information may be provided.

Turning to step 1302, a resource may be selected or provided. The user may select the resource via the input device and may transmit his selection from the user machine 102 to the server 130 of the computing system 110, via the network 122.

It is noted that the computing system 110 may be programmed to perform steps 1300 and 1302, without the user physically performing the steps. For example, the computing system 110 may be programmed to access a user database, stored in server 120, at predetermined time intervals. Other methods of information retrieval may be used.

In step 1306, the computing system 110, may receive or access information including at least one environmental effect caused by consumption of the selected resource. The effect may be limited by parameters; e.g. the effect may be caused by consumption of the selected resource within the selected geographical location. The server 130 may receive or access the environmental effect information from the plurality of databases stored within servers 144, for example.

The sustainability efficiency value may be compiled of or computed based on a plurality environmental effects. Each of the environmental effects may be retrieved from a single or plurality of databases. The computing system 110 may be programmed to continue receiving the environmental effects from the databases until all environmental effects have been received, as seen in step 1308.

Upon receiving all the relevant environmental effects, the computing system 110 may compute a consolidated value based on a single or plurality of environmental effects, as seen in step 1310. The compiling may be performed by any one of servers 120, 130 and 144 or by user machine 102, which may comprise or execute algorithms and protocols for rating the environmental effects and presenting the environmental effects as a numerical value. Additionally, the servers 120,130, 144 or user machine 102, may comprise or execute algorithms and protocols for compiling the plurality of retrieved numerical values into a consolidated numerical value representing the sustainability efficiency value.

It is appreciated that the sustainability efficiency value may be calculated for a plurality of resources and a plurality of geographical locations. Factors in addition to or other than geographical locations may be used.

The sustainability efficiency value may be provided to the user, in any suitable manner, such as via the user output device 118 or by providing a paper report, for example. Additionally or alternatively, the sustainability efficiency value may be stored within the computing system 110, such as within the server 120,130 or 144 or user machine 102, for future use.

The computing system 110 may convert the selected resource into the global sustainability quantification value. In accordance with an embodiment, the global sustainability quantification value may be calculated by converting a gallon of gasoline to the resource. Standard units other than a gallon of gasoline may be used. Accordingly, the global sustainability quantification value may be calculated in step 1320 by converting a gallon of gasoline to the selected resource. In some embodiments, a database comprising a predetermined table listing the conversion quantities of a variety of resources may be stored within server 130 or 144. It is appreciated that the global sustainability quantification value may be calculated in any suitable manner in step 1320.

It is noted that step 1320 may be performed parallel to steps 1306, 1308 and 1310 or prior thereto or following the steps.

In step 1330 the spatiotemporal sustainability quantification value may be calculated by executing or employing an algorithm comprising the sustainability efficiency value and the global sustainability quantification value. In one embodiment, the spatiotemporal sustainability quantification value may be a product of the sustainability efficiency value and the global sustainability quantification value. The servers 130 or 144 or user machine 102 or server 120 may comprise or execute the algorithm for calculating the spatiotemporal sustainability quantification value.

The computing system 110 may be programmed to continue calculating a plurality of spatiotemporal sustainability quantification values for a plurality of respective geographical locations. This may be performed by the user entering a plurality of geographical locations, as seen in step 1334. Alternatively, wherein the selected geographical location comprises sub-locations, a plurality of spatiotemporal sustainability quantification values may be calculated for each sub-location. An example of a display of a plurality of spatiotemporal sustainability quantification values is shown in FIG. 8.

The spatiotemporal sustainability quantification value may be provided to the user in any suitable manner, such as via the user output device 118 or by providing a paper report, for example. Alternatively, the spatiotemporal sustainability quantification value may be stored within the computing system 110, such as within the server 130 or 144 or user machine 102 or server 120, for future use.

In one embodiment, the computing system 110 may retrieve the spatiotemporal sustainability quantification values of a map, such as map 540 of FIG. 8.

A user may provide to the computing system 110 a quantity associated with a consumed resource, as seen in step 1340. This quantity may be the amount of a resource the user has consumed, such as an amount of kWh of consumed electricity or an amount of gallons of consumed water or gasoline or the amount the user will potentially consume in a hypothetical scenario.

It is noted that the computing system 110 may be programmed to perform step 1340, without the user physically performing the steps. For example, the computing system 110 may be programmed to access online reports via network 122 or a user database, such as a database stored in user machine 102 or server 120, 130 or 144, at predetermined time intervals for retrieving bills, receipts, air miles or points, indices, bank statements and input from energy consuming devices for example.

It is noted that step 1302 for selecting the resource may not be used and the computing system 110 may recognize the selected resource from step 1340 according to the provided quantity of consumed resource.

As seen in step 1350, wherein the provided quantity is not the consumed quantity, the computing system 110 may convert the provided to quantity to an amount of the consumed resource. For example, where the fee of a utility bill is provided, the computing system 110 may convert the fee to the consumed amount by dividing the fee by the cost per resource unit in the selected geographical location.

In step 1360 the sustainability expenditure value may be calculated by employing an algorithm factoring in or using the quantity of consumed resource and the spatiotemporal sustainability quantification value. In one embodiment, the sustainability expenditure value may be a quotient of the quantity of consumed resource divided by the spatiotemporal sustainability quantification value. The servers 120, 130, 144 or user machine 102 may comprise or execute the algorithm for calculating the sustainability expenditure value.

It is noted that steps 1340 and 1350 may be performed parallel to steps 1306, 1308, 1310, 1320, 1330 and 1334 for calculating the spatiotemporal sustainability quantification value or prior thereto or following the steps.

The sustainability expenditure value may be provided to the user, as seen in step 1370, in any suitable manner, such as via the user output device 118 or by providing a paper report, for example. Alternatively, the sustainability expenditure value may be stored within the computing system 110, such as within the server 120, 130, 144 or user machine 102 for future use.

The steps described herein for calculating the sustainability expenditure value may be performed for a plurality of resources for calculating the total sustainability expenditure value of a user.

The sustainability expenditure value may be presented to the user in any suitable manner.

In another embodiment, steps 1340 and 1350 may be replaced by selection of any suitable quantity of a resource. The selection may be performed by the user or by a predetermined selection by the computing system 110. The quantity may be, for example, the average consumption of the resource. In step 1360 a general sustainability expenditure value may be calculated by employing an algorithm factoring in or comprising the quantity of the resource and the spatiotemporal sustainability quantification value. In one embodiment, the global sustainability expenditure value may be a quotient of the quantity of the resource divided by the spatiotemporal sustainability quantification value. The general sustainability expenditure value may be a dimensionless value or may be measured in a uniform unit, such as an Energy Point unit.

Thus, a plurality of resources that conventionally are measured in different units, may be expresses by a uniform, common unit. This may allow comparing the different resources to each other. Additionally, a plurality of resources, all expressed in a uniform unit, may be calculated to be expressed as a consolidated numerical value.

It is noted that in the displays shown in FIGS. 7-10 and 12-16 the computing device may provide options for users to select and customize their energy monitoring display.

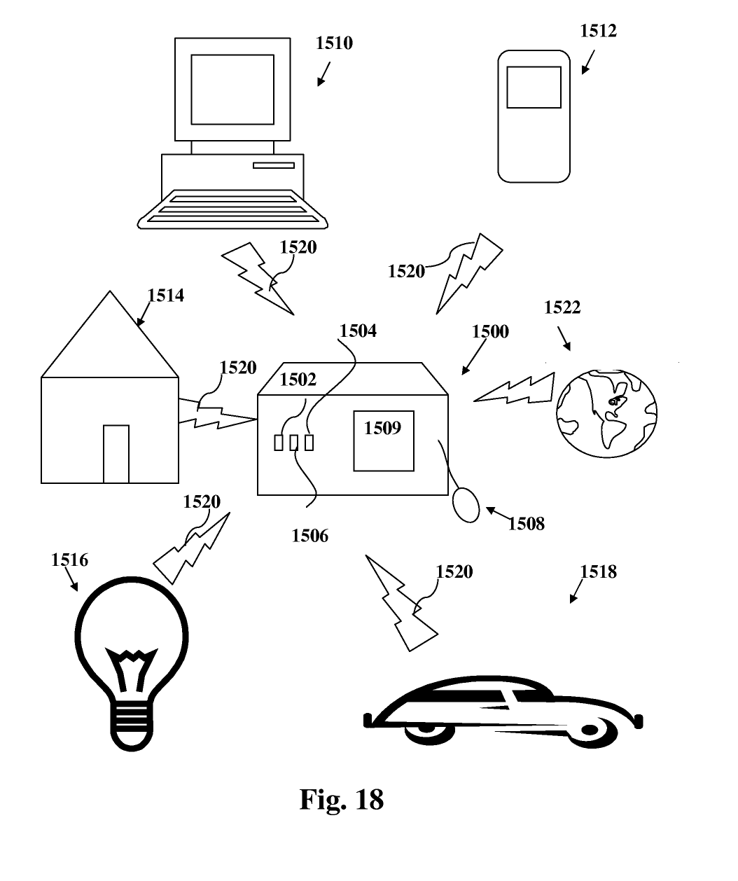

Additional embodiments of the invention will be further described in reference to FIGS. 18-21 herein.

Embodiments of the invention include inputting a plurality of energy values, each measured using a different energy scale, e.g., gallons of fuel, kilowatts, and BTUs, and outputting a plurality of energy values each measured using a consolidated energy scale. A scale may be a range of measurements incremented (spaced) by a single constant corresponding unit. Each value in a scale may measure or count a number of such units in the scale. Each different scale may use a different unit and therefore a different increment of values. Accordingly, the same quantity, e.g., of energy, may be represented by different values or numbers of units in different scales.

By consolidating the plurality of energy scales into a single consolidated scale, the computing device may provide a uniform measure of energy representing the different types of energy sources and energy-consuming devices. The consolidated energy scale may use a single energy unit, which may be referred to, e.g., as an Energy Point. These measures may correspond to the sustainability expenditure value and the general sustainability expenditure value. In other embodiments, the energy unit of the consolidated scale may be or may be based on a known unit (e.g., a BTU). In some embodiments, the plurality of input scales (e.g., gallons of fuel, kilowatts, and BTUs) may be consolidated into a different scale (EP) or one of the input scales themselves (e.g., the BTU scale). In another embodiment, a user may flip or switch between different scales to view the same energy quantities represented by different values using the different respective units of each scale.

Embodiments of the invention include automatically receiving the input energy data, e.g., from energy counters over a wireless network. In one example, a computing system may access electronic or online receipts indicating quantities of purchased energy or an online air or odometer (e.g. car or vehicle mile or kilometer) counters to automatically compute a quantity of fuel energy used to travel. The computing system may also receive (e.g., wireless) signals from the energy-consuming devices themselves, which may self-monitor or tally their own energy usage. Additionally or alternatively, the computing system may receive user input. For example, the user may input an odometer reading for the computing system to determine a quantity of fuel used to travel that distance by car. The computing system may automatically send a user a request for data, for example, “what is your odometer reading?,” when data is being compiled.

Embodiments of the invention may retrieve or request energy data periodically, for example, at predetermined time intervals such as, once per day, week, or month or each time the energy data is updated. In one embodiment, the computing device may monitor the energy information sources or data fields, which when updated, may trigger the automatic retrieval of the updated data.

Embodiments of the invention may automatically generate an environmental effect or “cost” value measured in the consolidated energy scale. In one embodiment, the environmental effect values may be incorporated into the energy value measured in the consolidated energy scale. In another embodiment, the computing system may generate a separate environmental value defining the carbon footprint value associated with the energy consumed represented by the consolidated energy value. A cumulative environmental cost value may be generated, for example, to represent the cumulative environmental effects of the energy usage associated with a plurality of different devices, where each device may have its energy measured in a different energy scale and may have a different energy efficiency. The cumulative environmental cost value may be measured, for example, as a weight of carbon dioxide (CO₂).

Additionally or alternatively, embodiments of the invention may automatically generate monetary cost values defining the monetary cost associated with using the energy values measured in the consolidated energy scale. The monetary cost values may list the cost associated with each device and/or type of energy. The monetary cost values may be added or combined with the consolidated energy values and measured in the consolidated energy scale or may be measured in a separate monetary cost scale.

The energy, cost and environmental effect values associated with the same energy usage may be viewed together in a single combined or a separate plurality of scales. Each type of energy or device may have a unique relationship with energy, cost and environmental effect. For example, a high-power machine may be harmful environmentally, while an environmentally beneficial device may be expensive. Viewing the plurality of values together may allow a user to view the overall benefit and detriment associated with the energy, environmental cost, and monetary cost of using each different type of energy.

Reference is made to FIG. 18, which schematically illustrates a system for monitoring energy usage according to an embodiment of the invention. Computing device 1500 may include a processor 1502, a memory unit 1504 a receiver or transceiver 1506, an input device 1508, and an output device 1509.

Computing device 1500 may be or include, for example, a desktop computer, laptop computer, workstation, server, or mobile or handheld computer. Memory unit 1504 may include a short-term memory to temporarily store input data until it is processed or a long-term memory, for example, to store a history log of energy usage data. Receiver or transceiver 1506, such as a wireless antenna, may receive and/or transmit data, for example, via electromagnetic or radio frequency (RF) signals 1520. Input device 1508 may include a pointing device, click-wheel or mouse, keys, touch screen, recorder/microphone, other input components for receiving user input. Output device 1509 may include a monitor or screen, to display and monitor energy usage in the system.

Computing device 1500 may receive signals 1520 (e.g., wirelessly or via a wired network) including energy usage data for devices, such as, one or more computers 1510, cellular phones or mobile devices 1512, home devices 1514 such as heating units or air conditioning units and, electric devices 1516 at one or more addresses, cars 1518 or other vehicles such as boats, planes, and public transportation vehicles (which may be owned or used by a user). Devices 1510-1518 may be linked to a user account or profile, for example, associated with one or more people, a household, a building or manufacturing plant, an address, a company, a community or social network, a government, or any other one or more identified people, spaces, or device(s).

Signals 1520 may describe energy values, for example, energy consumed by devices 1510-1518, or may describe non-energy data from which an energy value may be derived, for example, the costs to purchase the energy or work done by devices 1510-1518. Computing device 1500 may convert the cost values into energy values, for example, using a known or estimated cost basis (e.g., a national or regional average of gasoline prices on the date of purchase) and the work values into energy values, for example, using a known or estimated energy efficiency for doing the work (e.g., based on the efficiency associated with that general type of device or the specific device model). The known values may be automatically retrieved over a wireless network using public record, private records accessed by entering user-authorized passwords or personal information, or data mining techniques.

In one embodiment, computing device 1500 may receive energy data via transceiver 1506 from online reports via a network 1522. Network 1522 may be a wireless local area network (WLAN) or a global network, such as the Internet. Computing device 1500 may retrieve electronic receipts, bills, air mile or points, indices, and other data through network 1522 for determining the energy consumed by devices 1510-1518.

In another embodiment, computing device 1500 may receive energy data directly from one or more of devices 1510-1518. Devices 1510-1518 may each include a receiver to receive a data request signal from transceiver 1506, a programmable chip or internal memory to store energy data, and a transmitter to transmit data to transceiver 1506. In one embodiment, one or more devices 1510-1518 may include an induction transmitter, such as a passive RFID tag, which upon excitation by the energy of short-range radio signals, may transmit stored energy data from an internal memory in devices 1510-1518 to transceiver 1506.

Devices 1510-1518 may transmit the energy data, for example, periodically according to a clock cycle, a beacon signal, or a counter of an internal processor, in response to a change in the mode of the device (e.g., when the device is turned on or off, re-started, or goes into a sleep or energy saving mode), when the energy data is updated, when the energy data is changed by greater than a predetermined value (e.g., 10 or 100 EP), rate or percentage of the total energy (e.g., greater than 10%), or when triggered or requested, e.g., by the computing device 1500. For example, computing device 1500 may receive a request from a user to display the energy data of devices 1510-1518 and may, in turn, transmit a request for their updated energy data. In another embodiment, a user may have a device collecting energy data from other devices, such as a magnetic card or chip, which may scan devices using an induction transmitter and automatically tally the energy data.

Additionally or alternatively, computing device 1500 may use energy data entered manually or by a user. Computing device 1500 may request a user to enter energy data, for example, into a pop-up window. Computing device 1500 may include an input device 1508 for receiving the user input. A user may enter some or all of the energy data including, for example, an odometer reading (e.g., for computing device 1500 to deduce the quantity of fuel energy used to travel that distance by car).

The different input energy quantity values may represent or be measured in different forms of energy and may be measured with different units or in different scales of measurement. Computing device 1500 may convert the energy values received from devices 1510-1518 measured in the plurality of different input energy scales (kWh, Calories, BTU, etc.) to one or more output energy quantity values measured in a single consolidated energy scale having a single energy unit, for example, an Energy Point unit. Accordingly, all values of any form of energy, such as, electrical, chemical, and heat, may be measured in a uniform way in the same Energy Point scale. An Energy Point (1 EP) may be, for example, equal to 100 kilowatt-hours (kWh), which is approximately 10 Liters of gasoline, although other values may be used.

In one embodiment, the energy consumption for each user account may be, for example:

EP=ΣᵢEPᵢ

where i is an index defining each energy component contributing to the consolidated energy value, e.g., energy associated with each device 1510-1518, energy-consuming activity, or from of energy, for each user account. For example, a total cumulative number of Energy Points, may be, for example:

EP=EPₑ+EP_{CAR}+EP_{AIRM}+EP_{HEAT.}

where EPₑ, EP_{CAR}, EP_{AIRM}, and EP_{HEAT}, may be the converted energy quantity values measured in the Energy Point scale corresponding to each energy “event,” for example, an electricity bill, car distance or usage (e.g. mileage), air travel, and a heating bill, respectively. Other or different energy factors may contribute to the total cumulative number of Energy Points associated with a user account.

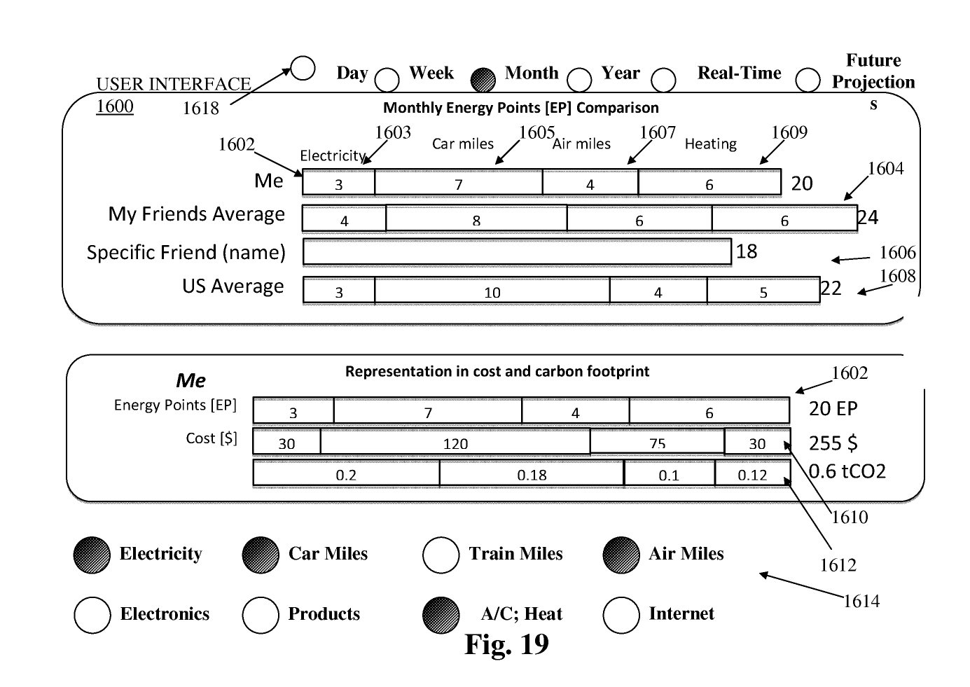

Although an Energy Point from each energy event may achieve the same energy output or work, each energy type may behave differently with respect to other factors, such as, environmental impact or monetary cost. Accordingly, different energy types may be marked, stored and displayed separately. For example, an EP of electricity (EPₑ) may have a greater carbon footprint and therefore a greater associated environmental “cost” than an EP of natural gas (EP_{g}) or fuel or chemical energy (EP_{c}). Computing device 1500 may tag each Energy Point score or value, e.g., with a symbol, value or marker in the associated metadata or using pre-designated data fields, to indicate the data type associated with an energy quantity value, e.g., EPₑ, EP_{g}, or EP_{c}. This may allow computing device 1500 to quickly retrieve, process and group data associated with each type of energy, for example, to display a break-down of each factor of energy usage to a user (e.g., as shown in FIG. 19).

Computing device 1500 may generate environmental impact quantity values measured in an environmental impact scale using environmental cost or carbon footprint points, CP. Since different types of energy are generally associated with different environmental effects, computing device 1500 may use a different scaling factor to convert energy values associated with each type of Energy Point, e.g., EPₑ, EP_{g}, or EP_{c}, from being measured in the energy scale to the environmental scale. In one embodiment, (1) carbon footprint point, CP, may equal to (1) ton of CO₂ (tCO₂) emitted into the atmosphere or 1000 kilograms (kg) CO₂. In another embodiment, (1) carbon footprint point, CP, may be normalized, for example, to equal the CO₂ waste associated with (1) EP of electricity (0.067 tCO₂ or 60 kgCO₂), (1) EP of car fuel (0.025 tCO₂ or 25 kgCO₂), or (1) EP of heat (0.020 tCO₂ or 20 kgCO₂). Other environmental impact scales, units or scaling factors may be used.

Computing device 1500 may generate monetary cost quantity values measured in a monetary cost scale using monetary points, MP. Similarly to environmental effects, each different type of energy is typically associated with a different monetary cost and computing device 1500 may account for this difference by using different scaling factors to convert energy values associated with each type of Energy Point to a respective corresponding monetary cost. In one embodiment, the monetary cost scale may use the national or regional monetary unit in which the user resides, for example, dollars ($) in the U.S., yen in Japan, etc. In another embodiment, the monetary unit of the scale, MP, may be normalized, for example, to equal the cost associated with (1) EP of electricity ($10), (1) EP of car fuel ($17.14), or (1) EP of heat ($5). Other monetary scales or units may be used.

The energy scale, environmental cost scale, and monetary cost scale may each measure different values associated with the same energy usage (e.g., EP_{CAR}, EP_{AIRM}, EP_{HEAT}). The values measured in one or more of these scales may be displayed on output device 1509. A user may monitor the displayed values and in response may manually alter their energy usage, e.g., turn off a lamp. Alternatively, computing device 1500 may include computing logic to automatically analyze causes of and provide solutions for inefficient energy usage. In some embodiments, computing device 1500 may automatically control the energy usage of devices 1510-1518 via wireless or wired signals.

In one embodiment, a user may enter a maximum value or budget associated with each of these scales, for example, an energy usage budget, an environmental cost budget, and/or a monetary cost budget. In one example, a user may input detailed information and specific amounts for each budget. Alternatively, the user may select from a pre-defined list of options for each budget (e.g., high, medium, or low). Default budget information may be used, e.g., when user-specific information is not provided. The default information may be a predetermined or user-selected percentage (e.g., 75%) of the national average cost for each budget. Computing device 1500 may provide recommendations for reducing energy usage that meet the budgets of each user.

Computing device 1500 may inform the user when their energy usage exceeds or is near (e.g., within 10% of) the maximums of each energy budget or when their energy usage is below the budget maximums. Computing device 1500 may measure the budget periodically, e.g., monthly, or in real-time based on all current available information.

Some devices may implement an energy lock or output an alarm, wherein when the budget associated with a scale or device is exceeded, associated device(s) may be locked or an alarm may be triggered. In one example, a cost budget for a cellular phone or mobile device 1512 may be associated not only with energy usage, but with the cost of calls. When the phone exceeds a pre-set energy usage and/or number of calls, the phone may have an alarm (e.g., a pre-designated ring-tone) or may lock (e.g., the phone may be unable to be turned on or may be turned on by entering a pre-designated sequence of keys). An emergency setting or code may be used to override the energy locks or alarms.

Some devices have different energy efficiencies depending on their usage settings. In one example, a car may drive more efficiently at 60 miles per hour (mph) than at 80 mph. In another example, lowering the temperature setting of an air-conditioner by 1° Fahrenheit (F) may save less energy if the setting starts at 78° F. than at 70° F. (the energy use function is not linear with respect to its output or work). In general, the greater the difference between the ambient temperature and the temperature at which the air-conditioner is set, the less energy efficient is the air-conditioner's operation. Computing device 1500 may account for the non-linear energy usages or efficiencies of devices 1510-1518 using for example their pre-defined specifications, e.g., stored in memory 1504 or retrieved from a device database or server over network 1522. For example, to achieve the same cooling, computing device 1500 may set (or request a user to set) the air-conditioner to a temperature closer to the ambient temperature, but may start (or request a user to start) the air-conditioning at an earlier time. These settings may be configured to limit the power output of device 1510-1518 to be below a predetermined threshold value (e.g., stored in memory 1504) at which the device efficiency degrades. Other controls may be set to operate within a maximum efficiency range.

In one embodiment, computing device 1500 may record a user's history of energy usage, e.g., stored in memory 1504, and may recommend to a user reducing or eliminating activities not regularly used or, which have shown an increase in energy usage over past use, or which have been associated with less energy by the user in the past but which show a recent increase. In one example, a user may enter a list of “necessary” activities and/or minimum energy amounts that the user does not wish to eliminate. For example, a user may enter that the heat should maintain a minimum temperature of 65° Fahrenheit; the car should be used for a minimum number or 50 miles per week; etc. Computing device 1500 may recommend to a user energy-reducing suggestions that work within those limits.

Computing device 1500 may display these energy usage recommendations, alerts and values, for example, as described in reference to FIG. 19.

Reference is made to FIG. 19, which schematically illustrates a user interface 1600 for displaying energy usage values according to an embodiment of the invention.

A computing device (e.g., computing device 1500 of FIG. 18) may display raw or processed energy data and environmental data and/or monetary data associated therewith on user interface 1600. User interface 1600 may be displayed on a monitor or screen (e.g., on output device 1509 of FIG. 18). User interface 1600 may include a control module or input field to allow a user to input information or receive user controls (e.g., via input device 1508 of FIG. 18), e.g., by indicating on a “button” or other portion of user interface 1600.

The computing device may provide options on user interface 1600 for users to select and customize their energy monitoring display. The computing device may provide users with a selection of one or more ways to display the plurality of energy values, for example, as one-dimensional values, as two-dimensional graphs, profiles, charts, or as a numerical analysis. The computing device provide users with a selection of devices (e.g., devices 1510-1518 of FIG. 18), activities and/or categories, for user interface 1600 to monitor, e.g., selected by clicking corresponding input fields 1614. The computing device may provide users with a selection of dates or a duration or time period of activity for user interface 1600 to monitor, e.g., selected by clicking corresponding time fields 1618 or by entering dates into the command module. Time fields 1618 indicating durations of time, e.g., day, week, month, and year, may display the most recent measured data spanning that time. A “real-time” time field 1618 may display instantaneous energy usage (e.g., allowing a pre-determined time delay to record the energy usage). A “future projections” time field 1618 may display an estimated energy usage over an indicated future time assuming a current energy usage rate is sustained.

The computing device may receive energy data associated with devices linked to a user account and may display the data on user interface 1600. The retrieved data may correspond to the devices, activities or categories and times indicated in fields 1614 and 1618, respectively. Otherwise, default categories and times may be used.

The computing device may display the consolidated energy values 1602 representing the plurality of input energy quantities from the plurality of different input energy scales in a single cumulative energy scale with a single consolidated energy unit (e.g., Energy Points) on user interface 1600.

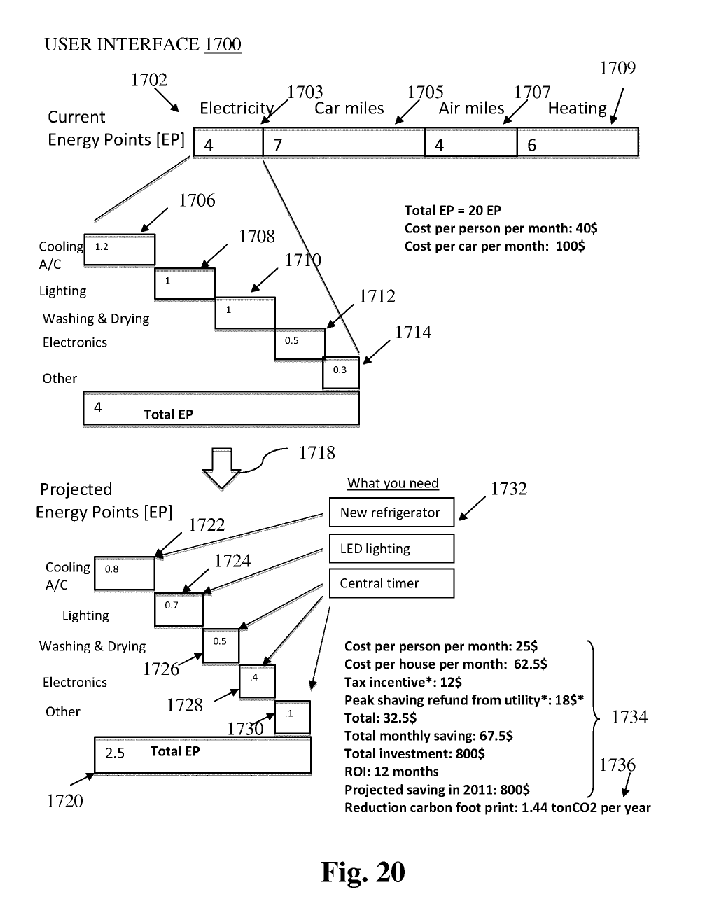

Once the consolidated energy values 1602 are measured in a uniform scale for all devices, the computing device may divide or break-down the values 1602, for example, to analyze the value of the sub-quantity of energy contributed by each device or activity to better understand the individual associated energy usage patterns. In one embodiment, cumulative energy values 1602 may be divided into a plurality of sub-values 1603, 1605, 1607, and 1609, each measuring a quantity of a different type of energy, e.g., an electric (EPₑ) sub-value, a fuel or chemical (EP_{c}) sub-value, and a natural gas (EP_{g}) sub-value. In an example shown in FIG. 19, cumulative energy values 1602 may be divided into sub-values 1603, 1605, 1607, and 1609 for each different energy consuming activity, e.g., electricity, car, train, or air miles, electronics, manufacture of products, air-conditioning and/or heating, and Internet usage. A user, or default settings, may define or refine the specificity of the energy sub-value categories, for example, to further divide the electricity sub-value 1603 into a plurality of smaller values, as shown in FIG. 20. Each energy value 1602, sub-value 1603, 1605, 1607, and 1609 or categories 1614 may be repeatedly divided or merged with other value(s), sub-value (s) or categor(ies). In one embodiment, the user may build a category (e.g., trip 2010) and may select the devices and dates associated with that event (e.g., car miles in June 2010 and air miles on Jun. 5 and 20, 2010).

The computing device may compare the consolidated energy values 1602 of a current user with the energy usage of other users, for example, by displaying their respective consolidated energy values 1604-1608 in adjacent windows on user display 1600 and/or provide a comparative statistical analysis of the differences therebetween. The current user may select other users for comparison or default users may be used. Other users may be, for example, located in the same country or region as the current user, in the same age bracket as the current user, in the same industry as the current user, and/or may be the same user at a different time, such as the previous year. In one example, an average of a group of other users may be displayed. In an example shown in FIG. 19, user interface 1600 includes cumulative energy values 1602 associated with a current user account, an average energy usage values 1604 averaged from a plurality of other user accounts, another user's individual energy usage values 1606 associated with the other user's account, and a national (e.g., U.S.) average energy usage values 1608 of energy consumed by other users located in the same country or region as the current user. Energy usage in values 1604-1608 may be obtained from other user accounts shared in a social network or may be obtained from public records.

In addition to energy values 1602 and/or 1604-1608, user interface 1600 may provide monetary cost values 1610 and/or environmental cost values 1612 corresponding to energy values 1602. Energy values listed in different sub-values 1603, 1605, 1607, and 1609 may be associated with different types of energy sources, e.g., electrical, natural gas, or chemical energy, and may be marked by a different Energy Point unit, e.g., EPₑ, EP_{g}, or EP_{c}. To account for the different environmental effects and monetary costs associated with each different type of energy source, computing device 1500 may use a different scaling factor cₑ, c_{g}, or c_{c} and dₑ, d_{g}, or d_{c} to convert energy values associated with each type of energy source or Energy Point, e.g., EPₑ, EP_{g}, or EP_{c}, to monetary cost values 1610 and environmental cost values 1612, respectively. In the example in FIG. 19, cₑ=$10/EPₑ, c_{g(CAR)}=$17.15/EP_{g(CAR)}, c_{g(AIR)}=$18.75/EP_{g(AIR)}, c_{c}=$5/EP_{c}, and dₑ=0.0067 tCO₂/EPₑ, d_{g(CAR)}=0.025 tCO₂/EP_{g(CAR)}, d_{g(AIR)}=0.025 tCO₂/EP_{g(AIR)}, d_{c}=0.020 tCO₂/EP_{c}.

Other values, sub-values, scales, units, scaling factors, and/or displays may be used.

Reference is made to FIG. 20, which schematically illustrates a user interface 1700 for displaying measured energy values and projected energy values according to an embodiment of the invention.

The computing device may display actual measured energy values 1702 (e.g., cumulative energy values 1602) of real measured energy usage in a consolidated energy scale on user interface 1700. Measured energy values 1702 may be divided into sub-values 1703, 1705, 1707, and 1709 for sub-categories or types of energy or activities, e.g., electricity, car miles, air miles, and heating. Energy sub-values 1703, 1705, 1707, and 1709 may be further sub-divided into more basic categories. For example, electricity sub-value 1703 may be divided into cooling/air-conditioning sub-value 1706, lighting sub-value 1708, washing and drying sub-value 1710, electronics sub-value 1712, and other sub-value (miscellaneous or user-specified category) 1714. The specificity of categories and sub-categories may allow the user to identify specific devices or activities that waste energy.

To provide solutions for wasteful devices or activities, the computing device may display a prediction or simulation 1718 of a projected energy value 1720 on user interface 1700, for example, as an alternative to each current energy values 1702. Projected energy value 1720 may list predicted values of energy that may be used to achieve exactly or approximately (e.g., within 10% of) the same functionality as energy values listed in current value 1703 but with more energy efficient devices (e.g., solar panels) or different activities (e.g., bicycling instead of driving). The computing device may provide projected monetary cost values or data 1734 and/or environmental cost values or data 1736 listing predicted values for the monetary and environmental effect associated with the energy values in projected energy value 1720.

Projected energy value 1720 may be sub-divided into the same or similar categories as current energy sub-value 1703 for easy comparison therebetween. In an example shown in FIG. 20, a projected total electricity energy value 1720 may be sub-divided into a projected cooling/air-conditioning sub-value 1722, a projected lighting sub-value 1724, a projected washing and drying sub-value 1726, a projected electronics sub-value 1728, and a projected other sub-value 330. Some or all projected sub-values 1722, 1724, 1726, 1728, and 1730 may show a reduction in energy consumption compared to their measured counterpart, sub-values 1706, 1708, 1710, 1712, and 1714, respectively.

The computing device may display a proposal 1732 on user interface 1700 describing new device(s) or activit(ies), which would achieve the projected energy values listed in the projected values 1722, 1724, 1726, 1728, and 1730 or the projected monetary cost or environmental cost values listed in fields 1734 and 1736. In some embodiments, when a user enters budget(s) for energy, cost and/or environmental effects indicating limits on the maximum allowable values for each scale, the computing device may generate a proposal 1732 that meets these budget(s). For example, to reduce energy usage to meet an energy budget, the computing device may generate proposal 1732 suggesting the user ride a bicycle to work to decrease the use of fuel energy, but may not suggest the user buy an electric or more fuel efficient car because the cost of acquiring the car would exceed the user's monetary budget.

User interfaces 1600 and/or 1700 may include other values, scales, proposals, displays, input and output fields and adaptive or computer learning capabilities.

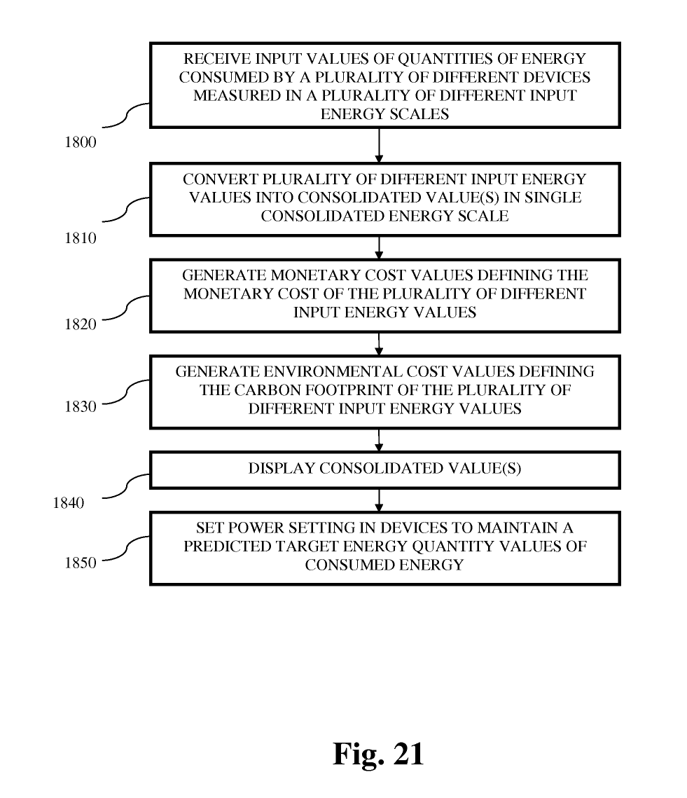

Reference is made to FIG. 21, which is a flowchart of a method according to an embodiment of the invention.

In operation 1800, a processor (e.g., processor 1502 of FIG. 18) may receive a plurality of input values of quantities of energy consumed by a plurality of different devices (e.g., devices 1510-1518 of FIG. 18) and measured in a plurality of different input energy scales. Each input energy scale may have different energy units (e.g., kWhs, Calories, BTUs, respectively). In some embodiments, each different energy scale may measure a different form of energy (e.g., electrical, chemical, or natural gas).

The plurality of different devices may all be associated with a user account. The input energy values for the devices may be received from a plurality of different input sources such as, for example, online utility bills, car mile counters, air mile counters, bank statements, receipts, user input, input from the devices consuming the energy, and remote energy-monitoring devices.

In operation 1810, the processor may convert the input energy values from the plurality of different input energy scales into one or more output energy value quantities and may enter the output energy value quantities (e.g., cumulative energy values 1602 of FIG. 19) into a single consolidated energy scale having a single energy unit. The input and output values may represent approximately the same quantity of energy (e.g., differing by less than or equal to a minimum value of the smallest stored decimal value when the values are approximated or “rounded off” to the nearest decimal value). The single energy unit may be an Energy Point unit.

In operation 1820, the processor may generate monetary cost values (e.g., monetary cost values 1610 of FIG. 19) defining the monetary cost associated with each value of the input quantities of energy consumed by the plurality of different devices. The monetary cost values may be measured in a single consolidated monetary cost scale using a single monetary unit (e.g., dollars ($)).

In operation 1830, the processor may generate an environmental scale values (e.g., environmental cost values 1612 of FIG. 19) defining the carbon footprint associated with each value of the input quantities of energy consumed by the plurality of different devices. The environmental cost values may be measured in a single consolidated environmental cost scale using a single environmental cost unit, e.g., a weight of carbon dioxide (CO₂).

The monetary cost values of operation 1820 and the environmental cost values of operation 1830 may indicate the monetary and environmental costs associated with the devices in operation 1800, respectively, using the amount of energy measured in the consolidated energy scale of operation 1810. Since each type of energy source (e.g., electrical, chemical, natural gas) has a different monetary and environmental impact, the processor may use different scaling factors to convert energy values associated with each respective type of energy source from the energy scale to the monetary and environmental scales.

In operation 1840, an output device (e.g., output device 1509 of FIG. 18) may display one or more of the consolidated energy, monetary or environmental cost values. These values may be displayed separately or together for comparison.

In some embodiments, the output device may display energy quantity values consumed by similar devices associated with one or more other users (e.g., values 1604, 1606, 1608 of FIG. 2) measured with the same output energy units or in the same output energy scale (EP). The displayed energy values may be regional or national averages of energy consumed by other users located in the same country or region as the current user. The other users may be users in the same age bracket or industry as the current user.

Other displays provided to a user may include a two or three-dimensional energy map of energy consuming devices (e.g., devices 1510-1518 of FIG. 18) associated with the user account. The map may be to scale (e.g., when using a blueprint) or may not be to scale (e.g., as shown in FIG. 18). When a large number of devices are used, the energy usage and energy efficiency parameters specific to each device may be entered, e.g., manually or automatically, such as by transmission with an identification (ID) code tagged onto the energy data. For example, a unique numeric tag may be provided for each of the devices associated with a user account so that collected data may be stored separately for each device. In this way, the computing device may individually analyze the sensed data associated with each device and reconstruct an accurate spatial arrangement of visualizations thereof. Such information may be used, e.g., to quickly locate malfunctioning units that are “leaking” energy. Energy usage information specific to each device, such as current rate of energy usage or most recent energy data, environmental cost data, history, repair history, actual geographical location, and/or standard unit specifications may be retrieved by a user by selecting (e.g., using an input device to refer to a portion of a user interface and clicking) on a visualization of the unit on a monitor or display device. Such information and optionally graphics visualization software for running the user interface may be stored in the computing device or at a remote server, e.g., for providing online visualizations via a network such as the Internet. In some embodiments, energy information for a client account may be transferred to a local computer or mobile device (e.g., uploaded from a server or computing device via a password protected client Internet webpage) where the user interface may be run (e.g., using an application installed on the local computer mobile device) to locally monitor the devices.

In operation 1850, a power setting (e.g., a speed, temperature setting, or other setting) in at least one of the devices (e.g., monitored devices 1510-1518 of FIG. 18) may be set or altered to maintain predicted target value(s) of quant(ies) of energy consumed (e.g., quantities in projected energy value 1720 of FIG. 20) measured in the consolidated energy scale. For a network of devices, the computing device may automatically control energy settings to maintain a total cumulative energy usage, e.g., below a predetermined target energy budget. A user may alter a setting manually, e.g., after receiving information from a user interface. A user may enter the values for the energy budget to a processing device, e.g., using the energy map in the example above.

Other operations, orders of operations, values, scales and displays may be used. The plurality of input energy values may be measured with at least two of the following energy units: kilowatt-hour (kWh), calories, Joules, British thermal unit (BTU), horsepower-hour, ergs, foot-pound force, electronvolts (eV), the Hartree (atomic unit of energy), and fuel equivalents. Other units may be used.

It may be appreciated that although, in one example, each Energy Point represents 100 kWh, the Energy Point (EP) scale may be normalized to any increment using any other suitable unit. The resolution of the Energy Point scale may be set so that the average daily usage for a single person or household may be counted in small integer values (e.g., 1-10 EPs). In one embodiment, a single (1) EP may be large enough to represent a substantial amount of energy (e.g., a short car trip or cooking a meal), but small enough to account for energy savings achieved by alternative, e.g., energy-efficient, devices or activities. Furthermore, energy may be counted in any increment of the Energy Point scale, such as, (10⁻⁶) Energy Points or micro-Energy Points (μ EP), (10⁻³) Energy Points or milli-Energy Points (mEP), (10⁻¹) Energy Points or deci-Energy Points (dEP), (10³) Energy Points or kilo-Energy Points (kEP), (10⁶) Energy Points or mega-Energy Points (MEP), etc.

When used herein, an energy “point,” “rating,” or “score” may be a general score, rating, or integer value, indicating an absolute or relative amount of energy, e.g., kinetic, potential, thermal, gravitational, and/or electromagnetic energy. In one embodiment, the higher the score representing consumption, the more energy is consumed. In another embodiment, a score may represent a specific property associated with energy, e.g., an environmental impact score, a monetary cost score, or another score or measure that corresponds to an amount of energy. Such a score may include multiple considerations, such as CO₂ emissions, water usage, land usage, cost, recycling effects, etc. In some embodiments, the higher the score, the greater the environmental impact and/or cost of the energy. A filter may select activities and/or devices associated with scores for energy, environmental impact and/or cost that are above a predetermined threshold and may display them as wasteful, and/or, a filter may select activities and/or devices associated with such scores below a predetermined threshold and may display them as good or optimal.

It may be appreciated that although some embodiments of the invention are adapted to monitor and control energy usage, resources other than energy, such as water, land, gold or other commodities or commercial products, or specific types on energy such as fuel, natural gas or oil, may equivalently be used.

Further embodiments, and further details which may be used with or describe the embodiments described herein, are described herein. Embodiments of the invention described through the description may include an article such as a non-transitory computer or processor readable medium, or a non-transitory computer or processor storage medium, such as for example a memory, a disk drive, or a USB flash memory, for encoding, including or storing instructions which when executed by a processor or controller (for example, processor 1502 of FIG. 18), carry out methods disclosed herein.

In the following description herein are provided additional embodiments for systems and methods for energy efficiency and sustainability management.

Embodiments of the invention relate to computer implemented systems and methods for measuring, analyzing, presenting and controlling energy consumption for various sectors (e.g. residential, commercial, governmental). According to one embodiment of the invention, a computer implemented system may collect data from various input sources such as utility bills, user input and multiple other sources, such as, airline miles, water bills and credit card receipts. This input data may be processed to provide a measurable quantity of energy consumption. An embodiment of the invention includes analyzing the input data and presenting it in a new energy consumption unit referred to, for example, as Energy Points. According to an embodiment of the invention, the input data may be derived using localization and visualization methods that associate energy consumption with a specific location.

The output data may include an Energy Point scale, or a scale in other standardized units. The Energy Point scale may use a quantitative scale for energy that, similar to the calories scale, is intuitive. Energy Points may be scaled to have a resolution small enough to detect differences between efficient and non-efficient machines but large enough to count energy usage in small integers of Energy Points. Energy Points may be monitored or tracked in space and time and may be converted to cost scales (e.g., dollars) and carbon footprint scales (e.g., weight of CO₂). Energy Points may be an energy unit that may replace or be used in place of the diversity of current energy units such as kilowatts (kWh), Calories, Mega Joules, and volumes of fuel or natural gas.

According to an embodiment of the invention, the measurement, analysis and presentation of values of consumed energy enables a plurality of computer implemented methods and systems to reduce energy consumption.

According to an embodiment of the invention, energy consumption reduction may be provided by employing a social network that provides solutions and motivates people to openly share specific ideas and means to reduce energy. To obtain accurate and reliable data in a way that may allow users to share it freely and self-improve, embodiments of the invention may provide a calculation or projected energy consumption model. Embodiment of the invention may also include a buffer for automatically paying energy bills and may be used for automatically calculating a product's energy efficiency.

Energy is of crucial importance in all aspects of life, for example, the economy, availability of future energy resources, the environment, global warming and energy security.

A goal according to some embodiments of the invention is to control and reduce energy use. Embodiments of the invention may provide a wide range of mechanisms to achieve this goal, for example, from measurement and rating to proposing alternative energy usage models and implementations.

One challenge may be a comprehensive energy measurement and rating system. Although a free market economy should provide comprehensive energy quantification by pricing energy correctly, current energy prices do not accurately reflect the environmental and political implications of energy use. Furthermore, energy has a number of different forms: chemical (fuel), electricity and heat and may be measured in a number of different units (e.g., kilowatt-hour (kWh), Calories, British thermal unit (BTU)). Due to the complexity and variety of energy measurements, few people have a quantitative intuition about energy. That is, few people know how to ‘count’ energy in a single metric or scale that represents, for example, a combination of different forms of energy, such as, electricity, heat, fuel, water and/or food.

Current methods for measuring environmental effects of energy usage include carbon or CO₂ accounting with schemes referred to as cap and trade. Although carbon accounting provides a metric for global warming and fossil fuel use, carbon accounting has inherent drawbacks. First, the carbon accounting metric system is highly non-intuitive. People are not accustomed to thinking in terms of CO₂ weight or volume or ‘carbon footprint’. It is an elusive and abstract notion. Second, the effects of ‘carbon footprint’ are debated as part of the debate of the human impact on the climate. However, even without global warming and CO₂, energy saving is a valuable issue from the economical and national security stand points. e.g., there is a need to conserve energy and protect the environment and reduce our dependence on fossil fuels.

Furthermore, energy sources such as nuclear and solar that have smaller carbon footprint, suffer from limitations that carbon accounting does not capture. For example, nuclear energy suffers from fuel supply limitation, reprocessing and nuclear proliferation challenges. Solar energy requires immense land area and consumes a significant amount of energy for manufacturing, shipment, installation and use of toxic chemicals. Consequently there is a need for another energy rating system, which may be translated or converted to an environmental impact scale (CO₂), but is not based only on environmental impact.

Embodiments of the invention may provide a new rating system that may be sufficiency accurate and detailed to enable the right decisions to be made (e.g., to differentiate significant energy savings) and yet simple enough to remain intuitive. The new rating system may measure energy using an Energy Point (EP). The EP system is comprehensive, understandable, and intuitive. It is based on rounded numbers with units of energy.

In an embodiment of the invention, the comprehensive measurement enabled by the EP rating is used to rate energy consumption in time and space in various sectors (residential, commercial, governmental), e.g., in relation to a specific location such as a house or office and on a periodic basis. The measurement may be achieved by a combination of data mining, user inserted data and physical measurements.

This measurement may be associated with a user, entity or ‘unit’, for example, an individual person, company, department in a company, army unit, government office, etc.

The process may be based on using accessible data as input. Input data may include, for example, electricity bills, car miles, air miles and electronic receipts to generate sufficiently accurate comprehensive information regarding energy consumption. Energy consumption may be correlated to cost and carbon footprint. The monitoring may be done on a periodic basis, for example, once per month.

The device may compare the energy consumption of a specific house or office to others within a specific social network (e.g. classmates or a neighborhood) and compare the respective EP consumption thereof. Energy consumption may be reduced as each member is motivated to reduce their consumption based on the reliable feedback obtained from the comprehensive measurement.

Specific solutions may be offered based on the needs of a specific user. For example, if the energy consumption in a specific sector such as the electricity is higher, the user may be offered a specific solution, such as, turn off lights when you leave a room or use energy saving/lower-wattage light bulbs. Furthermore, using smart grid, the user will be offered specific solutions.

In an embodiment of the invention, the current diversity of energy units such as kWh, Calories, Mega Joules, fuel equivalents etc., may be replaced with a single energy unit (EP).

In an embodiment of the invention, accurate and reliable data may be provided in a way that may allow users to share the data freely and self-improve a calculation model. In some embodiments, a buffer may automatically handle energy payments.

In an embodiment of the invention, the Energy Points rating may be used for product labeling.

In an embodiment of the invention, energy measurement and solution models may automatically improve using computer learning mechanisms via access to utility data. To allow the model to self-improve, embodiments of the invention describe an additional data optimization process.

According to some embodiments of the invention energy use may be controlled by measurement and rating systems (for example, the relationship of the energy rating system with cost and carbon footprint rating systems). A process may use accessible data such as electricity, gas bills, car mileage, airplane mileage and restaurant receipts and may convert this information into a comprehensive energy control system that measures Energy Points.

The EP rating system may be accurate enough to enable decisions and simple enough to be intuitive and practical.

In accordance with some embodiments Energy Points may be defined such that each Energy Point (EP) is 100 kWh:

1 EP=100 kWh Equation 1

In some embodiments, an Energy Point for electricity and chemical energy may be equivalent in the energy scale. The energy density of gasoline may be approximately 10 kWh per liter. Accordingly, each Energy Point may be equal to approximately 10 liters of gasoline, which is equal to approximately 2.6 gallons of gasoline or 65 miles in a 25 mile per gallon (MPG) car. Accordingly, each Energy Point may be equal to 2.5 gallons of gasoline.

An advantage according to some embodiments of the invention is that Energy Points unify electricity and fuel energy in a simple way.

For future estimations, it may be useful to remember:

1 EP˜2.5 gal Equation 2

Energy has a number of forms. Embodiments of the invention may use an energy scale in which all forms of energy are given equivalent weight. This means that the electricity Energy Points EPₑ are considered equal to lower grade energy such as heat and fuel or chemical energy EP_{c}, e.g., 1 EPₑ=1 EP_{c}. Treating all energy forms as equivalent, may provide preference to energy security for countries that import gasoline.

Although each form of energy may have the same energy or work potential, different types of energy are generally associated with different monetary costs and environmental effects. Accordingly, when needed, electricity Energy Points may be marked for example as EP_{e,} fuel Energy Points as EP_{c} and so on. Each different type of Energy Point may have a different weight or scaling factor in the environmental or monetary cost scale(s).

In the environmental impact scale, electricity may have relatively more weight than other energy sources, e.g., EPₑ˜2 EP_{c}, since the carbon footprint of electricity use in the U.S. is approximately 0.6 kgCO₂/kWh. Natural gas and gasoline may have relatively less weight than electricity, e.g., approximately 0.18 kgCO₂/kWh (50 kg/kJ) and 0.24 kgCO₂/kWh, respectively. For example, 1 EPₑ=60 kgCO₂, 1 EP_{c}˜20 kgCO₂.

In the monetary cost scale, one EP is about 10$. This is because the typical U.S. electricity price may be approximately 0.1$/kWh. The monetary cost scale may be adjusted to account for gas and fuel prices. For example, if recent gasoline prices are 3$/gal (and not 4$/gal as implied by 1 EP˜10$), the scale may be modified accordingly. For example, for gasoline: 1 EP_{c}=8$ and 4 EPₑ=5 EP_{c}. This equivalence may be adjusted to use the most recent accessible fuel price.

As for Natural Gas (NG), a US typical gas price of $15/mmBTU may be used, which is roughly equivalent to 5¢/kWh or 1 EP_{c}=$5.

That is, with current prices, $10 purchases about one EP of Electricity, 1.25 EPs of gasoline and 2 EPs of natural gas. The following table may summarize these demonstrative parameters:

TABLE 1
The typical cost per EP and CO₂ per EP

| | Cost per | CO₂ emission per |
|---|---|---|
| Energy | EP | EP |
| source | [$] | [KgCO₂] |
| Electricity | 10 | 60 |
| Gasoline | 8 | 25 |
| Natural Gas | 5 | 20 |

Embodiments of the invention may request energy information for different devices (e.g., devices 1510-1518 of FIG. 18) associated with a user or user account. A common calculation may be generated for a single person in a household as in the example below.

Similar calculations may be made for a company, a government agency, a department in a company, hospital or university, an army unit or a device or product (e.g., as described in herein). In the following example, the energy consumption is calculated for a person in a household per month:

EP=Σᵢ EPᵢ Equation 3

where i represents energy activity indices associated with using electricity, fuel, etc. For example, Equation 3 may be equal to:

EP=EPe+EP_{CAR}+EP_{AIRM}+EP_{HEAT}+EP_{FOOD}+EP_{WATER}+EP_{SHOP}+EP_{WASTE}+EP_{TOXW}+EP_{WORKP}+EP_{GOV}+EP_{NETGREEN} Equation 4

where EPₑ, EP_{CAR}, EP_{AIRM}, EP_{HEAT}, EP_{FOOD}, EP_{WATER}, EP_{SHOP}, EP_{WASTE}, EP_{TOXW}, EP_{WORKP}, EP_{GOV}, EP_{NETGREEN} are the number of Energy Points used by the user account for electricity, car mileage, air travel, heating, food, water, shopping, waste, toxic waste, work place, government as well as the net green energy contribution (which is subtracted from the total EP), respectively.

Unlike electricity, gas, fuel and water, which have an approximately linear correspondence between cost and quantity, food and shopped goods may have other contributing energy factors (e.g., including energy used to harvest, manufacture and ship the goods). Therefore, food and shopped may have a complex and non-linear correlation between cost and quantity. This correlation is discussed in greater detail herein.

For simplicity, embodiments of the invention may discuss the following energy parameters associated with each user or account:

1. Residential electricity

2. Transportation (cars and airplanes)

3. Residential Heating

These values generate, for example, the following combined energy scale:

EP=EPₑ+EP_{CAR}+EP_{AIRM}+EP_{HEAT} Equation 5

An embodiment is shown in FIG. 18. A device (e.g., computing device 1500 of FIG. 18) may collect input from various sources and may translate this input to Energy Points, cost points and CO₂ points.

For convenience, the device may distinguish between the following different types of parameters:
1. Fixed Parameters (marked by: F). These parameters may be inserted one time and may be updated as needed. They may be user-specific or region specific. For example, the occupancy of a house is a fixed parameter. At first this parameter may be estimated as the U.S. average, then as the local average and then may be refined as specified by a user or through access to databases. The fuel consumption of a car may also be a fixed parameter. The fuel consumption may be initially estimated as the U.S. average (e.g., 21 miles per gallon), then refined through image analysis of the car type and then refined through access to commercial and public data or through user-inserted information.

Another example for a fixed parameter is the local electricity price. This parameter is public and may be retrieved from a public database, e.g., with the desired accuracy.
2. Input Parameters (marked by: I): these parameters may be inserted periodically at a variable or fixed measurement frequency, for example, monthly (e.g., or weekly or yearly). For example, the electricity bill, car mileage and airline mileage may be input parameters. These parameters may be user inserted, estimated or obtained through access to private or public databases. The accuracy of these parameters is important for generating credible energy results. Accurate data may be obtained and refined in some embodiments of the invention.
3. Output Parameter (marked by: O): these parameters may be the calculation results that may be displayed as Energy Points, carbon footprint points and/or cost points.

Energy Points of Different Activities

Electricity Points

One or more input parameters may be used, which are easily available. In one example, the available input parameter is an electricity bill. A user may automatically link the Energy Point monitoring system to online energy bills via a network address and/or password. The Energy Point monitoring system may then derive the Electricity Points, for example, as follows:

EPₑ=Cₑ·EB[$] Equation 6

where Cₑ is a constant and ENV is the monthly electricity bill. The electricity bill may be entered by a user or may be retrieved on-line automatically. The automatic retrieval is subject to user's consent. For convenience, the input parameter may be displayed with the input units, for example, dollars ($). The various data insertion methods are shown, for example, in FIG. X. The constant Cₑ may be, for example:

$${c}_{e} = \frac{1}{100 \cdot {U}_{OC} \cdot EC} \qquad Equation 7$$

where the factor 1/100 is used to convert from kWh to EP units, U_{OC} is the house occupancy and EC is the electricity cost in $/kWh. The unit used for calculating U_{OC} may be the billed unit. In the residential application, as in the current example, the unit may be the household. However, the same may apply for other entities such as departments in a corporate or schools or any entity that receives an electricity bill. The balance between residential and workplace consumption is discussed in greater detail below.

Demonstrative values for U.S. residential energy consumption are provided, for example, in Table 2:

TABLE 2
Typical U.S. electricity parameters for a person in a household in a residential
setting.

| Parameter | Type | Value | Sources and comments |
|---|---|---|---|
| U_{OC} | F | 2.5 | The average U.S. house occupancy is 2.5. The model begins |
| | | | with this number, adapts it to the local occupancy on the |
| | | | community level and then prompts the user to insert the |
| | | | user's number. Census and town registry data may be used |
| | | | as well. |
| EC | F | $0.1/kWh | Local Electricity Cost. The energy model begins with an |
| | | | average number on the national level and modifies it on the |
| | | | state or county levels and according to use (residential or |
| | | | industrial) entered by the user. |
| EB | I | $80 | A typical U.S. monthly Electricity Bill. The range is from |
| | | | $30 to $130. See section below on obtaining utility data. |
| 1/Cₑ | O | $25/kWh | Result according to Equation 7 |
| EPₑ | O | 3 EP | An average residential EP per person per month from |
| | | | electricity in the U.S. |
| Cost per | O | $30 | A typical residential cost per person per month for electricity |
| person | | | |
| CO₂ per | O | 0.2 tonCO₂ | A typical residential weight of CO₂ per person per month for |
| person | | | using electricity. Regional knowledge includes how much |
| | | | renewable energy and nuclear energy is used. |

A simple correlation between the energy bill and Energy Points, that represents the U.S. average, may be, for example:

$${EP}_{e} = \frac{EB [ \$ ]}{25} \qquad Equation 8$$

### Electricity Points Observations and Modifications

Using the values listed in Table 1, a family of 3 with an $80 electricity bill typically consumes 3 Energy Points per month per person at home, which costs about $30 and leaves a carbon footprint of approximately 0.2 tons of CO₂. For comparison, using a 200 watt flat screen television for 5 hours uses 1 kWh, which is approximately equal to 0.003 of the monthly Energy Point consumption EPₑ. For further comparison, south California electricity usage household per capita per year is approximately 6,000 kWh or 5 EP per month.

Dividing energy usage to a monthly basis, gives, for example, lighting usage of 1 EP (1,200 kWh/yr), washing and drying usage of 0.8 EP (1,000 kWh/yr), cooling and refrigeration usage of 1 EP (1,200 kWh/yr), electronics and miscellaneous 0.5 EP (1,000 kWh/yr) and a total usage of 3.3 EP. These values corresponds to an electricity bill of about 100$/month. This information may be used for peak shaving, which is discussed in further detail below

### Car Points

Car information may include a number of miles driven per month (input parameter) and a number of miles per gallon (fixed parameter). Energy Points may be derived from these parameters. The car points may be, for example:

$${EP}_{CAR} = {C}_{CAR} \cdot \frac{{AvC}_{MPG}}{{MyC}_{MPG}} \cdot CM [ miles ] \qquad Equation 9$$

where C_{CAR} is the constant that characterizes a car, AvC_{MPG} is the US average car miles per gallon, MyC_{MPG} is the actual mileage of the car, and CM [miles] is the monthly car mileage. In one example, MyC_{MPG} is 25 MPG which is slightly higher than the actual US average AvC_{MPG} of 22 MPG. MyC_{MPG} is useful for car with fuel performance that is significantly different from the national average. CM [miles] may be entered manually by a user, e.g., via a cell phone camera, keyboard or other input device, or automatically deduced from a gas bill retrieved off the Internet.

Constant C_{CAR} may be, for example:

$${C}_{CAR} = \frac{1}{100 \cdot {C}_{OC} \cdot {AvC}_{MPG} \cdot \frac{1}{{ED}_{g}}} \qquad Equation 10$$

where the factor 1/100 is used to convert from kWh to Energy Points, C_{OC} is the car occupancy, AvC_{MPG} is the U.S. average fuel performance in miles per gallon, and EDg is the energy density of gasoline (e.g., although other factors or values may be used).

Demonstrative values for U.S. car energy consumption are provided, for example, in Table 3:

TABLE 3
Typical parameters for calculating Car Travel Points

| Parameter | Type | Value | Sources and comments |
|---|---|---|---|
| C_{OC} | F | 1.5 | Estimated car occupancy in the U.S. In Scotland, the estimated |
| | | | car occupancy is 1.6. This number may be obtained regionally |
| | | | or locally and a user-specific value may be entered. |
| AvC_{MPG} | F | 25 MPG | Slightly higher than the actual U.S. average of 22 MPG. In the |
| | | | calculation model this value may be derived from a database |
| | | | according to the model, make and year of the car or user or |
| | | | inserted by the car seller, registry or image analysis. |
| ED_{g} | F | 38 kWh/gal | The energy density of fuel may be a factor for all transportation |
| | | | fuel since the variation is typically smaller than 10%. It may be |
| | | | an important number to remember. |
| CM | I | 1,000 | Typical car miles: the average American drives 12,000 miles per |
| | | miles | year or about 30 miles per day. The model may have the miles |
| | | | as a user inserted number or using a cell phone camera to |
| | | | capture the mileage and process the picture into data. The |
| | | | mileage does not have to be entered on the same date when the |
| | | | mileage was obtained since the system may calibrate the value |
| | | | to the correct date. Fuel consumption may also be inserted |
| | | | through electronic receipts, credit card information or manually |
| | | | by a user. In another embodiment, mobile device or phone |
| | | | applications may enable a mobile device to calculate the car |
| | | | mileage based on a GPS and/or accelerometer in the mobile |
| | | | device. |
| C_{CAR} | O | 1/100 kWh/ | Calculation 1.5 × 25/38~1 |
| | | mile | |
| EP_{CAR} | O | 10 EP | Typical U.S. Energy Points from a car used per person per |
| | | | month (e.g., simply the number of miles driven per month |
| | | | divided by 100). |
| Cost per | O | 170$ | Typical cost per person per month from traveling in a car is |
| person | | | approximately 10 EP times 8$/EP for gasoline (see Table 1). |
| | | | The total cost is about $450 per mile, assuming a small Sedan |
| | | | that drives 12,000 miles per year. The actual value is typically in |
| | | | between these two estimates. Assuming that the car is owned, |
| | | | insurance paid and so on, the cost of maintenance, tires and fuel |
| | | | is about 0.17$/mile or $170 per month. |
| CO₂ per | O | 0.25 | Typical residential CO₂ per person per month from traveling in a |
| person | | ton CO₂ | car is given by 10 EP times 25 Kg CO₂/EP. |

A simple intuitive estimation of the typical EP consumption of a car may be, for example, the monthly mileage divided by 100:

$${EP}_{CAR} = \frac{CM [ mile ]}{100} \qquad Equation 11$$

For fuel efficient (or inefficient) cars, using an average car mileage of, for example, 25 MPG, gives:

$$CarP = \frac{CM [ miles ]}{4 \cdot {MyC}_{MPG}} \qquad Equation 12$$

For example, if a user owns a 50 MPG car and drives the same 1,000 miles per months, the Energy Points for the car may be, EP_{CAR}=5 EP.

Americans (e.g., using a 25 MPG car), use about 3 times more energy to drive a car than for electricity. However, by using a fuel-efficient car (e.g., a 40 MPG car) and driving half the distance, the same amount of energy may be used for driving the car and for electricity.

### Adding a Car's Embodied or Manufacturing Energy

Embodiments of the invention may calculate the Energy Points of a car to include the energy to manufacture the car. The energy to manufacture a car may be estimated to be, e.g., 120 mmBTU or 35,000 kWh, which is equal to 350 EP (each mmBTU˜3 EP). The energy model may take into account different car models and corresponding manufacturing so that for each car, the manufacturing or embodied energy may be, for example:

$$\frac{{EE}_{CAR} - {RE}_{CAR}}{{T}_{CAR}} \qquad Equation 13$$

where EE_{CAR} is the embodied energy in the car, T_{CAR} is the car life time in months and RE_{CAR} is the retrieved energy from using recycled materials to manufacture the car. A ton of recycled steal corresponds to about 10 GJ which is about 30 EP or 10% of the energy used to manufacture the car. In this example, the addition of the embodied energy of the car is (350-30)/120˜2.6 EP.

The may be a ‘penalty’ of about 1 EP per month per person for each car owned. For example, if a household uses more than one car, the car points of the household may be approximated, for example, as:

$$CarP = \frac{CM [ miles ]}{4 \cdot {MyC}_{MPG}} + {N}_{CARS} \qquad Equation 14$$

where N_{CARS} is a number of cars per household. It may be noted that owning 2 cars, without driving a mile, may contribute a positive energy value, for example, equivalent to half the typical domestic electricity use. These factors may be relevant when comparing electric cars and combustion engine cars. For example, when the energy required for recycling a lithium battery is added to the Energy Point calculation for a car, the Energy Points an electric car may change significantly.

To simplify, the car points for a user may be approximated, for example, as:

$$CarP = \frac{CM [ miles ]}{4 \cdot {MyC}_{MPG}} \qquad Equation 15$$

### Car Points Observations and Modifications

An example of a decision may be to drive 10 miles with an average 25 MPG car and use 10/25=0.4 EP or with a 50 MPG car and use 0.2 EP.

### Air Travel Points

Air travel is typically planned on an annual basis. Therefore, the input in air travel miles may be an annual mileage value. Air travel points may be, for example:

EP_{AIRM}=C_{AIRM}·YM[miles] Equation 16

where C_{AIRM} is a constant and YM [miles] is the annual air mileage. The annual air mileage per person can may inserted by a user or automatically through on-line access to the users air miles frequent flyers accounts, which may be done through a password permission process.

A constant, C_{AIRM}, may be estimated, for example, as follows:

$${C}_{AIRM} = \frac{1}{100 \cdot 12 \cdot {P}_{OC} \cdot {P}_{MPG} \cdot \frac{1}{{ED}_{8}}} \qquad Equation 17$$

where P_{OC} is the average airplane occupancy, P_{MPG} is a typical airplane fuel performance in miles per gallon and ED_{g} is the energy density of fuel. The energy density of airplane fuel ED_{g} may have the same value of 38 kWh/gal or 1 EP˜2.5gal, as car fuel. The factor 12 is used to convert calculations from years to months. For simplicity, all other parameters such as the airplane life and other airplane energy requirements such as maintenance, airport energy consumption, may be ignored.

Demonstrative values for calculating air-travel points are provided, for example, in Table 4:

TABLE 4
Typical parameters for calculating Air Travel Points

| Parameter | Type | Value | Sources and comments |
|---|---|---|---|
| P_{OC} | F | 350 | A Boeing 747-400 at full occupancy has 416 seats. The |
| | | | average occupancy is 84%. A user may enter a type of |
| | | | airplane model or the model may be automatically retrieved |
| | | | from on-line electronic airplane receipts. |
| P_{MPG} | F | 0.14 MPG | Assuming that the 747 airplane flies 8,800 with 63,158 gal, |
| | | | it uses about 50 MPG per passenger. This parameter is |
| | | | similar for a car with 30 MPG and an average of 1.6 passengers. |
| ED_{g} | F | 38 kWh/gal | Substantially the same as for cars. |
| YM | I | 6,000 miles | The total number of miles per month flown in a commercial |
| | | | aircraft in the U.S. is about 120 billion, which is about 500 |
| | | | miles per U.S. resident and 6,000 miles per U.S. resident |
| | | | per year. The mileage information may be automatically |
| | | | retrieved from various sources, such as, an airline database, |
| | | | credit card statements, electronic receipts and user inserted |
| | | | values. |
| C_{AIRM} | O | 1/1,500 kWh/ | 100 * 350 * 0.14/38 * 12~1,550. |
| | | mile | |
| EP_{AIRM} | O | 4 EP | Typical U.S. Energy Points from Air Travel per person per |
| | | | month. |
| Cost per | O | $75 | The cost was about $0.13/mile in 2007 and is now about |
| person | | | $0.15/mile. The monthly cost is about $75 and the cost per |
| | | | EP is about $19. |
| CO₂ per | O | 0.1 ton CO₂ | Similar estimate of 0.25 Kg CO₂/EP yields 0.1 ton CO₂. |
| person | | | |

Air travel Energy Points may be, for example:

$${EP}_{AIRM} = \frac{YM [ miles ]}{1.500} \qquad Equation 18$$

### Airplane Points Observations and Modifications

It may be observed that by comparing the amount of energy used per passenger, per mile by car and per passenger, per mile by airplane, the amount of energy used is similar. A user planning a plane trip to California inquiring about the energy consumption or carbon footprint may be sent a report indicating that driving with a loaded 4-passenger car and going with an airplane use about the same number of Energy Points.

It may be noted that the same calculation may be used for determining the energy consumption of any means of public or private transportation (e.g., train, bus, ship, helicopter, etc.)

For simplicity, parameters such as the airplane life cycle and other airplane energy requirements such as maintenance, airport energy consumption, are ignored in this model, but may be taken into account in a more comprehensive model.

### Heating Points

Heating Energy Points may correspond to space heating, cooking and water heating. For simplicity, heating Energy Points may correspond to natural gas, although other types of energy may generate heat. The same methodology may be used for calculating the energy used for heating with other fuels. Natural gas may be used for cooking (heating food), space heating (heating a home), and boiling (heating water).

The energy used to for heating may be computed, for example, as follows:

EP_{HEAT}=C_{HEAT}·GB[$] Equation 19

where GB[$] is the gas bill, e.g., in dollars ($) and C_{HEATING} is a constant that depends on the home occupancy and gas cost GC[$/kWh], for example, as follows:

$${C}_{HEAT} = \frac{1}{100 \cdot {H}_{OC} \cdot GC [ \$ / kWh ]} \qquad Equation 20$$

Demonstrative values for calculating Energy Points for heating are provided, for example, in Table 5:

TABLE 5
Typical parameters for calculating Heating Points

| Parameter | Type | Value | Sources and comments |
|---|---|---|---|
| H_{OC} | F | 2.6 | House occupancy (4%) above the U.S. average of 2.5. The model |
| | | | begins with this number, adapts it to the local occupancy on the |
| | | | community level and then prompts the user to insert the user's |
| | | | number. Census and town registry data may be used as well. |
| GC | F | 0.05 $/kWh | In 2007, the wholesale price was about $10 per gigajoule or |
| | | | $0.035/kWh. The residential price varies from 50% to 300% more |
| | | | than the wholesale price. For example, Massachusets residential price |
| | | | in 2010 is about $15 per thousand cubic feet, which is approximately |
| | | | $0.05/kWh. |
| GB | I | 80 $ | Atypical U.S. gas bill in May 2010. |
| C_{HEAT} | O | 1/14 kWh/$ | 100 * 2.6 * 0.05. |
| EP_{HEAT} | O | 6 | A typical number of Energy Points per person per month. |
| Cost per | O | 30 | In dollars ($). |
| person per | | | |
| month | | | |
| CO₂ per | O | 0.12 | 20 Kg CO₂/EP. |
| person | | ton CO₂ | |

The number of Energy Points used for heating may be computed, for example, as follows:

$$GasP = \frac{GB [ \$ ]}{14} \qquad Equation 21$$

### Heating Points Observations and Modifications

Renewable energy such as solar water heating may be included in the model, e.g., to reduce the gas bill. The total average ratio between heating and electricity may be approximately 12.5/4.3˜3, where 12.5 may be the sum of heating, hot water and cooking (12,000 kWh/yr, 3,000 kWh/yr, 1,000 kWh/yr, respectively). In the example used herein, the ratio is 2.

### Summarizing Electricity, Car, Air Miles and Heating

Embodiments of the invention may combine the (four) energy parameters, for example, electricity, car miles, air miles and heating, into a single uniform measurement scale.

The combined Energy Point value of the energy parameters may be approximated, for example, as follows:

$$EP = \frac{EB [ \$ ]}{25} + \frac{CM [ miles ]}{4 \cdot {MyC}_{MPG}} + \frac{YM [ miles ]}{1.500} + \frac{GB [ \$ ]}{14} \qquad Equation 22$$

For example, if a car has a fuel efficiency of 25 MPG, then the:

$$EP = \frac{EB [ \$ ]}{25} + \frac{CM [ miles ]}{100} + \frac{YM [ miles ]}{1.500} + \frac{GB [ \$ ]}{14} \qquad Equation 23$$

For example, if in the last month for a user account, a household has an electricity bill of $100, a car drove a thousand miles, a plane flew about 6,000 air miles during the year, and the user paid $80 for heating, then the monthly Energy Points for the account may be, for example, 4(electricity)+10(car)+4(air travel)+6(heating)=24 EP.

Conversion of Energy Points to monetary cost ($) and environmental cost (weight of CO₂) may use the relationships between Energy Points and money and weight of CO₂ associated therewith, for example, shown in Table 6:

TABLE 6
The typical cost per EP and CO₂ per EP

| | Cost per | |
|---|---|---|
| | monthly | CO₂ emission per |
| Energy | EP | EP |
| source | [$] | [Kg CO₂] |
| Electricity | 10 | 50 |
| Car | 50 | 50 |
| Air | 16 | |
| Gasoline | 8 | 25 |
| Natural Gas | 5 | 20 |

### Energy Points in the Workplace or Second Residence

### Electricity Points

To calculate electricity points for the workplace, occupancy and cost parameters, e.g., in Table 2, may be modified. For example, any profit and loss (P&L) center such as a department in a corporate or a government office may have (100) people and electricity bill of $3,000 per month at cost of $0.07/kWh. The electricity Energy Points at the workplace may be defined, for example, as shown in Table 27:

TABLE 7
Electricity parameters for a department of unit of 100 employees and
$5,000/month electricity cost at a rate of $0.05/kWh.

| Parameter | Type | Value | Sources and comments |
|---|---|---|---|
| U_{OC} | F | 100 | Occupancy of a P&L Center. |
| EC | F | $0.07/kWh | |
| EB | I | $3,000 | Monthly electricity bill. |
| 1/Cₑ | O | $7/kWh | Result according to Equation 7. |
| EPₑ | O | 4 EP | The company consumes about 428 EP. |
| | | | Per capita its about 4 EP |
| Cost per | O | | |
| person | | | |
| CO₂ per | O | | |
| person | | | |

Energy monitoring systems may report electricity points, electricity cost and/or carbon footprint associated, e.g., with each department or any other P&L unit or associated with revenues or profit. A company may use the reports to monitor its energy efficiency, energy costs and carbon footprint.

### Avoiding Double Counting

Workplace points (WorkPlaceP) associated with a group or department of workers may be divided into an amount associated with each user's individual workplace contribution, for example, to be added to the user's Energy Point counter in their personal user account. For example, a portion of the electricity consumption in the workplace may be added to the residential electricity consumption for a user. However, the employee's electricity associated may also be counted by the company that employs the individual, e.g., resulting in counting the energy use twice. In some embodiments, instead of assigning Energy Points to a user, Energy Points may be assigned to a well-defined local entity such as a household, office, factory or an army base and these location may in turn be associated with a user account (e.g., the property or business owners). For example, if an individual owns a car, it may be associated with the individual's household, but if a company owns the car, it will be associated with the workplace.

### Shopping Energy Points

Shopping data may be entered through credit card information and receipts, which may be entered by a user manually or may be retrieved automatically through on-line electronic receipts.

### Food Energy Points

Food data may be entered by a user, for example, through the user's Caloric budget or through credit card information or restaurants and supermarket receipts. The food data may be retrieved automatically through on-line electronic receipts.

There is thus provided a device for using Energy Points in accordance with a system and method for energy efficiency and sustainability management. In accordance with an embodiment there is provided a device for controlling total energy use using Energy Point analysis, visualization and social networks. Additionally, there may be provided a device for replacing the diversity of energy units with Energy Points. Moreover may be provided a device and process to self improve the model including a smart meter data and user inserted data.

Embodiments of the invention may obtain accurate and reliable data to enable users to share it freely and self improve their energy calculation model.

Embodiments of the invention may improve the accuracy of the energy calculation model by accessing utility data.

In some embodiments of the invention, a system may include an adaptive learning technology, such that an initial estimate is made and then refined by each new set of data automatically retrieved or entered by a user. In some embodiments of the invention, a system may include smart metering and social networking. In some embodiments of the invention, a system may include using Energy Points for product labeling. Additionally, a device for minimizing the Energy Point path between two points may be provided. Moreover, a device for mapping and labeling the energy hot spots (or HogSpots) may be provided. Additionally, a device may include making transactions in Energy Points. Furthermore, a system may include selling to an Industrial Park.

Embodiments of the invention may generate interactive electronic maps monitoring the energy usage of, for example, an area, a company, building, or industrial park. The map may provide data indicating the energy usage, monetary cost and environmental impact of each unit, e.g., area, building, or individual. Companies may monitor the energy maps to determine where to improve energy efficiency.

In some embodiments of the invention, a system may include a device for Poking (stinging) or helping others (support donate), such as by helping a family reduce their Energy Points. Additionally, a device for Peak Shaving/Load Balancing may be included. Embodiments of the invention may use social network information for peek shaving and load balancing. For example:
1. At about 6 PM a utility operator sees that a peak demand approaches in a certain area;
2. Using a server side or client side portal the utility operator may send a request to the social network in the area to move appliances to a different hour;
3. The reward is displayed, e.g., to be a reduced energy bill and according to Equation 8, better Energy Point performance.

The social Network may, for example use interactive tools to engage consumers in load balancing, use interactive tools to obtain electricity bills information, such as via a trusted source ‘EnergyPal’, use smart metering, use a mobile application, use a targeted advertisements business model and ensure defense of privacy

In accordance with an embodiment using energy converts the energy from a form of low entropy (which is higher quality) such as electricity, to a form of higher entropy (lower quality) such as heat. To generate energy, energy may be converted in the reverse direction (from high to low entropy), for example, converting heat to electricity using a turbo-generator. Energy is typically converted from one form to another in every day activities, for example, converting electricity to lower grade energy such as lighting, converting chemical energy such as natural gas into heat, or converting chemical energy such as gasoline into mechanical energy for transportation.

Cost and carbon footprint values may be consistent with the direction of entropy. For example, to convert thermal energy such as natural gas to electrical energy, for example, using a turbo generator with 40% fuel efficiency (which is typical for natural gas), the ratio of the carbon footprint of electricity to natural gas is 2.5 (which is consistent with the factor of 2.5 in Table 1).

Some systems may convert energy back and forth in both directions (e.g., from high to low entropy and from low to high entropy). For example, an electric car may convert chemical energy (e.g., coal or natural gas) into electricity and then convert electricity to mechanical energy. For example, the efficiency for converting natural gas to electricity is about 30% and the efficiency for converting electricity to mechanical energy for motion is about 80%. The energy efficiency for an electric car is generally comparable to that of a standard (fuel-powered) car, for example, since the total efficiency of the conversion for the electric car is about 32% which is comparable to the efficiency of an internal combustion engine. In another example, a plastic factory may convert energy from high to low entropy and from low to high entropy, converting electricity and oil to produce plastic bottles that contain oil and also converting high quality energy (electricity) to produce low quality energy (heat).

Since energy may be converted from one form to another and the energy used to produce useable energy are substantially the same for different forms of energy, embodiments of the invention may consider all energy forms, e.g., electricity, chemical and thermal, equal, such that, 1 EPₑ=1 EP_{c}=1 EPₜₕ. Such embodiments may give preference to the use of local energy sources (e.g., nuclear, renewable and coal) over gasoline. In such embodiments, instead of counting electricity as (e.g., 2.5 times) more ‘expensive’ than gasoline in the Energy Point scale, both forms of energy are equivalent, thereby providing a significant discount for electricity, which may be advantageous for energy security to limit importation of foreign energy sources.

However, to convert energy values to associated carbon footprint values, different scaling factors may be used for the different energy forms to reflect the different environmental impacts of using each form of energy. For example, electrical energy has a CO₂ emission value that is 2.4 times higher than that of chemical energy, e.g., according to Table 1. The carbon footprint conversion or scaling factor for each different type of energy may be, e.g., 0.18, 0.24 and 0.31 kgCO₂/kWh for natural gas, gasoline and coal, respectively. U.S. electricity sources are include approximately 50% coal, 15% natural gas, 20% nuclear, 7% hydro and other relatively small resources. For electricity, the carbon footprint per EPₑ may be 31×0.5+18×0.15˜15 kg CO₂/EPₑ. Since electrical energy may be processed for use (e.g., using a turbine and distributor), the carbon footprint per EPₑ may be divided by the average electricity production efficiency of, for example, 30%, to generate a total carbon footprint per electricity EPₑ of 50 kg CO₂/EPₑ. It may be noted that the efficiency of producing electricity from coal is typically lower than from natural gas due to the lower temperature required for energy conversion. The difference in the temperature required for energy conversion may also account for the difference between the carbon footprint of thermal and electrical energy.

In some embodiments, a conversion factor may be used to incorporate the difference in energy prices, for example, between oil rich or oil poor countries. In Table 8 national average cost and carbon footprint values are listed. Iceland may have a relatively low cost geothermal electricity and expensive imported gasoline.

TABLE 8
National average cost and carbon footprint for energy for the U.S., Iceland
and China.

| | USA | | Iceland | | | |
|---|---|---|---|---|---|---|
| | | CO₂ | (approximate) | | China | |
| | Cost | per EP | Cost | CO₂ per | Cost per | CO₂ per |
| Energy | per EP | [Kg | per EP | EP | EP | EP |
| source | [$] | CO₂] | [$] | [Kg CO₂] | [$] | [Kg CO₂] |
| Electricity | 10 | 50 | 5 | 5 | 4 | 5 |
| Gasoline | 8 | 25 | 15 | 25 | 15 | 25 |
| Heating | 4 | 20 | 1 | 3 | | 20 |

Iceland estimates are based on a geothermal energy economy, which is for example less than 1/10 of the carbon footprint and half the cost. A majority of oil is important and heating is typically achieved using the geothermal resources.

U.S. residents emit an estimated 25 tons CO₂ per capita per year. About 1% of this number is attributed to domestic electricity use.

Key numbers may provide an estimate of values that may be used to intuitively understand the Energy Point scale. The values for conversion may be used for quick conversions between the Energy Point scale and other energy scales, for example, giga-joules (GJ), BTUs, mcf of natural gas (NG) and kilo-watt (kWh).

TABLE 9
Numbers To Remember

Energy density of gasoline or diesel ~38 kWh/gal or 0.4 EP/gal
1 GJ~1 mmBtu~1 mcf of NG~278 kWh~3 EP

Other numbers, scales or Energy Point values may be used.

It may be noted that quantities of natural gas are typically measured in normal cubic meters (corresponding to 0° C. at 101.325 kilopascals (kPa)) or in standard cubic feet (corresponding to 60° F. (16° C.) and 14.73 pounds-force per square inch (psia)). The gross heat of combustion of one cubic meter of commercial quality natural gas is typically about 39 megajoules (≈10.8 kWh), but may vary by several percent, generating a total of about 49 megajoules (≈13.5 kWh) for one kg of natural gas (assuming 0.8 kg/m³, an approximate value).

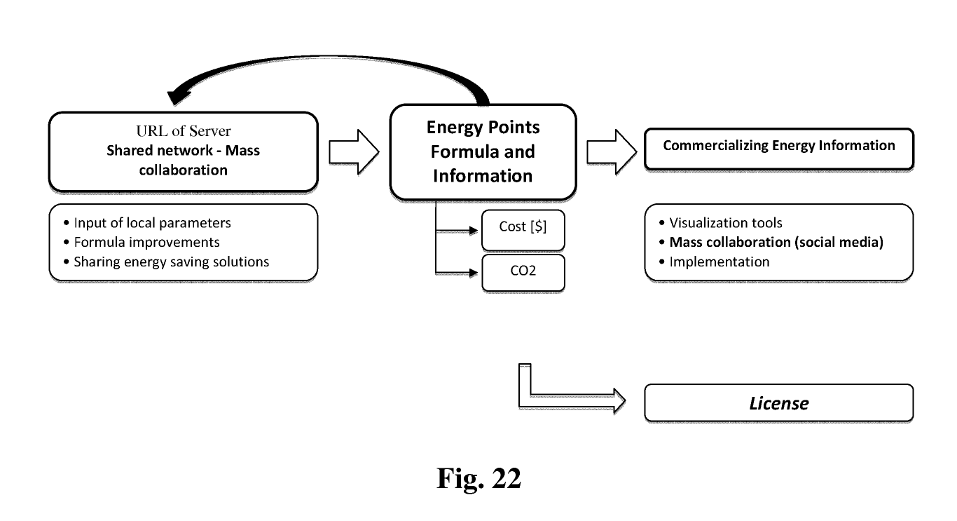

Embodiments of the abovementioned method and system for energy efficiency and sustainability management are illustrated in the following FIGS. 22-29.

FIG. 22 is a simplified flowchart of a method for energy efficiency and sustainability management illustrating self explanatory components of a structure of an Energy Point process and system.

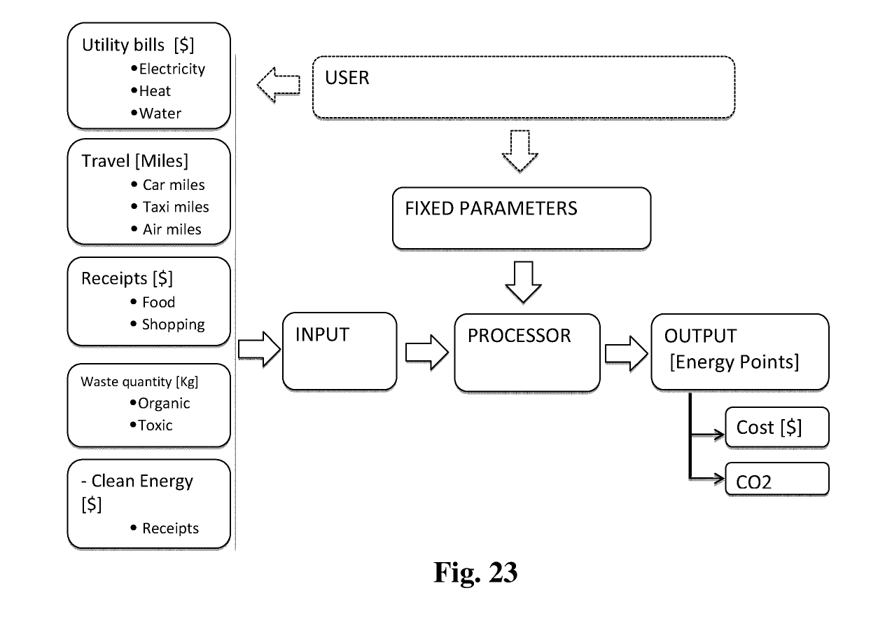

FIG. 23 is a simplified flowchart of a method for energy efficiency and sustainability management illustrating self explanatory components of a system for calculating Energy Points.

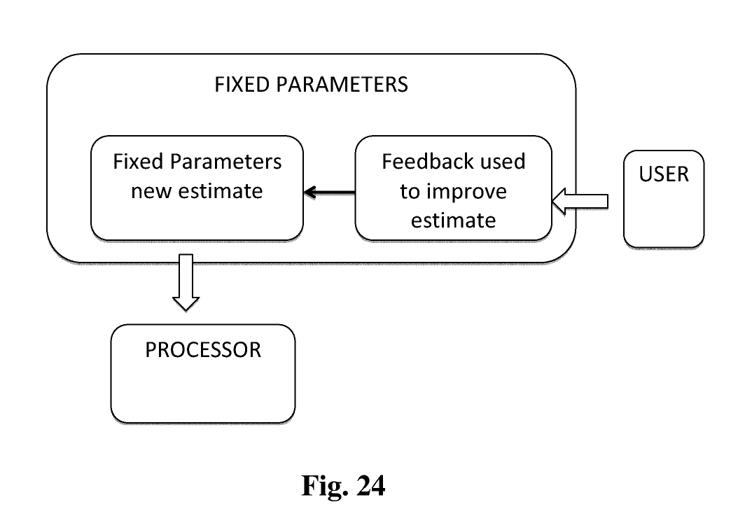

FIG. 24 is a simplified flowchart of a method for energy efficiency and sustainability management illustrating self explanatory components of a system for calculating Energy Points.

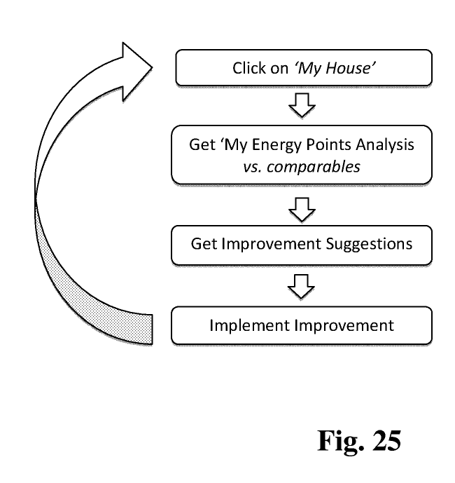

FIG. 25 is a simplified flowchart of a method for energy efficiency and sustainability management illustrating a self explanatory process for controlling total energy use using Energy Point analysis.

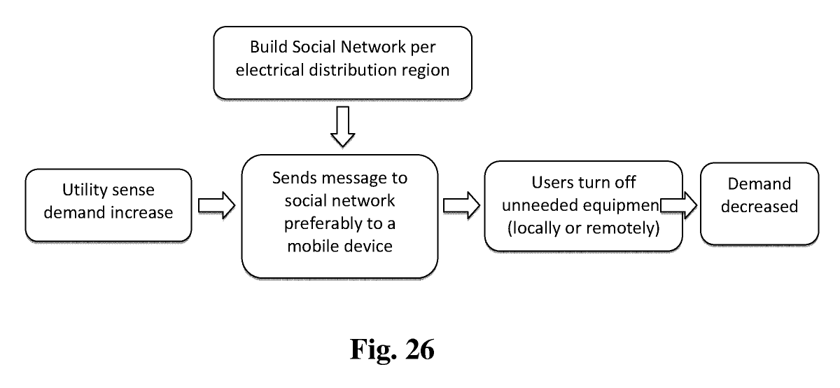

FIG. 26 is a simplified flowchart of a method for energy efficiency and sustainability management illustrating a self explanatory process for reducing energy use using a social network.

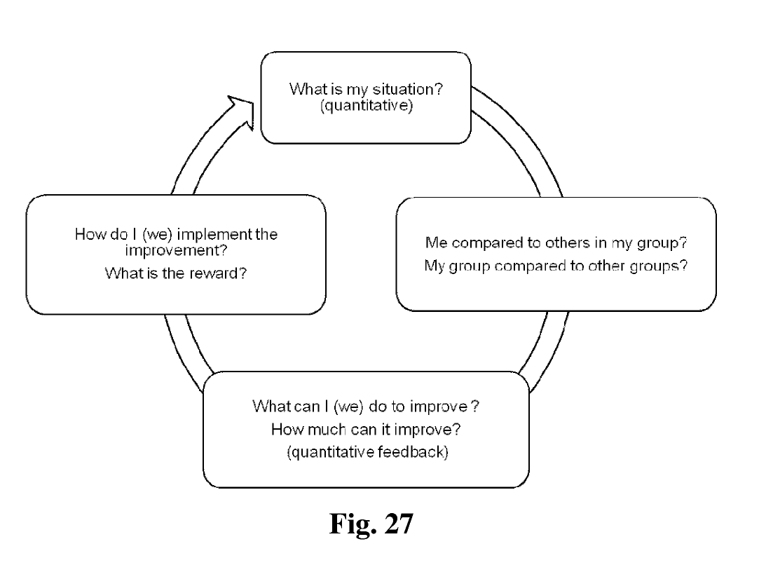

FIG. 27 is a simplified flowchart of a method for energy efficiency and sustainability management illustrating a self explanatory Energy Point feedback loop for evaluating energy use.

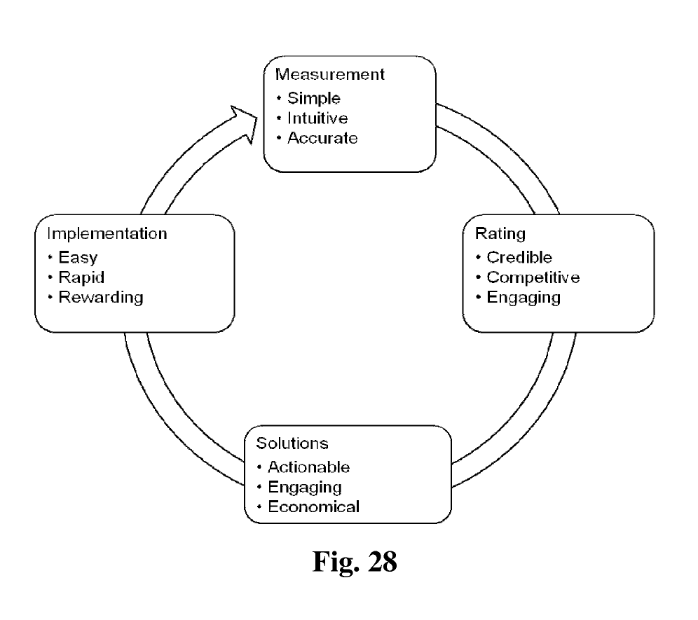

FIG. 28 is a simplified flowchart of a method for energy efficiency and sustainability management illustrating a self explanatory Energy Point feedback loop for evaluating energy use.

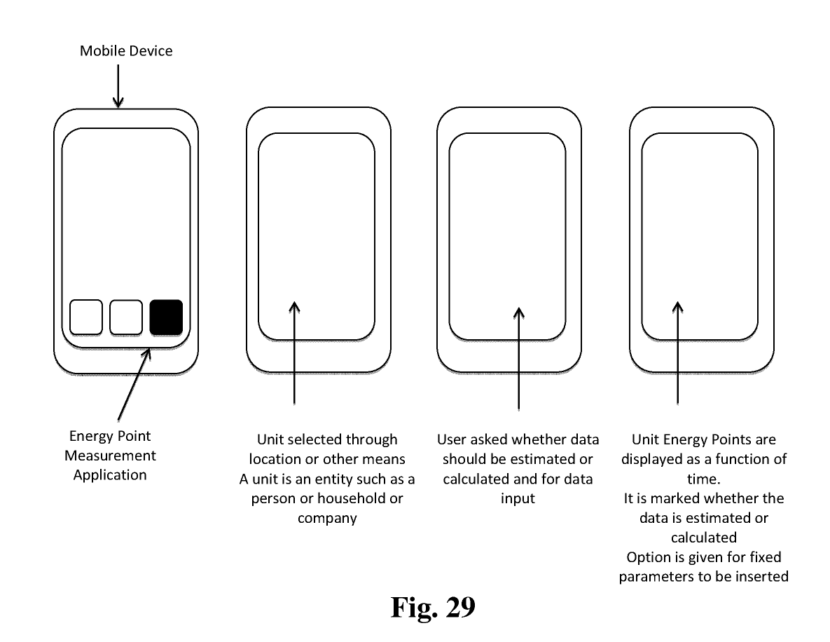

FIG. 29 is a simplified schematic illustration of a device for energy efficiency and sustainability management illustrating a self explanatory application on a mobile device for monitoring energy.

In the following description herein are provided additional embodiments for systems and methods for energy efficiency and sustainability management.

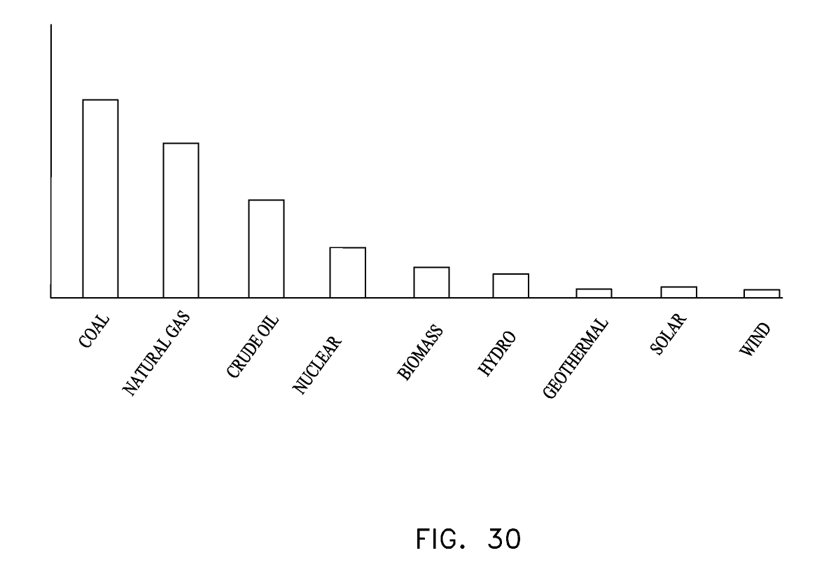

FIGS. 30-42 are displays provided to a user performing the methods in accordance with an embodiment of a method for energy efficiency and sustainability management

Embodiments of the invention relate to computer implemented systems and methods for measuring, analyzing, presenting and controlling energy consumption and environmental impact as energy consumption measured in Energy Points for various sectors (e.g. residential, commercial, industrial, governmental). According to one embodiment of the invention, a computer implemented system may collect data of various activities not necessarily those traditionally associated with energy, from various input sources such as utility bills, user input and multiple other sources, such as, airline miles, water bills and credit card receipts. This input data may then be processed to provide a measurable quantity of energy consumption. An embodiment of the invention includes analyzing the input data and presenting it in a new energy consumption unit referred to, for example, as Energy Points. According to an embodiment of the invention, the input data may be derived using measurement localization and visualization methods that associate energy consumption with a specific location. According to an embodiment of the invention, the system may be open and may be adapted to various locations through mass collaboration. According to an embodiment of the invention, the system enables a total energy and environmental impact budget. It further enables product labeling and other purchase decisions based on one number that represents the environmental impact: Energy Points.

The output data includes a new Energy Point scale. The Energy Point scale uses a quantitative scale for energy that, similar to the calories scale in food, may easily become intuitive. Energy Points are scaled to have a resolution small enough to detect differences between efficient and non-efficient activities and machines but large enough to count energy usage in small integers of Energy Points. Energy Points may be monitored or tracked in space and time and may be converted to cost scales (e.g., dollars) and carbon footprint scales (e.g., weight of CO₂). Energy Points are a new energy unit that may replace the diversity of current energy units such as kilowatts (kWh), mBtu, Mega Joules, and volumes of fuel or natural gas.

Using measured and easily presented consumption values translated into energy to control and reduce environmental impact, energy consumption, cost and carbon footprint

According to an embodiment of the invention, the measurement, analysis and presentation of values of consumed energy enables a plurality of computer implemented methods and system to reduce environmental impact and energy consumption.

For example, households that would like to improve their environmental performance while not giving up things that contribute to their standards of living would be able to run a computerized energy budget. Instead of the current situation where items like car use, electricity use, consumption of goods, water, waste etc., are counted separately and may not be part of one ‘energy budget’, the computer implemented method in the invention connect these items to one number that may be followed as one's ‘environmental or energy budget’. Similarly, corporations that would like to improve their energy consumption and environmental performance would have a quantitative way to measure and improve this performance. This metric may be translatable to carbon footprint and cost.

For example, according to an embodiment of the current invention, all these activities may be part of one budget so, for example, the Energy Point impact of buying a new car, may be compared to the impact of driving a car or using electricity or water. An electric car may be compared to internal combustion engine car from the entire environmental impact, including electricity production and battery making and disposal.

In accordance with an embodiment of the invention reducing energy consumption and the environmental impact that energy use entails, while maintaining economic growth and a modern standard of living, are among the biggest challenges of our time.

Although a free market economy may provide comprehensive energy quantification by pricing energy, current energy prices do not reflect the environmental, political and economical effects of energy use.

Energy has a number of different types or forms, for example, chemicals such as fuel, electricity, mechanical and heat. The conversion between the different forms of energy entails energy losses as implied by the second law of thermodynamics. Energy may be converted from one form to another in every day activities, for example, converting electricity to lower grade energy such as lighting, converting chemical energy such as natural gas into heat, or converting chemical energy such as gasoline into mechanical energy for transportation.

Using energy converts the energy from a form of low entropy (higher quality)—for example electricity, to a form of higher entropy and lower quality, for example: mechanical work and heat. To generate useful energy, energy may be converted in the reverse direction (from high to low entropy), for example, converting heat to electricity using a turbo-generator. The current invention translates these complex notions to a practical Energy Rating System that is on the one hand sufficiently accurate and on the other hand simple and easy to use.

Many decisions may be based on one leading parameter. Examples range from calories in a diet to heart rate in exercising, MPG in fuel efficiency, EBITDA or earning per share in investments. When it comes to energy, due to the complexity and variety of energy types and units, very few people have a quantitative intuition and a number that may be the basis of decisions. That is, few people know how to ‘count’ energy in a scale that represents, for example, a combination of different forms of energy, such as, electricity, heat, fuel used in the car, miles traveled in the air etc. In addition, energy may be consumed in products and activities, which are typically counted differently such as water, waste, materials, goods and food. These other activities have an environmental impact that may be counted as energy with the same metric. For example, the energy used for desalinating water or recycling a used battery.

The Energy Rating System may be a comprehensive process that may rate the energy consumption and environmental impact of human activities in an actionable manner (similar to food calories in a diet). Such a process may be used for example for rating products or activities according to their energy use and environmental impact. It may be used as a decision support system for households, governments, corporations and other organizations.

For a rating process to be accepted, it may be transparent, verifiable and not open for manipulation. In the case of energy, the hurdle may be higher since the rating system has to be based on quantitative intuition, similar to the way that calories in a food diet became a intuitive measure.

A goal according to some embodiments of the invention may be to control and reduce energy use, primarily by providing comprehensive energy rating. Embodiments of the invention may provide a wide range of mechanisms to achieve this goal, from measurement and rating to proposing alternative energy usage models and implementations.

According to an embodiment of the invention, the energy rating process may have the following characteristics:
1. Focus on energy as one rating metric (Energy Points).

Introducing a new energy unit, where the main criterion for choosing the unit may be building quantitative intuition. According to an embodiment of the invention the unit may be equal to the energy content of a gallon of gasoline (or liter of gasoline, barrel of oil etc).

The new unit enables easy and intuitive translation between electricity, fuel, heat and other energy sources and uses.
2. Rate everything as energy, including items that are traditionally not measured as energy such as water, waste, material, food and goods are rated as the energy that may be used to produce or dispose these items.

According to an embodiment of the invention, environmental performance may be quantified with one number (Energy Points). This may include all relevant environmental impact such as externalities as energy. For example, when rating an electric car and comparing it to an internal combustion engine, the entire impact (including energy generation, battery disposal and car life cycle analysis) may be captured in the Energy Points rating in a sufficiently accurate manner. In addition physical effects such as the global warming Albedo effect, may be rated as their energy equivalent.
3. Transparency and quantitative Intuition may be accomplished with round, sufficiently accurate numbers that are easy to work with and remember. The Energy Rating System may be built to neglect insignificant contributions while providing sufficiently accurate quantification—to enable intuition.

The derivation may be transparent and verifiable. These features make it universal and built for mass collaboration. In an embodiment of the invention, accurate and reliable data may be provided in a way that may allow users to share the data freely. This may allow the model to self-improve through social networks, cloud sourcing and mass collaborations.

The same Energy Rating System may serve different locations with different local parameters. The Energy Rating System may be improved through open source and mass collaboration. For example, a state like Wyoming has different electricity source (coal) and cost from Washington (hydroelectric) that may be taken into account in the Energy Rating System. As another example: the equivalence between water and energy is significant in California and practically negligible Massachusetts.

The unit for the Energy Rating System may be an individual person, company, department in a company, retail store, factory, unit in the army, government office, etc.

In an embodiment of the invention, the comprehensive measurement enabled by the Energy Rating System rating may be used to rate energy consumption in time and space in various sectors (residential, commercial, governmental), e.g., in relation to a specific location such as a house or office and on a periodic basis related to the time of day or day in the year.

Translation of energy to CO2 and cost may be built into the system.

The process may be based on using accessible data as input. Input data may include, for example, electricity bills, car miles, air miles and electronic receipts to generate sufficiently accurate comprehensive information on energy consumption. Energy consumption may be correlated to cost and carbon footprint. The monitoring may be done on a periodic basis, for example, once per month. Typical input includes accessible information such as bills and miles that may be translated by the Energy Rating System. This feature may allow the system to be more intuitive and easy to work with. The measurement may be achieved by a combination of data mining, access to public information and utility data, user inserted data and physical measurements.

Embodiments of the invention may provide a new rating system that may be sufficiency accurate and detailed to enable the right decisions to be made (e.g., to differentiate significant energy savings) and yet simple enough to build intuition, just as calories in food became an intuitive measure.

The new Energy Rating System may measure energy using a new unit, for example, referred to as an Energy Point (EP). The EP system may be comprehensive, understandable, and intuitive. The EP system may be based on rounded numbers with units of energy.

In an embodiment of the invention, the current diversity of energy units such as kWh, Calories Mega Joules, fuel equivalents etc., may be replaced with a single energy unit (EP). In an embodiment of the invention, the Energy Points rating may be used for product labeling and other purchase decisions, such as on-line shopping, where the total energy print of the product may be labeled similar to the way that it is labeled with Calories.
4. Built-in alternatives, suggestions and ‘what-if’ scenarios Specific solutions may be offered based on the needs of a specific user. For example, if the energy consumption in a specific sector such as the electricity is higher, the user may be offered a specific solution, such as, energy saving/lower-wattage light bulbs.

Current methods for measuring environmental effects of energy usage include carbon or CO₂ accounting with schemes referred to as cap and trade. Although carbon accounting provides a metric for global warming and fossil fuel use, carbon accounting has inherent drawbacks. First, the carbon accounting system is highly non-intuitive. People are typically not accustomed to thinking in terms of CO₂ weight or volume or ‘carbon footprint’. Carbon footprint may be known for a few decades. There are thousands of Internet calculators that may be used to calculate it on-line. Still, very few people know their carbon footprint. It may be an elusive and abstract notion related to one substance that accounts for 43% of global warming Embodiments of the current invention aim at enabling reduction and control of energy consumption and therefore the resulting pollutants such as CO₂, methane and soot. Second, the effects of ‘carbon footprint’ are debated as part of the debate of the human impact on the climate. However, even without global warming and CO₂, energy saving may be a valuable issue from the economical and national security stand points. e.g., there may be a need to conserve energy and protect the environment and reduce our dependence on fossil fuels. Furthermore, energy sources such as nuclear that have smaller carbon footprint, suffer from limitations that carbon accounting does not capture. For example, nuclear energy may be associated with fuel supply limitation, reprocessing and nuclear proliferation challenges. Consequently there may be a need for an Energy Rating System, which may be translated or converted to an environmental impact scale (including CO₂), but measures energy in an intuitive way, while capturing the total comprehensive environmental impact.

There is provided according to an embodiment of the invention a new energy unit where the criteria for choosing the unit is based on quantitative intuition. Accordingly, it may be equal to the energy content of a gallon of gasoline (or liter of gasoline etc). Additionally, one can measure everything as energy: items that are traditionally not measured as energy such as (water, waste, material use) are rated as energy. Items such as material goods are rated as their life cycle energy. Moreover, there are included externalities such as global warming and other environmental effects in the rating. Additionally, there is provided accessible input parameters that use bills. Moreover, there is provided a method which may be universal with local adaptations. The method may be transparent, verifiable and not open for manipulation and built for mass collaboration. Additionally, there may be provided built-in alternatives, suggestions and ‘what-if’ scenarios. Furthermore, the current diversity of energy units such as kWh, Calories Mega Joules, fuel equivalents etc., may be replaced with a single energy unit (EP).

According to some embodiments of the invention there is provided a method and system to control energy use by measurement and rating systems. A process may use accessible data such as electricity, gas bills, car mileage, airplane mileage and restaurant receipts and may convert this information into a comprehensive energy control system that measures Energy Points.

The proposed EP rating system may be accurate enough to enable decisions and simple enough to be intuitive and practical.

In accordance with an embodiment Energy Points may be defined such that each Energy Point may be equivalent to the energy contents of a gallon of gasoline. According to one embodiment of the invention, this may be important to build quantitative intuition since gallons of gasoline may be a form of energy that people buy directly and are used to paying for. The energy content of Gasoline may be given by:

1 EP˜1 Gallon_of_Gasoline˜38 kWh

The Energy Point rating, calibrated such that one EP may be a gallon of gasoline, may serve as an intuitive unit for counting energy consumption just like the kCal may be an intuitive unit in counting the energy content of food.

The following table provides the useful energy units in Energy Points, in one embodiment:

TABLE 10
Typical Energy Point values in other units, in one embodiment

| | Gallons | | | | | |
|---|---|---|---|---|---|---|
| | of | | | | | |
| EP | Gasoline | kWh | mBtu | therm | MJ | Cal |
| 1 | 1.0 | 38 | 0.13 | 1.3 | 137 | 32,680 |

Wherein the gallons are US gallons of auto gasoline; the calories are Nutritional calories and the difference between net and gross energy content of fuel is smaller than 10% and can be ignored. Diesel, Jet Fuel and Petrol also differ in less than 10% and are referred to as ‘fuel’

According to the invention, once Energy Points of different activities, products and materials may be remembered in approximate numbers, people may begin building quantitative intuition, similar to food calories.

In accordance with embodiments of the invention one may request energy information for different devices (e.g., devices 1510-1518 of FIG. 18) associated with a user or user account. A common calculation may be generated per person per month as in the example below.

Similar calculations may be made for a company, a government agency, a department in a company, hospital or university, an army unit or a device or product for product labeling. In the following example, the energy consumption may be calculated for a person in a household per month:

$$EP = {\sum }_{i} {EP}_{i}$$

where i represents activity indices associated with using energy, etc. For example, it may be equal to the following components:

EP=EP_{ELECTRICITY}+EP_{HEAT}+EP_{CAR}+EP_{AIRMILES}+EP_{WATER}+EP_{WASTE}+EP_{FOOD}+EP_{GOODS}+EP_{WORK}+EP_{COMMUNITY}

where EP_{ELECTRICITY} may be the EP associated with electricity consumption;

EP_{HEAT} may be the EP consumption associated with heat. In the current example the heat may be provided by natural gas. Heat may also be provided by electricity. In this case, heating consumption may be classified as electricity. Heat may also be provided by wood or fuel. In the case of wood, the calorific value of firewood (About 4.4 kWh/Kg or 5 EP/100 Lb) may be used. In the case of fuel, the calculation may be done in analogy to natural gas;

EP_{CAR,} may be a proxy for the EP consumption of all use of fuel-driven private means of transportation including cars, motorcycles, boats etc;

EP_{AIRMILES} may be a proxy for the EP consumption of public transportation such as planes trains and busses. Taxi's and shared cars such as those operated by the Zipcar service may be in the category of public transportation from the operational viewpoint and public from the capital or ownership viewpoint, which may be discussed in further detail herein. The numerical estimation of other means of public transportation may also be discussed in further detail herein. There may be a difference between public and private transportation when taking into account the fact that the plane schedule may be not dependent on the individual's decision to board it or not, while the decision to drive the car may be the driver's decision. This difference may be neglected for simplicity;

EP_{WATER} may be the EP consumption associated with water. It may be sensitive to the specific location. Some locations have a plentiful supply of fresh water while other locations use energy for water piping or desalination;

EP_{FOOD} may be the EP consumption associated with food. It includes the energy in its various forms (including water) associated with the production, shipment, packaging etc of food;

EP_{GOODS} may be the EP consumption associated with consumer goods. It may be the sum of the embodied energy in the goods that one buys, using conventional embodied energy and life cycle analysis techniques;

EP_{WASTE} may be the EP consumption associated with waste and toxic waste;

EP_{WORK} may be the EP consumption associated with one's workplace. The simplest estimation may be taking the workplace consumption per employee, in analogy to revenues per employee.

EP_{COMMUNITY} may be the EP consumption associated with the community (local community, state, national etc). The simplest model may be dividing the total consumption for example the government's consumption per capita.

The above Energy Points may be classified in various ways. For convenience, they are classified in the following 5 levels, for example per person per month:

EP=EP_{I}+EP_{II}+EP_{III}+EP_{IV}+EP_{V}

EP_{I}: Operational commodity items that are conventionally counted as energy (electricity, heating, travel) and are easiest to monitor as energy:

EP_{I}=EP_{ELECTRICITY}+EP_{HEAT}+EP_{CAR}+EP_{AIRMILES}

EP_{II}: Capital non-commodity items such as the embodied energy of a house and car:

EP_{II}=EP_{EE CAR}+EP_{EE HOUSE}

EP_{III}: Operational commodity items that are typically not counted as energy such as water, waste disposal:

EP_{III}=EP_{WATER}+EP_{WASTE}

EP_{IV}: Non-commodity (capital and operational) items such as food and goods:

EP_{IV}=EP_{FOOD}+EP_{GOODS}

EP_{V}: Shared consumptions such as workplace and community:

EP_{V}=EP_{WORK}+EP_{COMMUNITY}

In the following example, the energy consumption may be calculated for a person in a household per month, according to the above classification.

Energy may be used in its different forms for different uses. Electricity may be the highest quality form of energy. According to the current invention, electricity may be separated from lower quality forms of energy such as fuel. This may be done through an introduction of an electricity factor

represents the local electricity mix. According to the current invention, the electricity mix may be a function of three components: η, χ and e. Where η is the generation and transmission efficiency. It accounts for the conversion chemical or nuclear energy to electricity; χ may be the capital and operational energy consumption. It represents the fraction of the energy produced by the plant that may be spent on capital equipment (steal, concrete, turbines, grid connection etc) and operations and maintenance throughout the plant life; e may be the fraction of the energy produces that accounts for the externalities. It may be the amount of energy spent to restore the environment, including pollution, water use and global warming effects.

According to an embodiment of the invention, renewable may be separated from non-renewable sources. In the case of renewable energy, the resource may be considered infinite and only the capital and operational energy consumption as well as the externalities may be taken into account.

For example:

non-renewable:

$${EP}_{ELEC} = η {EP}_{PRIMARY} - {EP}_{ELEC} ( χ + ɛ )$$

$${EP}_{ELEC} = \frac{η}{1 + χ + ɛ} {EP}_{PRIMARY}$$

$$φ = \frac{1 + χ + ɛ}{η}$$

renewable:

φ=χ+ε
η=efficiency, χ=Capital_Consumption
ε=Externalities

χ may be the fraction of capital and operational energy consumptions used to harness the resource, such as the amount of energy used for building and operating the power plant (solar, nuclear or coal).

For example, about 15% of the energy that solar panels produce may be consumed by the production and installation of the panels. This does not include the externalities such as water, waste and other environmental impacts. Thus, η=0.15 may be estimated for solar. As with other specific values discussed herein, efficiencies, losses, conversion values, etc., may be different depending on specific circumstances or embodiments.

As another example, a nuclear power plant of 1 GW uses about 70,000 tons of steel and 1.2 million ton of concrete. The embodied energy of steel and concrete are about 13 kWh/Kg and 2 kWh/Kg respectively. The total may be about 90 million EP. This does not account for shipping, water, labor and other capital operational consumption. For example, the total capital consumption may be 150 million EP. Assuming that the plant exists for 25 years and produces on average 75% of the full capacity, which may be 4.3 billion EP. Thus x can be estimated as 0.02.

e represents the externalities associated with the power plant. It may be the fraction of the energy to fix the environment due to the energy production. It includes global warming (including e.g. the Albedo effect), pollution, land use and so on. The following table demonstrates some of the values used for φ according to the invention. It is noted that these numbers are estimations based on averages and may be modified according to local conditions, economical constraints and technology. In this specific example η includes a transmission and distribution loss of 5% (e.g. distributed versus centralized generation may also have an effect on φ. The description of this effect may be discussed in detail herein)

TABLE 11
Typical values used for converting from primary to end-use energy.

| Primary Energy | | | | |
|---|---|---|---|---|
| Source | η | χ | e | φ |
| Coal | 0.3 | 0.05 | 0.1 | 4.0 |
| Crude oil | 0.35 | 0.03 | 0.03 | 3.2 |
| Natural Gas | 0.55 | 0.03 | 0.02 | 2.0 |
| Nuclear | | 0.04 | 1 | 1.04 |
| Hydro | | 0.2 | 0.4 | 0.60 |
| Biomass | | 0.1 | 0.4 | 0.50 |
| Geothermal | | 0.1 | 0.1 | 0.20 |
| Solar | | 0.15 | 0.1 | 0.25 |
| Wind | | 0.05 | 0.1 | 0.15 |

FIG. 30 illustrates the conversion factor for electricity φ According to one embodiment. It shows the amount of primary energy used to generate one Energy Point of electricity.

As an example, consider the typical US electricity mix of: Coal (22%) Natural Gas (21%) Crude oil (11%), Nuclear (8%), Biomass (4%), Hydro (3%), Liquid NG (3%) and 1% renewable (Solar, Wind, Geothermal), the typical electricity factor for the US may be φ˜2.5.

The following table shows some energy mix distributions of US states and the resulting φ

TABLE 12
Typical electricity mix and electricity factors of US states

| Primary | | | | | New | | | |
|---|---|---|---|---|---|---|---|---|
| Energy | Seattle | California | Wyoming | Texas | York | Mass. | Nevada | Arizona |
| Coal | 13% | | 98% | 40% | 14% | 30% | 45% | 45% |
| Crude oil | | | | 2% | 15% | 12% | 49% | |
| Natural | 10% | 47% | | 50% | 18% | 48% | | 27% |
| Gas | | | | | | | | |
| Nuclear | 10% | 18% | | 6% | 32% | 8% | | 24% |
| Hydro | 65% | 19% | | | 18% | | 3% | 4% |
| Biomass | | 2% | | | 3% | 2% | | |
| Geothermal | | 10% | | | | | 3% | |
| Solar | | 2% | | | | | | |
| Wind | 2% | 2% | 2% | 2% | | | | |
| φ | 1.2 | 1.3 | 4.0 | 2.7 | 1.9 | 2.7 | 3.4 | 2.6 |

By utilizing the method of the invention one may connect different energy domains as energy (EP_{I}); count as energy items that are conventionally not counted as energy, such as water (EP_{II}) ; perform the above in a sufficiently accurate but simplified manner such that quantitative intuition and a ‘budget’ may be built and maintained. Consider, for simplicity, the following combination of Energy Points:

Consider the following simplified example:

EP=EP_{CAR}+EP_{ELECTRICITY}+EP_{WATER}

For example, one month may be chosen as the period for calculation since typically bills are paid once per month. Without being limiting, the period may also be a day or a year. For example, the house occupancy and the car occupancy are unity.

The car EP may be simply given by the number of fuel gallons. The electricity EP may be the number of kWh consumed that month, divided by 38. The water EP may be proportional to amount of water supplied, measured in 1,000 of water gallons divided by a local water factor (LWF) that represents the amount of fresh water that may be delivered per EP:

$$EP = Fuel [ Gal ] + φ \frac{Electricity [ kWh ]}{38} + \frac{Water [ k Gal ]}{LWF [ k Gal / EP ]}$$

The first two elements in the equation show the equivalence of fuel and other forms of energy such as electricity. One example is driving 1,000 miles per month, which may be near the US average, in a 25 MPG car. This means that EP_{CAR}=40 EP. If the average car occupancy was two, then this number would be reduced to 20 EP.

For example, an area with φ=1.5 and an average electricity nameplate of about 2 kW per person. The typical consumption may be about 75% of the capacity, which may be 1,080 kWh (24*30*2*0.75). Dividing by 38/φ a similar number may be obtained:

EP_{ELECTRICITY}˜43 EP

Notice that in cold places such as Boston, the winter heating per person per month may be typically around 5 mBtu, which may be a contribution again near 40 EP (5/0.13˜38).

The typical water consumption in a cold place may be about 3,500 gallons per person per month and the energy to deliver fresh water may be negligible on the scale of 40 EP/month. As a simplified example, consider California or Arizona where some areas consume up 200 gallons per person per day (6,000 gallons per person per month). In one example the energy used to deliver water includes desalination at 3 kWh/m̂3 and piping at additional 2 kWh/m̂3. So the total may be 5 kWh/m̂3 with φ=1.5 (assuming that desalination may be done through electricity). Then the monthly consumption per person may be EP_{WATER}˜3 EP (6×1,000 [lit]×3.8[Gal/lit]×5 [kWh]=3 EP)

The above example demonstrates how different forms of energy may be treated as equivalent and how water may be equated to energy.

The next step may be to make the above equation easy to use. Most people do not remember or know how much energy or gallons they used but may more easily work with their payments or miles.

The energy consumption that may be conventionally referred to as energy:
1. Residential electricity and heat
2. Transportation private and public.

For simplicity, an example is provided for cars and airplanes:

EP_{I}=EP_{CAR}+EP_{ELECTRICITY}+EP_{HEAT}+EP_{AIRMILES}

Energy Points of Driving a Car

The available monthly car information may be the miles that where driven in a specific month. Car information may include a number of miles driven per month and a number of miles per gallon. Energy Points may be derived from these parameters. The car points may be, for example:

$${EP}_{CAR} = \frac{CarMiles}{{C}_{OC} \cdot {MPG}_{CAR}}$$

where CarMiles are the miles driven in the car in the relevant period of time e.g. a month. MPG_{CAR may be} the average MPG of the car. The car MPG is an estimated number. It is may be either calculated independently per driving pattern or inserted through the car computer and calculated accurately. C_{OC} may be the car occupancy.

The range of behavior patterns largely impacts the EP consumption. For example an ‘average’ person that drives 1,000 miles per month in a 25 MPG car with two cars serving 3 people, may have about 27 EP per month, which may be equivalent to one EP or gallon per day.

A Prius driver with 50 MPG that drives 200 miles per month and owns one car per household of 4 may have 1 EP (200/50/4) per month from car driving.

Demonstrative values for U.S. car energy consumption are provided, for example, in Table 13:

TABLE 13
Typical parameters for calculating Car Travel Points

| Parameter | Value | |
|---|---|---|
| C_{OC} | 1.6 | Estimated car occupancy in the U.S. In Scotland, the |
| | | estimated car occupancy may be 1.6. This number may |
| | | be obtained regionally or locally and a user-specific |
| | | value may be entered. |
| MPG_{CAR} | 25 MPG | May be derived according to the model, make and year |
| | | of the car or user or inserted by the car seller, registry or |
| | | image analysis. |
| CM | 1,000 | The average American drives 12,000 miles per year. The |
| | miles | model may have the miles as a user inserted number or |
| | | using a cell phone camera to capture the mileage and |
| | | process the picture into data. The mileage does not have |
| | | to be entered on the same date when the mileage was |
| | | obtained since the system may calibrate the value to the |
| | | correct date. Fuel consumption may also be inserted |
| | | through electronic receipts, credit card information or |
| | | manually by a user. |
| EP_{CAR} | 27 EP | Typical U.S. Energy Points from a car used per person per |
| | | month |
| Cost per | 17$ | Assuming that the car may be owned, insurance paid, the |
| person | | cost of maintenance, tires and fuel may be about |
| | | 0.17$/mile or $170 per month. |
| Cost per EP | 5$ | |
| CO₂ per | 225 Kg CO₂ | Typical residential CO₂ per person per month from |
| person | | traveling in a car may be given by 25EP times |
| | | 9 Kg CO₂/EP. |

For the average American, the car points may be, for example:

$${EP}_{CAR} = \frac{CarMiles}{40}$$

Electricity Points

The preferred embodiment in calculating the Electricity Energy Points may be to use the electricity bill as the available input.

A user may automatically link the Energy Point monitoring system to online energy bills via a network address and/or password. The automatic retrieval may be subject to user's consent:

The Energy Point monitoring system may then derive the electricity Energy Points, based on the Electricity Bill, for example, as follows:

$${EP}_{ELECTRICITY} = \frac{φ \cdot EBill [ \$ ]}{38 \cdot {H}_{OC} \cdot ECost [ \$ \text{/} kWh ]}$$

The where the factor 1/38 may be used to convert from kWh to EP units, H_{OC may be} the house occupancy and EC may be the electricity cost in $/kWh.

The unit used for calculating H_{OC} may be the billed unit. In the residential application, as in the current example, the unit may be the household. However, the same may apply for other entities such as departments in a corporate or schools or any entity that receives an electricity bill.

Consider the average US electricity mix of φ=2.5 and a typical household of 2.5 people and electricity cost of 0.1$/kWh may have simply:

$${EP}_{ELECTRICITY} = \frac{EBill [ \$ ]}{4}$$

The typical electricity Energy Points are the energy bill in dollars divided by 4.

The factor changes according to local and personal conditions. For example, the electricity cost remains 0.1$/kWh and compare a household with 5 people in an area with renewable energy and low φ=1 to a household of one individual in a ‘coal’ state of φ=4. The range may be presented in the following table:

TABLE 14
Range of electricity factors, assuming electricity Cost of 0.1 $/kWh

| | Low | Mid | High |
|---|---|---|---|
| φ | 0.9 | 2.5 | 3.5 |
| H_{OC} | 6 | 2.5 | 1 |
| EP_{ELECTRICITY} | EBill[$]/25 | EBill[$]/4 | EBill[$] |

Once the local electricity mix, electricity price and house occupancy are known, the electricity EP may be simply given by the monthly bill times a constant that typically range from 1 to 1/25. An electricity bill of $100 for one individual may be a hundred EP while for another it may be 4 EP.

Demonstrative values for U.S. residential energy consumption are:

TABLE 15
Typical U.S. electricity parameters for a person in a household in a residential setting.

| Parameter | Value | Sources and comments |
|---|---|---|
| H_{OC} | 2.5 | The average U.S. house occupancy may be 2.5. The model |
| | | begins with this number, adapts it to the local occupancy on the |
| | | community level and then prompts the user to insert the user's |
| | | number. Census and town registry data may be used as well. |
| ECost | $0.1/kWh | Local Electricity Cost. The energy model begins with an average |
| | | number on the national level and modifies it on the state or |
| | | county levels and according to use (residential or industrial) |
| | | entered by the user. |
| φ | 2.5 | The electricity factor may be location dependent |
| EBill | $100 | A typical U.S. monthly Electricity Bill per household. The range |
| | | may be from $30 to $130 |
| EP_{ELEC} | 25 EP | An average residential EP per person per month from electricity |
| | | in the U.S. |
| Cost per | $40 | A typical cost per person per month for electricity |
| person | | |
| CO₂ per | 200 Kg CO₂ | A typical residential weight of CO₂ per person per month for |
| person | | using electricity. Regional knowledge includes how much |
| | | renewable energy and nuclear energy may be used. |
| | | An average may be 8 Kg CO₂/EP |

Air Travel Points

Air miles are typically counted on an annual basis. Therefore, the input in air travel miles may be an annual mileage value divided by 12. The annual air mileage per person may be inserted by a user or automatically through on-line access to the users air miles frequent flyers accounts, which may be done through a password permission process. Air travel points may be for example:

$${EP}_{AIRMILES} = \frac{YearAirMiles}{12 \cdot {P}_{OC} \cdot {MPG}_{PLANE}}$$

where P_{OC} may be the average airplane occupancy, MPG_{PANE may be} a typical airplane fuel performance in miles per gallon. The energy density of airplane fuel may be approximated as having the same value of 38 kWh/gallon as car fuel. For simplicity, all other parameters such as the airplane life and other airplane energy requirements such as maintenance, airport energy consumption, are neglected.

Boeing 747-400 at full occupancy has 416 seats. The average occupancy may be 84% so the effective occupancy may be 350. The MPG may be about 0.14 that the effective MPG per passenger may be 50 MPG. Similar to an efficient hybrid car.

This means that the decision to drive a 25 MPG car with two people from New York to California or take a flight, are equivalent from the Energy Points perspective. There may be a difference when taking into account the fact that the plane schedule may be not dependent on the individual's decision to board it or not, while the decision to drive the car may be the driver's decision. This difference may be currently neglected for simplicity.

Other forms of public transportation (trains, busses) may be dealt with in the same way.

Demonstrative values for calculating air-travel points:

TABLE 16
Typical parameters for calculating Air Travel Points

| Parameter | Value | Sources and comments |
|---|---|---|
| P_{OC} | 350 | A Boeing 747-400 at full occupancy has 416 seats. The |
| | | average occupancy may be 84%. A user may enter a |
| | | type of airplane model or the model may be |
| | | automatically retrieved from on-line electronic airplane |
| | | receipts. |
| MPG_{PLANE} | 0.14 MPG | Assuming that the 747 airplane flies 8,800 with 63,158 gal, |
| | | it uses about 50 MPG per passenger. This |
| | | parameter may be similar for a car with 30 MPG and an |
| | | average of 1.6 passengers. |
| YearAirMiles | 6,000 | The total number of miles per month flown in a |
| | miles | commercial aircraft in the U.S. may be about 120 |
| | | billion, which are about 500 miles per U.S. resident and |
| | | 6,000 miles per U.S. resident per year. The mileage |
| | | information may be automatically retrieved from |
| | | various sources, such as, an airline database, credit card |
| | | statements, electronic receipts and user inserted values. |
| EP_{AIRM} | 10 EP | Typical U.S. Energy Points from Air Travel per person |
| | | per month. |
| Cost per | $75 | The cost has a broad range. It was about $0.13/mile in |
| person | | 2007 and may be now about $0.15/mile. So: 0.15$/mile × |
| | | 50 MPG~ |
| CO₂ per | 0.1 | Similar estimate of 0.25 Kg CO₂/EP yields 0.1 ton CO₂. |
| person | ton CO₂ | |

Air travel Energy Points may be, for example:

$${EP}_{AIR} = \frac{YM [ miles ]}{600}$$

It may be noted that the same calculation may be used for determining the energy consumption of any means of public or private transportation (e.g., train, bus, ship, helicopter, etc.). For example, the typical bus consumes 8 MPG. In a full occupancy of 50 its effective MPG may be 200 MPG. However, if the average occupancy may be 60%, the effective Bus MPG may be 120 MPG.

A fast train has an effective MPG similar to a Bus. A commuter train may have an effective MPG similar to an airplane of about 50 MPG. Amtrak reports energy use of 2,935 BTU per passenger-mile (44 MPG)

Heating Points

Heating Energy Points may correspond to space heating, cooking and water heating. For simplicity, heating Energy Points may correspond to natural gas, although other types of energy may generate heat. The same methodology may be used for calculating the energy used for heating with other fuels. Natural gas may be used for cooking (heating food), space heating (heating a home), and boiling (heating water).

Assuming that the gas bill may be in therm, (Natural-gas billing use ‘therm’ which is 0.1 mBtu. It may also refer toMcf (1,000 cubic feet). 1 Mcf˜1 mBtu) the energy used to for heating may be computed, for example, as follows:

$${EP}_{HEAT} = \frac{GasBills [ \$ ]}{1.3 \cdot {H}_{OC} \cdot GasCost [ \$ \text{/} therm ]}$$

Demonstrative values for calculating Energy Points for heating by gas:

TABLE 17
Typical parameters for calculating Energy Points of heating by gas

| Parameter | Value | Sources and comments |
|---|---|---|
| H_{OC} | 2.5 | same as above |
| Gas Cost | 1.2 | The residential price varies from 50% to 300% |
| | $/therm | more than the wholesale price. About half the |
| | | cost may be related to distribution |
| GasBill | 40$ | A U.S. gas bill in May 2010. |
| EP_{HEAT} | 10 EP | A typical number of Energy Points per person |
| | | per month. The local variations from cold to |
| | | warm states may be of course very high. |
| Cost per | 10$ | |
| person per | | |
| month | | |
| CO₂ per | 80 Kg CO₂ | 6.1 kG per therm or 8 Kg CO₂/EP |
| person | | |

When the number of people per household may be in the range of 2-4 and the gas bill may be given in mBtu, the number of Energy Points used for heating may be estimated, for example, as follows:

$${EP}_{HEAT} = \frac{GasBill [ \$ ]}{4}$$

Summarizing Electricity, Car, Air Miles and Heating

Embodiments of the invention may combine the (four) energy parameters, for example, electricity, car miles, air miles and heating, into a single uniform measurement scale.

The combined Energy Point value of the energy parameters may be approximated, for example, as follows:

$${EP}_{I} = \frac{CarMiles}{{C}_{OC} {MPG}_{CAR}} + \frac{φ EBill [ \$ ]}{38 {H}_{OC} ECost [ \$ \text{/} kWh ]} + \frac{GasBill [ \$ ]}{1.3 {H}_{OC} GasCost [ \$ \text{/} therm ]} + \frac{YearAirMiles}{600}$$

It may easily be used to compare the Energy Points performance of different individuals. For example, a comparison of three people:
1. An average US person (the definition of consumer unit contains 2.5 persons, 1.3 earners and 2 vehicles). The factors that multiply the bill and miles information are given in the equations above. EP_{I} performance of the average US person may be thus given by the following simple equation:

$${EP}_{I} = \frac{EBill [ \$ ]}{4} + \frac{GasBill [ \$ ]}{4} + \frac{CarMiles}{40} + \frac{YearAirMiles}{600}$$

2. Person A that lives alone in a condo apartment in Boston, Mass., heats with gas and does not own a car. Borrows a ‘common car’ when needed of 35 MPG which he/she drives with an average occupancy of 2. The calculations of the local factors may be as done and shown in the above equations and may be given in table 18 below:

$${EP}_{I} = \frac{EBill [ \$ ]}{2} + \frac{GasBill [ \$ ]}{2} + \frac{CarMiles}{70} + \frac{YearAirMiles}{600}$$

3. Person B that live with in a townhouse in Austin, Tex. with a family of 4. Heats and cools with electricity. Uses gas primarily for cooking and own 3 cars. The typical car occupancy may be 1.1 and the car average MPG may be 18.

$${EP}_{I} = \frac{EBill [ \$ ]}{7} + \frac{GasBill [ \$ ]}{6} + \frac{CarMiles}{20} + \frac{YearAirMiles}{600}$$

TABLE 18
Parameters used to calculate local factors

| | US | | |
|---|---|---|---|
| | Average | Persona A | Persona B |
| Members per | 2.5 | 1 | 4 |
| household | | | |
| Electricity Cost | 0.11 | 0.15 | 0.12 |
| [$/kWh] | | | |
| Electricity Mix | 2.5 | 2.7 | 2.7 |
| Factor | | | |
| Gas cost [$/therm] | 1.2 | 1.5 | 1.1 |
| Car efficiency | 25 | 35 | 18 |
| [MPG] | | | |
| Car occupancy | 1.6 | 2 | 1.1 |

The above equations demonstrate transparent and verifiable way to measure and track one's operational EP in an intuitive manner. One may know his local ‘factors’ and insert or automatically have inserted the bill and mileage information.

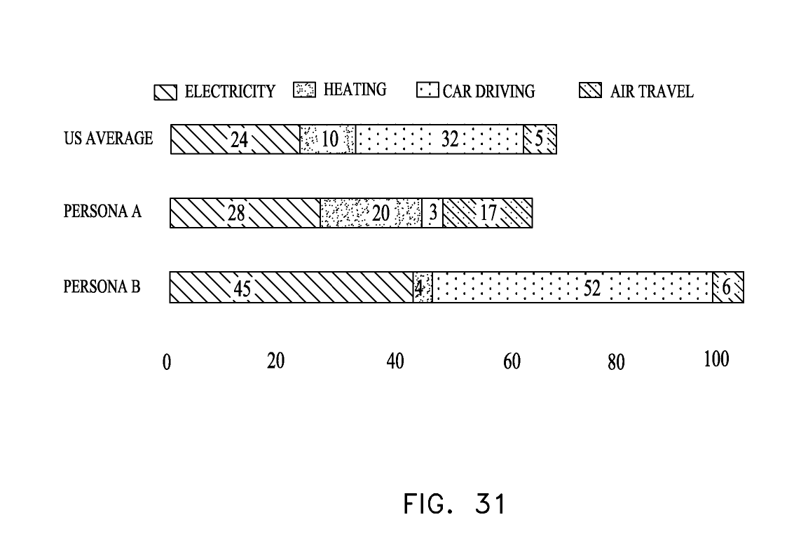

FIG. 31 and the following table show a comparison that may be made between these three individuals:

TABLE 19
Comparing EP of three individuals

| | | | Car | Air | |
|---|---|---|---|---|---|
| | Electricity | Heating | Driving | travel | TOTAL |
| US | 22 | 10 | 34 | 5 | 72 |
| Average | | | | | |
| Persona A | 27 | 40 | 3 | 42 | 111 |
| Persona B | 40 | 4 | 44 | 6 | 93 |

Monitoring Progress and Implementation of Improvements

The equations above exemplify the concept. They are done as on an annual average for simplicity. The Energy Points Rating system may allow easy monitoring of the progress from month to month, year to year or any other time period.

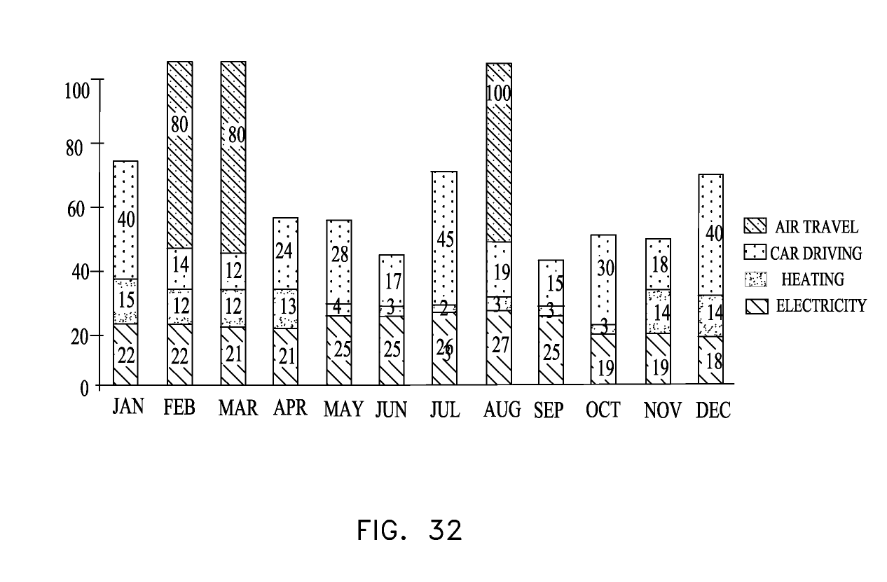

Since parameters such as electricity mix, house occupancy, electricity cost and MPG do not tend to change frequently, the above simple equations, adapted locally and individually, may be used to monitor progress as exemplified in FIG. 32. The figure demonstrates monthly changes in Energy Points rating over a period of one year for a person that lives in an area that uses both heating in the winter (through gas) and cooling in the summer through air conditioning.

One may notice, for example that:
The air-conditioning consumption may be seen in the Electricity EP during May-September
The gas consumption may be dominant in November through April
Car travel has a base related to commutes and then peaks related to business or leisure travels.
Air travel miles that may be collected annually as in the above equations actually peak with domestic and trans-Atlantic flights. For example, a flight from NYC to Europe (departing for example in the last week of February and Returning on the First week of March) may be 160 EP (8,000 miles) and an East Coast to West Coast Flight (5,000 miles) may be about a 100 EP.

The change in EP rating may be used in various ways to promote reduction. For example, it may be used in a social network as an icon for the progress that was made.

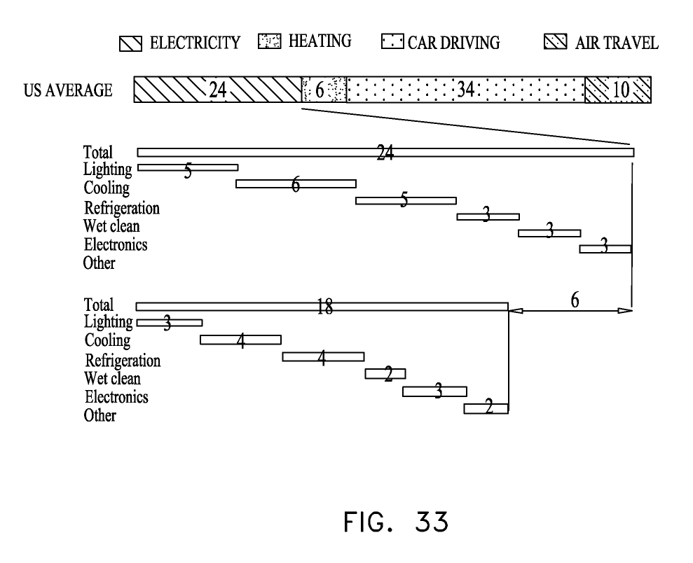

The device in the current invention may breakdown the energy consumption to specific uses and enable implementation through ‘what-if’ scenarios. That may be to calculate the Energy Points benefits of different scenarios as exemplified in FIG. 33.

Dividing energy usage to a monthly basis, gives, for example, lighting usage of 1 EP (1,200 kWh/yr), washing and drying usage of 0.8 EP (1,000 kWh/yr), cooling and refrigeration usage of 1 EP (1,200 kWh/yr), electronics and miscellaneous 0.5 EP (1,000 kWh/yr) and a total usage of 3.3 EP. These values corresponds to an electricity bill of about 100$/month.

Comparing to cost and carbon footprint

The EP_{I} (of commodity items) enable direct mapping of Energy Points to monetary cost ($) and carbon footprint or environmental cost, measures in weight of CO₂.

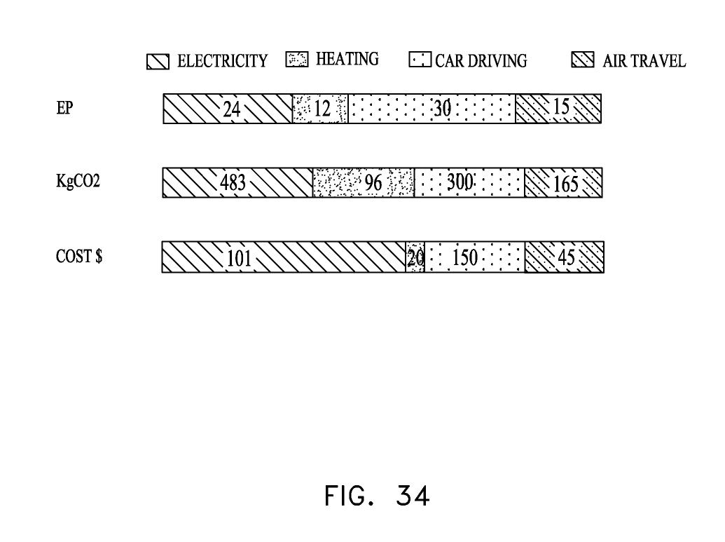

One may use the relationships between Energy Points and money and weight of CO₂ associated therewith, for example, as shown Table 20 and FIG. 34.

This concept may be shown in FIG. 18. A device (e.g., computing device 1500 of FIG. 18) may collect input from various sources and may translate this input to Energy Points, cost in dollars and CO₂ footprint.

TABLE 20
The typical cost per EP and CO₂ per EP

| | Cost per | |
|---|---|---|
| | EP | CO₂ per EP |
| | [$] | [Kg CO₂] |
| Electricity | 4.2 | 20 |
| Heat | 1.6 | 8 |
| Car | 5 | 10 |
| Air | 25 | 11 |

Capital Consumption: embodied energy of a car and a house (EP_{II})

Car Embodied Energy

The Energy Points calculation may include the embodied energy, for example of manufacturing a car or building or renovating a house. They may further include the embodied energy of manufacturing means of public transportation such as airplanes, ships and trains.

For simplicity, the embodied energy of a house and a car may be:

EP_{II}=EP_{II}_{_{—}}_{CAR}+EP_{II}_{_{—}}_{HOUSE}

Embodiments of the invention may calculate the Energy Points of a car to include the energy to manufacture the car. The energy to manufacture a car may be estimated to be, e.g., 0.3 terra Joule, which may be equivalent to about 2,000 EP. The retrievable energy assuming that a car may be composed of 50% steel, 0.25% aluminum, 0.1% plastics, may be around 0.05 terra Joule or 400 EP. In one example, for simplicity the energy used to:
Manufacturing externalities such as water use and toxic waste
Dispose the not retrievable parts, including the externalities
Recycle the recyclable parts
   The embodied energy may be given by:

$${EP}_{II \_ CAR} = \frac{{EE}_{CAR} - {RE}_{CAR}}{{T}_{CAR}}$$

Using the approximated numbers above, the Energy Points associated with car embodied energy are ˜9 EP/month (2000-400)/15/12). This may be referred to as the EP analogy of depreciation. Thus according to an embodiment of the invention, the EP system may serve to demonstrate what may be the energy consumption impact of buying a new energy efficient car. Assuming that one considers moving form a 25 MPG car to one of the following options:
40 MPG with embodied energy of 1600 EP
50 MPG with embodied energy of 2,600 EP

For simplicity one may ignore the embodied energy of the car that may be already in use and assume that the new car may be manufactured for the purchase.

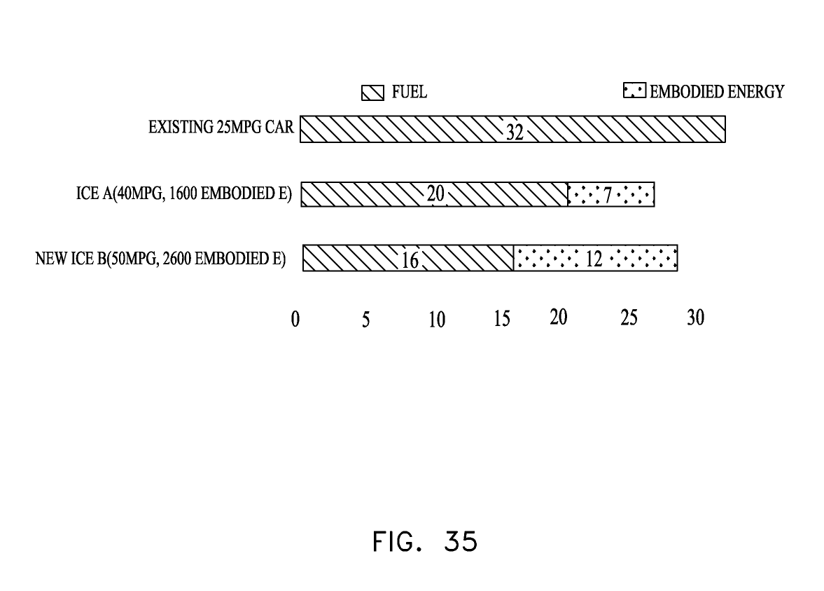

FIG. 35 shows how the cars decision may be made. It shows that a 40 MPG car with lower embodied energy may be actually better by one Energy Point per month than a car with lower embodied energy and 50 MPG.

House Embodied Energy

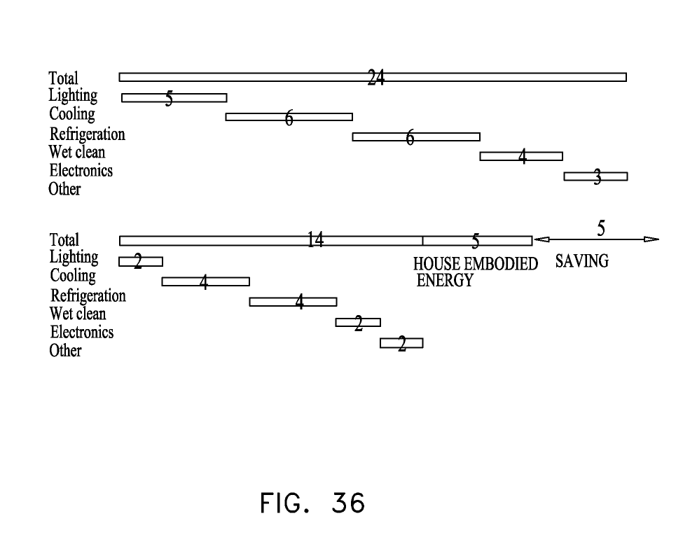

Similarly to the car embodied energy, according to the current invention, one may observe the energy benefits of building a new energy efficient house, as seen in FIG. 36.

The energy expenditure of building a new home may be about 7 GJ/m² assuming a 2,000 ft² house (186 m²), the energy consumption of building the house may be ˜9000 EP. Assuming that the house exist for 60 years and that 20% may be recycled if the house may be demolished, the embodied energy may be about 5 Energy Points per person per month (assuming occupancy of 2.5 persons).

### Operational Consumption: e.g., Water and Waste (EP_{III})

Water

Energy in its various forms: Gasoline, Electricity and Natural gas may be sold as a commodity. One does not expect any feature except low cost and reliability of supply. Embodiments of the invention extend the Energy Points system to rate the plurality of other commodity products such as water, wastewater and waste disposal.

For example, according to one embodiment of the current invention, water may be measured in the Energy Points used for desalination and/or piping and/or shipping and/or purifying water according to the local conditions.

Water may be an unevenly distributed abundant resource. Some regions, for example, in California and Arizona suffer from water scarcity, while others such as Massachusetts and New York are relatively rich with fresh water. Accordingly the assignment of Energy Points to water varies locally.

The energy used to supply fresh water may be typically in the form of electricity, may be as follows:

$${EP}_{III \_ WATER} = \frac{φ}{38 \cdot {H}_{OC}} \frac{WB [ \$ ]}{WR [ \$ \text{/} 1000 gal ] \cdot LWF [ 1000 gal \text{/} kWh ]}$$

Where WB may be the monthly water bill. WR may be the local water rate in and LWF may be the Local Water Factor representing the amount of energy used for generating 1000 gallons of fresh water.

The water rate usually depends on the volume of water. For example, in Las Vegas the rate may be $4.58 per 1,000 gallon for the fifth 5,000 gallons (per family) and $2 per 1,000 gallons for the second 5,000 gallons. As an example, a water rate of $3 per 1,000 gallons may be use. Water bill of $35 per family per month and Local factor of 0.053 [1000 gal/kWh], which corresponds to 5 kWh/m̂3. The result may be 5.3 EP per person per month.

The same use and tariff at a place with water abundance such as a city that may be supplied by a lake (local factor LWF of ˜0.5 1000 gal/kWh), the water related EP may be as low as 0.5 EP per person per month.

The water EP per person per month has a range of 0.5-5 EP.

Wastewater

Another commodity may be wastewater and sewage treatment. It turns out that waste water treatment consumes energy in the range of 2,000 kWh/million gallon or 2 kWh per 1,000 gallon and that a person uses (produces) slightly less than 2,000 gallons per month. Thus, in most places, the Energy Points of wastewater are in the range of 0.1 EP per month and may be neglected. Furthermore, there may be not a lot of quantitative saving decisions that one may do with respect to wastewater treatment.

Municipal Waste and Toxic Waste may be treated in a similar manner.

Items Such as Food and Consumer Goods (EP_{IV})

Food and consumer goods are non-commodities in the sense that one may pay for extra quality such as gourmet foods or fashion clothing without extra Energy Points. The invention may include items such as food and goods as energy.

Unlike electricity, gas, fuel and water, which have an approximately linear correspondence between cost and quantity, food and shopped goods may have other contributing energy factors (e.g., including energy used to harvest, manufacture and ship the goods). In addition, gourmet food and fashion apparel may have high cost irrespective of Energy Points. Therefore, food and shopped items may have a complex and non-linear correlation between cost and quantity.

Thus, according to an embodiment of the invention, food and consumer goods information may be entered by a user, through credit card information or receipts. For example, data may be retrieved automatically through on-line transactions and electronic receipts.

For the basic estimation, one may use the quantity and type of things that are bought.

Once EPs are used in product labeling, the complete cycle may be established automatically. Namely a system such as mobile application receives the EP value of a meal or goods and adds it to the EP budget.

Food

The key factors in determining food Energy Points are the composition of food, such as percentage of energy intensive food items (e.g. beef and shrimps) in the diet and ‘food-miles’ e.g. local sourcing vs. remote supply.

As an example, according to an embodiment of the invention, the decision to eat a steak may be about 0.5 EP as may be seen in the following estimation: One Kg of Beef has approximately 2,500 calories and 220 gr protein. A 200 gr steak (˜7 oz) has about 400 Cal and 44 gr protein (about half the daily calories intake of an average adult). The energy consumption in preparing the steak may be about 40 times the caloric content, which may be about 16,000 Cal or 0.5 EP per steak.

The above estimation does not include water and other externalities. The production of 1 Kg of beef uses about 43,000 Liter or 11,000 gallons. In a region where 1,000 gallons of water uses 0.5 EP, a Kg of beef uses additional 5 EP and a steak an additional 1 EP if beef may be grown only with fresh water without reuse. If water as energy is counted, the cost of steak would more than double. In a similar manner, one may add the Energy Points associated with nitrogen, phosphorous, potassium, insecticides, fungicides, herbicides etc. In a similar way, one could calculate the Energy Point implication of a decision to eat Poultry or turkey, which are about 5 times more energy efficient than beef.

According to an embodiment of the invention, low EP food typically represents healthier food. For example, diets that are based on locally grown, plant-rich diets have less Energy Points than diets that are based on more food-miles and meat.

According to an embodiment of the invention, the simplest assignment of Energy Points to food may be based on the following three categories: vegetarian, lacto-ovo (a vegetarian who may be willing to consume dairy and egg products) and non-vegetarian.

The average daily energy input into the manufacturing of food of pure vegetarian, lacto-ovo vegetarian and non-vegetarian energy consumption in a typical US conditions per person per month may be given by:

$${EP}_{FOOD} = \{ \begin{matrix}16 \_\_Vegeterian \\ 23 \_\_Lacto \text{-} ovo \text{-} Vegeterian \\ 32 \_\_Non \text{-} Vegeterian\end{matrix} \}$$

According to an embodiment of the invention, one may also count specific Energy Points per meal or per portion of food in a similar way to counting calories.

According the invention, a database may be formed where each food portion have its EP association. Electronic receipts may feed in the purchased food items and the Energy Points may be calculated.

Goods

The Energy Points of goods may be broken down to categories such as:
1.Apparel
2. Electronics
3.Appliances
   One way may be to go into existing databases, average, and translate to EP

The total energy associated with consumer goods may be conventionally described as ‘Life cycle Analysis’ (LCA). It may be composed of 4 main phases: the
1. Making of Raw Materials
2. Production
3. Use
4. Disposal

Another way may be to count material and used the embodied energy of material estimation.

The variation between two items may be smaller (& less important) than the decision to buy them.

Energy Points associated with the Workplace and Community

The total US energy consumption may be about 8,500 gallons of oil equivalent per person per year. This may be equivalent to about 730 EP per person per month. This includes the energy consumption of the government, industry and businesses. It may be more than 3 times the average residential consumption per person per month.

According to an embodiment of the invention, one may account for his share in the Energy Points of its workplace and government. A corporation may use the current invention to calculate the Energy Points per Employee and a Government, including local governments may use embodiments of the current invention to calculate the Energy Points per capita. According to the current invention, community Energy Points may be the total Energy Points consumption of the governmental, non-profit, commercial and industrial entities excluding one's workplace and residential. The three numbers: residential, workplace and community may add up to the national Energy Point consumption per capita.

In principle any P&L unit that receives electricity, heat and water bills and have persons associated with it, may use the current invention to calculate the Energy Points per person per month.

Assuming for example an office with 100 employees, electricity bill of $4,000 per month at cost of $0.07/kWh. The electricity serves for office building heating and cooling. The company may be in an area where φ=1.5. Business travels account for 200 car miles and 200 air miles per employee per month. Assuming the average airplane effective MPG of 50 MPG (normalized by the number of passengers). For example the typical car MPG may be 25 and the average car occupancy may be 2 (the Energy Points score may improve as the car MPG increases).

Example of workplace Energy Points per employee, that may be added to the residential EP may be:

$${EP}_{I} = \frac{EBill [ \$ ]}{177} + \frac{CarMiles}{50} + \frac{YearAirMiles}{50}$$

Which in the particular example may be 24+4+4=32 EP/person/month.

Example of the Energy Points Process Description

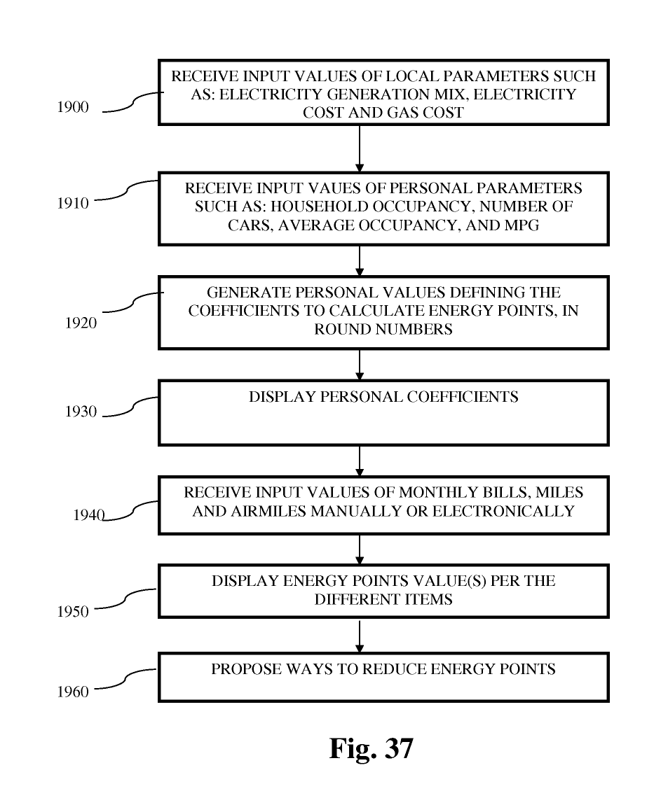

FIG. 37 illustrates a flowchart of a method according to an embodiment of the invention.

In operation 1900, a processor may receive a plurality of input values of quantities such as the local electricity mix, the portion distributed generation, the local electricity cost, the local gas cost.

In operation 1910, a processor may receive a plurality of input values of quantities such as the personal household occupancy, number of cars, make and model of cars, MPG of cars, average car occupancy, etc.

In operation 1920, a processor may generate a plurality of values of quantities such as the personal defining the coefficients for calculating Energy Points such that the monthly bills or miles as described divided by those coefficients provide the Energy Points.

In operation 1930, a processor may display the personal coefficients such that an individual or a corporation may be able to know that, for example, their electricity Energy Point may be their energy bill divided by said coefficient. The coefficients don't change often. Typically they change when things like electricity price or the local energy mix changes.

In operation 1930, a processor may display the personal coefficients such that an individual or a corporation may be able to know that, for example, their electricity Energy Point may be their energy bill divided by said coefficient. The coefficients don't change often. Typically they change when things like electricity price or the local energy mix changes.

In operation 1940, a processor may receive a plurality of input values such as the monthly electricity bills, gas bills, airline miles, car miles, train miles etc.

In operation 1950, a processor may display the plurality of monthly Energy Points in a graphical or numerical ways that enable decisions. The processes or may further display the related cost and carbon footprint.

In operation 1960, a processor may propose ways to reduce the EP consumption by taking different measures.

Below are simplified non-limiting examples of implementations of embodiments of the invention.

The Electric Car

The electric car may be a prime example for the equivalence of electrical and chemical energy. The electric car consumes electricity. The electricity may be produced at the power plant and delivered to the battery. Approximately 20% of the power consumption may be due to inefficiencies in charging the batteries. The batteries end up as waste—mainly toxic waste. In contrast to the internal combustion engine (ICE) car that consumes fuel in a generally inefficient manner (about 20% efficiency). Other inefficiencies and power losses may occur in different examples.

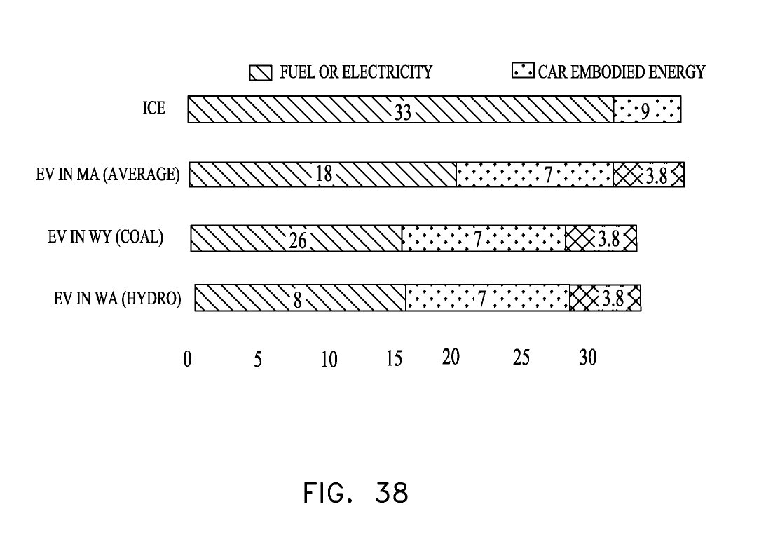

According to an embodiment of the current invention, one may compare the miles per EP of an electric car to the internal combustion engine (ICE) in a way that takes into account the electricity energy generation of the electric vehicle, or electric car and waste disposal. An example of such comparison may be shown in FIG. 38. It turns out, as shown in the figure, that the internal combustion engine may be inferior to the electric vehicle in its Energy Points performance. Even if the primary energy source may be coal.

According to an embodiment of the invention, the energy EP performance may be done while taking into account the EP cost of disposing the battery after the effective number of charging cycles (typically 1000). According to an embodiment of the invention, for example:

The energy to make the batteries per car (assuming 250 Kg batteries per car) may be about 30 mBtu and the energy to recycle the batteries may be about 3 mBtu/250 Kg. The total batteries EP consumption may be about 33 mBtu or 250 EP.

The calculation may be based on the following assumptions: The battery pack exists for 1,000 cycles. Each charging range may be about 60 miles. The typical driving distance may be 1,000 miles per month. Charging inefficiencies lead to 20% more charging (thus 20 charging cycles per month). Under those assumptions, the battery lasts for 4 years. Overall the batteries add about additional SEP per month. This quantity may change rapidly as battery technology (range and energy density) improves.

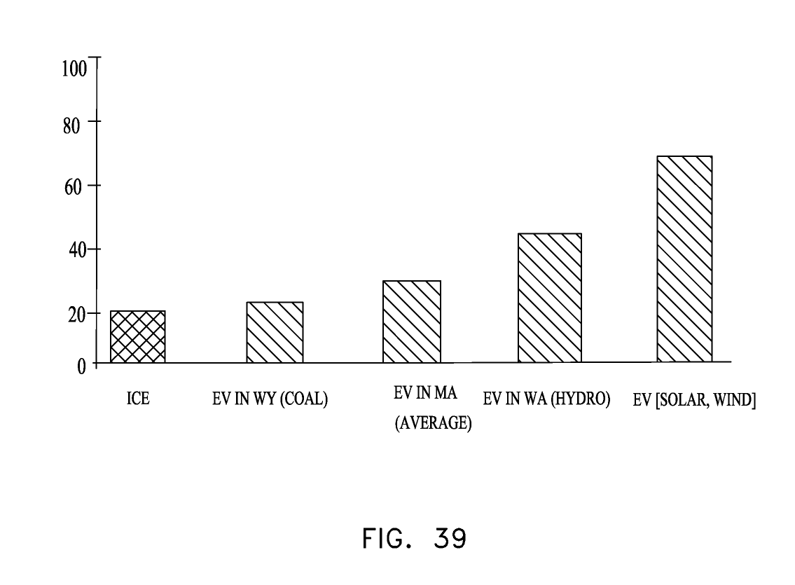

FIG. 39 shows the EP per month of a 25 MPG ICE car vs. the electric vehicle or electric car where the batteries are taken into account, in the average US, Wyoming (‘Coal’ state) and Washington (‘Hydroelectric’ state). As shown in the figure, even in the ‘coal’ state the electric vehicle performance may be superior. In the ‘hydro’ state the car driving EP per person per month are half the ICE consumption.

The electricity factor f may be multiplied by a factor that reflects the fact that an electric car may participate in peak electricity load leveling and therefore may be partially ‘free’. This factor varies from 80% in coal, which may be fully dispatchable and have overcapacity during nighttime and under capacity during peak times (namely the effective for electric cars in Wyoming may be 4*0.8=3.5) to unity for solar energy that has to be consumed as produced (namely solar energy does not help in load leveling).

Electric cars may be charged separately through a 220 bus so measured separately. This means that EP_{CAR} of an electric vehicle may be measured as:

$${EP}_{CAR} = \frac{φ {EBill}_{CAR} [ \$ ]}{38 {H}_{OC} ECost [ \$ \text{/} kWh ]}$$

Some comments on electric vehicle:
The reserves of lithium are around 10 million tons. If a car uses 200 kG batteries and 10% lithium it may be 20 Kg per car. So the world supply may deal with 500 million cars.
The battery energy density may be about 120 Wh/Kg (say Li-ion). The energy density of oil may be 100 times better. However the electric motor may be lighter and 4 times more efficient than the ICE. For extending the range of electric vehicle still need an order of magnitude improvement in battery energy density
The battery energy density may be about 120 Wh/Kg (say Li-ion). The energy density of oil may be 100 times better. However the electric motor may be lighter and 4 times more efficient than the ICE. For extending the range of electric vehicle still need an order of magnitude improvement in battery energy density.
   A device for replacing the diversity of energy units with Energy Points

Energy has multiple units, which makes energy calculations daunting. According to an embodiment of the invention, the EP system may be used as a practical energy unit.

As an example, consider buying and air-conditioning system. The efficiency of air conditioners may be often rated by the Seasonal Energy Efficiency Ratio (SEER). The SEER rating of a unit may be the cooling output in Btu (British thermal unit) during a typical cooling-season divided by the total electric energy input in watt-hours during the same period. The higher the unit's SEER rating the more energy efficient it may be. For example, an AC system with SEER of 10 Btu/Wh and output of 6,500 Btu/hour that works a 1,000 hours per year. The annual output may be 6.5 mBtu and the annual input may be 650 kWh of electricity. The dimensionless thermodynamic coefficient of performance may be about 3 (10×2.9, where 0.29 may be the ratio of 1 Btu/1 Wh). The AC system outputs 50 EP/Y in cooling per about 17 EP/Y of electricity. The local electricity factor may be used to calculate the EP consumption of this electricity.

Product Labeling

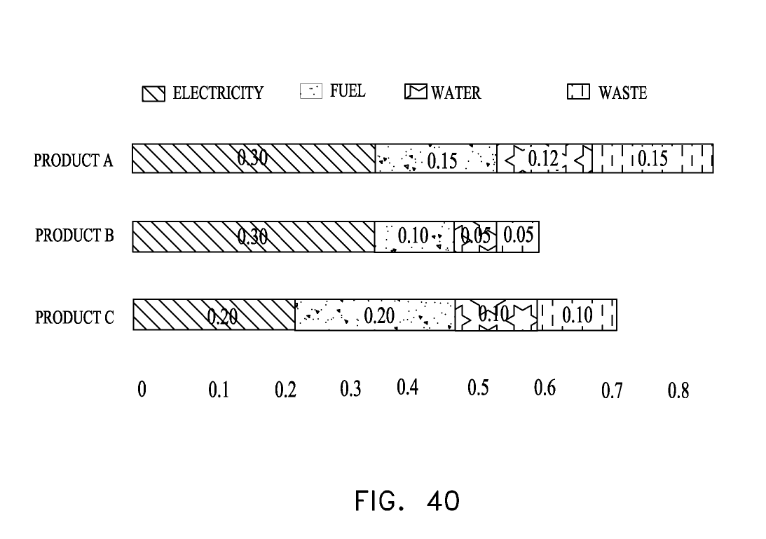

An example is three products that are similar in cost and properties. For example, two soft drinks, pairs of Jeans and so on. According to an embodiment of the invention, it may be possible to assign Energy Points that include the entire energy spent on delivering the product from cradle to grave. A schematic example is shown in FIG. 40.

Supporting and Rating Energy decisions

What may be the effect in EP of decisions or how many EP do I get per dollar?:

According to an embodiment of the current invention, the system may be used to maximize environmental gain in EP impact per dollar.

Assuming for example a corporation would like to find out the maximum EP reduction per an investment of 100,000$. The corporation may be considering the following options:
Installing solar power

The solar power cost $5/Watt installed. The $100k may buy about 20 kW. The gain over a lifetime of 20 years may be about 23,000 EP
Installing video conferencing

$100k may buy a video conferencing system which may save 50 coast to coast flights per year for 5 years. Total 250 flights where each flight may be about 100 EP
Installing LED lighting

The lighting cost about $1000/watt for a lifetime of 10 years, the total delivery may be about 57,000 EP

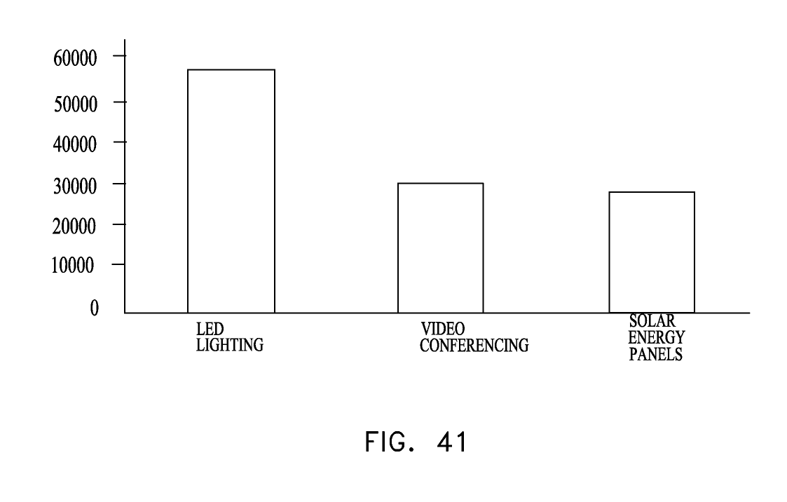

The comparison may be shown in FIG. 41.

### Traveling

An embodiment of the current invention enables a calculation of the Energy Points of traveling and thereby selecting the lowest EP route. For example one may add the EP of: plane+car+hotel and compare different packages according to Energy Points. Assuming for example a trip with 1,000 air miles, 100 car miles and 2 days in a hotel. The estimated Energy Points consumed are 20 EP for the air miles (1,000 miles/50 MPG), 4 EP for the car miles (100 miles/25 MPG) and 2 EP for each night in the hotel. According to an embodiment of the invention different airlines, hotels and cars may have different Energy Points cost. Given identical or similar cost a purchase decision may be taken on the basis of Energy Points as exemplified in

Online Shopping

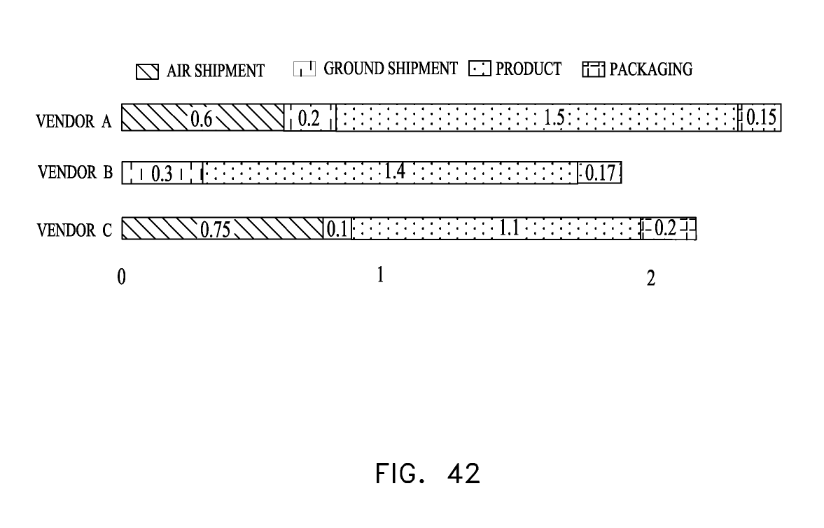

In accordance with an embodiment of the invention enables a calculation of the Energy Points of buying a produce on-line and selection of the lowest EP option. For example one may compare the air-shipment, ground shipment, product and packaging of a few options and use it as part as the purchase decision. An example is shown FIG. 42.

Although the particular embodiments shown and described above will prove to be useful for the many systems to which the present invention pertains, further modifications of the present invention will occur to persons skilled in the art. Several embodiments are presented, and specific features in some embodiments may be combined with features of other embodiments. All such modifications are deemed to be within the scope and spirit of the present invention as defined by the appended claims.

1. A system for sustainability management of energy consumption of a selected resource, comprising:
a memory; and
a processor, the processor to:
calculate a global sustainability quantification value, the value being a resultant quantity of the selected resource which is produced by exploitation of a predetermined quantity of a predetermined second resource.

2. A system according to claim 1 wherein the predetermined second resource is a fossil fuel.

3. A system according to claim 1 wherein the predetermined second resource is gasoline.

4. A system according to claim 1 wherein the predetermined quantity of the predetermined second resource is a gallon of gasoline.

5. A system according to claim 1 wherein the predetermined second resource is a fossil fuel in its primary energy state.

6. A system according to claim 1 wherein the processor is to calculate a sustainability quantification value by executing an algorithm based on:
the global sustainability quantification value, and
a sustainability efficiency value, the sustainability efficiency value being an indication of an energy efficiency degree of the selected resource.

7. A system according to claim 6 wherein the sustainability efficiency value is calculated according to the geographical location wherein the resource is consumed.

8. A system according to claim 7 wherein the processor is to calculate a sustainability expenditure value by executing an algorithm based on:
a quantity associated with the selected resource; and
the sustainability efficiency value.

9. A system according to claim 8 wherein the quantity associated with the selected resource is a consumed quantity of the selected resource.

10. A system according to claim 8 wherein:
the processor is to calculate the sustainability expenditure value for a first selected resource and the sustainability expenditure value for a second selected resource, wherein the sustainability expenditure value for the first selected resource and the sustainability expenditure value for the second selected resource are measured in a common unit wherein the first resource is measured in a first conventional unit and the second resource is measured in a second conventional unit, said first conventional unit being different than the second conventional unit.

11. A method for sustainability management of energy consumption of a selected resource, comprising:
calculating a global sustainability quantification value, the global sustainability quantification value being a resultant quantity of the selected resource which is produced by exploitation of a predetermined quantity of a predetermined resource,
the calculating performed by a processor and the global sustainability quantification value being stored in a memory.

12. A method according to claim 11 wherein the predetermined second resource is fossil fuel.

13. A method according to claim 11 wherein the predetermined second resource is gasoline.

14. A method according to claim 11 wherein the predetermined quantity of the predetermined second resource is a gallon of gasoline.

15. A method according to claim 11 wherein the predetermined second resource is a fossil fuel in its primary energy state.

16. A method according to claim 11 and calculating a sustainability quantification value by executing an algorithm based on:
the global sustainability quantification value, and
a sustainability efficiency value being an indication of an energy efficiency degree of the selected resource.

17. A method according to claim 16 wherein the sustainability efficiency value is calculated according to the geographical location wherein the resource is consumed.

18. A method according to claim 17 and calculating a sustainability expenditure value by executing an algorithm based on:
a quantity associated with the selected resource; and
the sustainability efficiency value.

19. A method according to claim 18 wherein the quantity associated with the selected resource is a consumed quantity of the selected resource.

20. A method according to claim 18 wherein:
the sustainability expenditure value is calculated for a first selected resource and the sustainability expenditure value is calculated for a second selected resource, wherein the sustainability expenditure value for the first selected resource and the sustainability expenditure value for the second selected resource are measured in a common unit,
wherein the first resource is measured in a first conventional unit and the second resource is measured in a second conventional unit, said first conventional unit being different than the second conventional unit.

21. A system for sustainability management of energy consumption of a selected resource, comprising:
a memory; and
a processor, the processor to:
calculate a sustainability efficiency value based on the geographical location of the selected resource,
the sustainability efficiency value being an indication of an energy efficiency degree of the selected resource.

22. A system according to claim 21 wherein the sustainability efficiency value is based on a time period in which the selected resource is consumed.

23. A system according to claim 21 wherein the sustainability efficiency value comprises at least one value of a resultant adverse effect on the environment resulting due to production of the selected resource.

24. A system according to claim 21 wherein the processor calculates a sustainability quantification value by executing an algorithm based on:
a global sustainability quantification, the global sustainability quantification value being a resultant quantity of the selected resource, which is produced by exploitation of a predetermined quantity of a predetermined resource, and
the sustainability efficiency value.

25. A system according to claim 24 wherein the processor is to calculate a sustainability expenditure value by executing an algorithm based on:
a quantity associated with the selected resource; and
the sustainability quantification value.

26. A system according to claim 25 wherein the quantity associated with the selected resource is a consumed quantity of the selected resource.

27. A system according to claim 24 wherein the predetermined second resource is a fossil fuel.

28. A system according to claim 24 wherein the predetermined second resource is gasoline.

29. A system according to claim 24 wherein the predetermined quantity of a predetermined second resource is a gallon of gasoline.

30. A system according to claim 25 wherein:
the processor is to calculate the sustainability expenditure value for a first selected resource and the sustainability expenditure value for a second selected resource, wherein the sustainability expenditure value for the first selected resource and the sustainability expenditure value for the second selected resource are measured in a common unit,
wherein the first resource is measured in a first conventional unit and the second resource is measured in a second conventional unit, said first conventional unit being different than the second conventional unit.

31. A method for sustainability management of energy consumption of a selected resource, comprising:
calculating a sustainability efficiency value based on the geographical location of the selected resource,
the sustainability efficiency value being an indication of an energy efficiency degree of the selected resource,
the calculating performed by a processor and the sustainability efficiency value being stored in a memory.

32. A method according to claim 31 wherein the sustainability efficiency value is based on a time period in which the selected resource is consumed.

33. A method according to claim 31 wherein the sustainability efficiency value comprises at least one value of a resultant adverse effect on the environment resulting due to production of the selected resource.

34. A method according to claim 31 comprising calculating a sustainability quantification value by executing an algorithm based on:
a global sustainability quantification, the value being a resultant quantity of the selected resource, which is produced by exploitation of a predetermined quantity of a predetermined resource, and
the sustainability efficiency value.

35. A method according to claim 34 comprising calculating a sustainability expenditure value by executing an algorithm based on:
a quantity associated with the selected resource; and
the sustainability quantification value.

36. A method according to claim 35 wherein the quantity associated with the selected resource is a consumed quantity of the selected resource.

37. A method according to claim 34 wherein the predetermined second resource is a fossil fuel.

38. A method according to claim 34 wherein the predetermined second resource is gasoline.

39. A method according to claim 34 wherein the predetermined second quantity of a predetermined resource is a gallon of gasoline.

40. A method according to claim 35 wherein:
the sustainability expenditure value is calculated for a first selected resource and the sustainability expenditure value is calculated for a second selected resource, wherein the sustainability expenditure value for the first selected resource and the sustainability expenditure value for the second selected resource are measured in a common unit,
wherein the first resource is measured in a first conventional unit and the second resource is measured in a second conventional unit, said first conventional unit being different than the second conventional unit.
